(19) United States
(12) Patent Application Publication
(10) Pub. No.: US 2018/0316914 A1
(43) Pub. Date: Nov. 1, 2018

(54) IMAGE PROCESSING APPARATUS AND METHOD

(71) Applicant: SONY CORPORATION, TOKYO (JP)

(72) Inventor: KENJI KONDO, TOKYO (JP)

(21) Appl. No.: 15/768,359

(22) PCT Filed: Oct. 14, 2016
(86) PCT No.: PCT/JP2016/080495

§ 371 Date: Apr. 13, 2018

(30) Foreign Application Priority Data
Oct. 30, 2015 (JP) 2015-214250

(51) Int. Cl. H04N 19/105; H04N 19/33; H04N 19/167; H04N 19/172; H04N 19/159; H04N 19/119

(52) U.S. Cl. CPC H04N 19/105; H04N 19/33; H04N 19/119; H04N 19/172; H04N 19/159; H04N 19/167

(57) ABSTRACT

The present disclosure relates to an image processing apparatus and method by which it is possible to suppress reduction of the encoding efficiency. Inter prediction is performed for part of a plurality of regions of a lower hierarchy into which a processing target region of an image is partitioned, and a reference pixel is set using a reconstruction image corresponding to a prediction image generated by the inter prediction. Further, intra prediction is performed using the reference pixel for the other region from among the regions of the lower hierarchy, and the image is encoded using a prediction image generated by the inter prediction and the intra prediction. The present disclosure can be applied, for example, to an image processing apparatus, an image encoding apparatus, an image decoding apparatus or the like.

### TECHNICAL FIELD

The present disclosure relates to an image processing apparatus and method, and particularly to an image processing apparatus and method by which reduction of the encoding efficiency can be suppressed.

### BACKGROUND ART

In recent years, standardization of an encoding method called HEVC (High Efficiency Video Coding) has been and is being advanced by JCTVC (Joint Collaboration Team-Video Coding) that is a joint standardization organization of ITU-T (International Telecommunication Union Telecommunication Standardization Sector) and ISO/IEC (International Organization for Standardization/International Electrotechnical Commission) in order to further improve the encoding efficiency from that of MPEG-4 Part 10 (Advanced Video Coding, hereinafter referred to as AVC).

In those image encoding methods, image data of predetermined units of encoding are processed in a raster order, a Z order or the like (for example, refer to NPL 1).

### CITATION LIST

### Non Patent Literature

[NPL 1]
Jill Boyce, Jianle Chen, Ying Chen, David Flynn, Miska M. Hannuksela, Matteo Naccari, Chris Rosewarne, Karl Sharman, Joel Sole, Gary J. Sullivan, Teruhiko Suzuki, Gerhard Tech, Ye-Kui Wang, Krzysztof Wegner, Yan Ye, “Draft high efficiency video coding (HEVC) version 2, combined format range extensions (RExt), scalability (SHVC), and multi-view (MV-HEVC) extensions,” JCTVC-R1013_v6, 2014 Oct. 1

### SUMMARY

### Technical Problem

However, according to such processing orders, in the case of intra prediction, a pixel on the right side or the lower side of a processing target block cannot be referred to. Therefore, there is the possibility that the encoding efficiency may be reduced.

The present disclosure has been made in view of such a situation as described above and makes it possible to suppress reduction of the encoding efficiency.

### Solution to Problem

The image processing apparatus according to a first aspect of the present technology is an image processing apparatus including a prediction section configured to perform inter prediction for part of a plurality of regions of a lower hierarchy into which a processing target region of an image is partitioned, set a reference pixel using a reconstruction image corresponding to a prediction image generated by the inter prediction and perform intra prediction using the reference pixel for the other region from among the regions of the lower hierarchy, and an encoding section configured to encode the image using a prediction image generated by the prediction section.

The prediction section may perform the inter prediction for one or both of a region positioned on the right side with respect to the region for which the intra prediction is to be performed and a region positioned on the lower side with respect to the region for which the intra prediction is to be performed, set one or both of a reference pixel on the right side with respect to the region for which the intra prediction is to be performed and a reference pixel on the lower side with respect to the region for which the intra prediction is to be performed using a reconstruction image corresponding to a prediction image generated by the inter prediction and perform the intra prediction using the set reference pixel or pixels.

The prediction section may further set a reference pixel using a reconstruction image of a region for which the prediction process has been performed and perform the intra prediction using the set reference pixel.

The prediction section may generate respective pixels of a prediction image using a single reference pixel corresponding to a single intra prediction mode by the intra prediction.

The prediction section may generate respective pixels of a prediction image using a plurality of reference pixels corresponding to a single intra prediction mode by the intra prediction.

The prediction section may generate each pixel of the prediction image using one of the plurality of reference pixels selected in response to the position of the pixel.

The prediction section may generate each pixel of the prediction image by performing, using the plurality of reference pixels, weighted arithmetic operation in response to the position of the pixels.

The plurality of reference pixels may be two pixels positioned in the opposite directions to each other of the single intra prediction mode as viewed from a pixel in the region for which the intra prediction is to be performed.

The processing target region may be an encoded block that becomes a unit of encoding, and the plurality of regions of the lower hierarchy may be prediction blocks each of which becomes a unit of a prediction process in the encoded block.

The plurality of regions of the lower hierarchy may be encoded blocks each of which becomes a unit of encoding, and the processing target region may be a set of a plurality of encoded blocks.

The image processing apparatus may further include a generation section configured to generate information relating to prediction by the prediction section.

The image processing apparatus may further include an intra prediction section configured to perform intra prediction for the processing target region, an inter prediction section configured to perform inter prediction for the processing target region, and a prediction image selection section configured to select one of a prediction image generated by the intra prediction section, a prediction image generated by the inter prediction section, and a prediction image generated by the prediction section, and in which the encoding section may encode the image using the prediction image selected by the prediction image selection section.

The encoding section may encode a residual image representative of a difference between the image and the prediction image generated by the prediction section.

The image processing method according to the first aspect of the present technology is an image processing method including performing inter prediction for part of a plurality of regions of a lower hierarchy into which a processing target region of an image is partitioned, setting a reference pixel using a reconstruction image corresponding to a prediction image generated by the inter prediction, performing intra prediction using the reference pixel for the other region from among the regions of the lower hierarchy, and encoding the image using a prediction image generated by the inter prediction and the intra prediction.

The image processing apparatus according to a second aspect of the present technology is an image processing apparatus including a decoding section configured to decode encoded data of an image to generate a residual image, a prediction section configured to perform inter prediction for part of a plurality of regions of a lower hierarchy into which a processing target region of the image is partitioned, set a reference pixel using a reconstruction image corresponding to a prediction image generated by the inter prediction and perform intra prediction using the reference pixel for the other region from among the regions of the lower hierarchy, and a generation section configured to generate a decoded image of the image using the residual image generated by the decoding section and a prediction image generated by the prediction section.

The image processing method according to the second aspect of the present invention is an image processing method including decoding encoded data of an image to generate a residual image, performing inter prediction for part of a plurality of regions of a lower hierarchy into which a processing target region of the image is partitioned, setting a reference pixel using a reconstruction image corresponding to a prediction image generated by the inter prediction, performing intra prediction using the reference pixel for the other region from among the regions of the lower hierarchy, and generating a decoded image of the image using the generated residual image and the generated prediction image.

The image processing apparatus according to a third aspect of the present technology is an image processing apparatus including a prediction image generation section configured to generate each of pixels of a prediction image of a processing target region of an image using a plurality of reference pixels corresponding to a single intra prediction mode.

The prediction image generation section may generate each pixel of the prediction image using one of the plurality of reference pixels selected in response to the position of the pixel.

The prediction image generation section may generate each pixel of the prediction image using the plurality of reference pixels by performing weighted arithmetic operation in response to the position of the pixel.

The image processing method according to the third aspect of the present technology is an image processing method including generating each of pixels of a prediction image of a processing target region of an image using a plurality of reference pixels corresponding to a single intra prediction mode.

In the image processing apparatus and method according to the first aspect of the present technology, inter prediction is performed for part of a plurality of regions of a lower hierarchy into which a processing target region of an image is partitioned, and a reference pixel is set using a reconstruction image corresponding to a prediction image generated by the inter prediction. Further, intra prediction is performed using the reference pixel for the other region from among the regions of the lower hierarchy, and the image is encoded using a prediction image generated by the inter prediction and the intra prediction.

In the image processing apparatus and method according to the second aspect of the present technology, encoded data of an image is decoded to generate a residual image, and inter prediction is performed for part of a plurality of regions of a lower hierarchy into which a processing target region of the image is partitioned. Further, a reference pixel is set using a reconstruction image corresponding to a prediction image generated by the inter prediction, and intra prediction is performed using the reference pixel for the other region from among the regions of the lower hierarchy. Thereafter, a decoded image of the image is generated using the generated residual image and the generated prediction image.

In the image processing apparatus and method according to the third aspect of the present technology, each of pixels of a prediction image of a processing target region of an image is generated using a plurality of reference pixels corresponding to a single intra prediction mode.

### Advantageous Effects of Invention

According to the present disclosure, an image can be processed. Especially, reduction of the encoding efficiency can be suppressed.

### BRIEF DESCRIPTION OF DRAWINGS

FIG. 1 is a view illustrating an overview of recursive block partition of a CU.

FIG. 2 is a view illustrating setting of a PU to the CU depicted in FIG. 1.

FIG. 3 is a view illustrating setting of a TU to the CU depicted in FIG. 1.

FIG. 4 is a view illustrating a scanning order of LCUs in a slice.

FIG. 5 is a view illustrating a scanning order of CUs in an LCU.

FIG. 6 is a view illustrating an example of a reference pixel in intra prediction.

FIG. 7 is a view illustrating an example of an intra prediction mode.

FIG. 8 is a view illustrating an example of a reference pixel.

FIG. 9 is a view illustrating an example of a manner of reference.

FIG. 10 is a view illustrating an example of an intra prediction mode.

FIG. 11 is a view illustrating an example of an intra prediction mode.

FIG. 12 is a view illustrating an example of a manner of weighted addition.

FIG. 13 is a view illustrating a different example of an intra prediction mode.

FIG. 14 is a block diagram depicting an example of a main configuration of an image encoding apparatus.

FIG. 15 is a block diagram depicting an example of a main configuration of an inter-destination intra prediction section.

FIG. 16 is a block diagram depicting an example of a main configuration of a prediction image selection section.

FIG. 17 is a view illustrating an example of a manner of CTB partition.

FIG. 18 is a view illustrating an example of a manner of partition type determination.

FIG. 19 is a view depicting examples of a partition type.

FIG. 20 is a view depicting an example of allocation of intra prediction and inter prediction.

FIG. 21 is a flow chart illustrating an example of a flow of an encoding process.

FIG. 22 is a flow chart illustrating an example of a flow of a prediction process.

FIG. 23 is a flow chart illustrating an example of a flow of a block prediction process.

FIG. 24 is a flow chart illustrating an example of a flow of an inter-destination intra prediction process.

FIG. 25 is a view illustrating an example of a manner of inter prediction in the case of 2N×2N.

FIG. 26 is a view illustrating an example of a manner of intra prediction in the case of 2N×2N.

FIG. 27 is a view illustrating an example of a manner of inter prediction in the case of 2N×N.

FIG. 28 is a view illustrating an example of a reference destination of a motion vector.

FIG. 29 is a view illustrating an example of a manner of intra prediction in the case of 2N×N.

FIG. 30 is a view illustrating another example of a manner of intra prediction in the case of 2N×N.

FIG. 31 is a view illustrating an example of a manner of weighted addition.

FIG. 32 is a view illustrating an example of a manner of intra prediction in the case of 2N×N.

FIG. 33 is a view illustrating an example of a manner of weighted addition.

FIG. 34 is a view illustrating an example of a manner of inter prediction in the case of N×2N.

FIG. 35 is a view illustrating an example of a reference destination of a motion vector.

FIG. 36 is a view illustrating an example of a manner of intra prediction in the case of N×2N.

FIG. 37 is a view illustrating an example of a manner of intra prediction in the case of N×2N.

FIG. 38 is a view illustrating an example of a manner of weighted addition.

FIG. 39 is a view illustrating an example of a manner of intra prediction in the case of N×2N.

FIG. 40 is a view illustrating an example of a manner of weighted addition.

FIG. 41 is a view illustrating an example of information to be transferred.

FIG. 42 is a block diagram depicting an example of a main configuration of an image decoding apparatus.

FIG. 43 is a block diagram depicting an example of a main configuration of an inter-destination intra prediction section.

FIG. 44 is a flow chart illustrating an example of a flow of a decoding process.

FIG. 45 is a flow chart illustrating an example of a flow of a prediction process.

FIG. 46 is a flow chart illustrating an example of a flow of an inter-destination intra prediction process.

FIG. 47 is a view illustrating a scanning procedure of lower hierarchy CUs in a CU.

FIG. 48 is a view illustrating an example of a prediction process allocation pattern of lower hierarchy CUs.

FIG. 49 is a block diagram depicting an example of a main configuration of an image encoding apparatus.

FIG. 50 is a block diagram depicting an example of a main configuration of a prediction image selection section.

FIG. 51 is a flow chart illustrating an example of a flow of a prediction process.

FIG. 52 is a flow chart illustrating an example of a flow of a block prediction process.

FIG. 53 is a flow chart illustrating an example of a flow of a block partition prediction process.

FIG. 54 is a block diagram depicting an example of a main configuration of an image decoding apparatus.

FIG. 55 is a flow chart illustrating an example of a flow of a decoding process.

FIG. 56 is a block diagram depicting an example of a main configuration of an image encoding apparatus.

FIG. 57 is a block diagram depicting an example of a main configuration of a multiple reference intra prediction section.

FIG. 58 is a block diagram depicting an example of a main configuration of a prediction image selection section.

FIG. 59 is a flow chart illustrating an example of a flow of a prediction process.

FIG. 60 is a flow chart illustrating an example of a flow of a block prediction process.

FIG. 61 is a flow chart illustrating an example of a flow of a multiple reference intra prediction process.

FIG. 62 is a block diagram depicting an example of a main configuration of an image decoding apparatus.

FIG. 63 is a block diagram depicting an example of a main configuration of a multiple reference intra prediction section.

FIG. 64 is a flow chart illustrating an example of a flow of a prediction process.

FIG. 65 is a flow chart illustrating an example of a flow of a multiple reference intra prediction process.

FIG. 66 is a view depicting an example of a multi-view image encoding method.

FIG. 67 is a view depicting an example of a main configuration of a multi-view image encoding apparatus to which the present technology is applied.

FIG. 68 is a view depicting an example of a main configuration of a multi-view image decoding apparatus to which the present technology is applied.

FIG. 69 is a view depicting an example of a hierarchical image encoding method.

FIG. 70 is a view depicting an example of a main configuration of a hierarchical image encoding apparatus to which the present technology is applied.

FIG. 71 is a view depicting an example of a main configuration of a hierarchical image decoding apparatus to which the present technology is applied.

FIG. 72 is a block diagram depicting an example of a main configuration of a computer.

FIG. 73 is a block diagram depicting an example of a general configuration of a television apparatus.

FIG. 74 is a block diagram depicting an example of a general configuration of a portable telephone set.

FIG. 75 is a block diagram depicting an example of a general configuration of a recording and reproduction apparatus.

FIG. 76 is a block diagram depicting an example of a general configuration of an image pickup apparatus.

FIG. 77 is a block diagram depicting an example of a general configuration of a video set.

FIG. 78 is a block diagram depicting an example of a general configuration of a video processor.

FIG. 79 is a block diagram depicting another example of a general configuration of a video processor.

### DESCRIPTION OF EMBODIMENTS

In the following, modes for carrying out the present disclosure (hereinafter referred to as embodiment) are described. It is to be noted that the description is given in the following order.

1. First Embodiment (outline)

2. Second Embodiment (image encoding apparatus: inter-destination intra prediction, PU level)

3. Third Embodiment (image decoding apparatus: inter-destination intra prediction, PU level)

4. Fourth Embodiment (image encoding apparatus: inter-destination intra prediction, CU level)

5. Fifth Embodiment (image decoding apparatus: inter-destination intra prediction, CU level)

6. Sixth Embodiment (image encoding apparatus: multiple reference intra prediction)

7. Seventh Embodiment (image decoding apparatus: multiple reference intra prediction)

8. Eighth Embodiment (others)

### 1. First Embodiment

<Encoding Method>

In the following, the present technology is described taking a case in which the present technology is applied when image data are encoded by the HEVC (High Efficiency Video Coding) method, when such encoded data are transmitted and decoded or in a like case as an example.

<Block Partition>

In old-fashioned image encoding methods such as MPEG2 (Moving Picture Experts Group 2 (ISO/IEC 13818-2)) or H.264 and MPEG-4 Part 10 (hereinafter referred to as AVC (Advanced Video Coding)), an encoding process is executed in a processing unit called macro block. The macro block is a block having a uniform size of 16×16 pixels. In contrast, in HEVC, an encoding process is executed in a processing unit (unit of encoding) called CU (Coding Unit). A CU is a block formed by recursively partitioning an LCU (Largest Coding Unit) that is a maximum encoding unit and having a variable size. A maximum size of a CU that can be selected is 64×64 pixels. A minimum size of a CU that can be selected is 8×8 pixels. A CU of the minimum size is called SCU (Smallest Coding Unit).

Since a CU having a variable size in this manner is adopted, in HEVC, it is possible to adaptively adjust the picture quality and the encoding efficiency in response to the substance of an image. A prediction process for prediction encoding is executed in a processing unit (prediction unit) called PU (Prediction Unit). A PU is formed by partitioning a CU by one of several partitioning patterns. Further, an orthogonal transform process is executed in a processing unit (transform unit) called TU (Transform Unit). A TU is formed by partitioning a CU or a PU to a certain depth.

<Recursive Partitioning of Block>

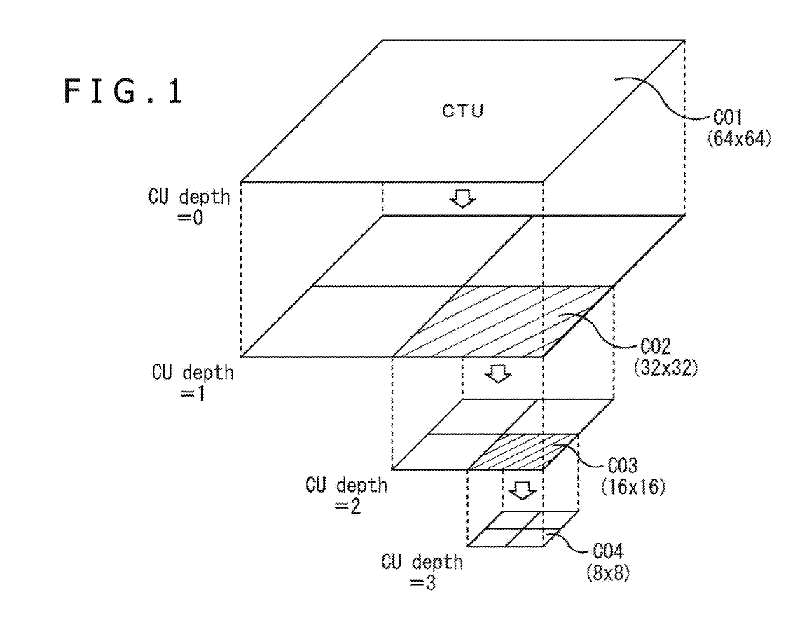

FIG. 1 is an explanatory view illustrating an overview of recursive block partition of a CU in HEVC. Block partition of a CU is performed by recursively repeating partition of one block into four (=2×2) sub blocks, and as a result, a tree structure in the form of a quad-tree (Quad-Tree) is formed. The entirety of one quad-tree is called CTB (Coding Tree Block), and a logical unit corresponding to a CTB is called CTU (Coding Tree Unit).

At an upper portion of FIG. 1, C01 that is a CU having a size of 64×64 pixels is depicted. The depth of partition of C01 is equal to zero. This signifies that C01 is the root of a CTU and corresponds to the LCU. The LCU size can be designated by a parameter that is encoded in an SPS (Sequence Parameter Set) or a PPS (Picture Parameter Set). C02 that is a CU is one of four CUs partitioned from C01 and has a size of 32×32 pixels. The depth of partition of C02 is equal to 1. C03 that is a CU is one of four CUs partitioned from C02 and has a size of 16×16 pixels. The depth of partition of C03 is equal to 2. C04 that is a CU is one of four CUs partitioned from C03 and has a size of 8×8 pixels. The depth of partition of C04 is equal to 3. In this manner, a CU is formed by recursively partitioning an image to be encoded. The depth of partition is variable. For example, to a flat image region like the blue sky, a CU of a greater size (namely, having a smaller depth) can be set. Meanwhile, to a steep image region that includes many edges, a CU having a smaller size (namely, a greater depth) can be set. Then, each of set CUs becomes a processing unit of an encoding process.

<Setting of PU to CU>

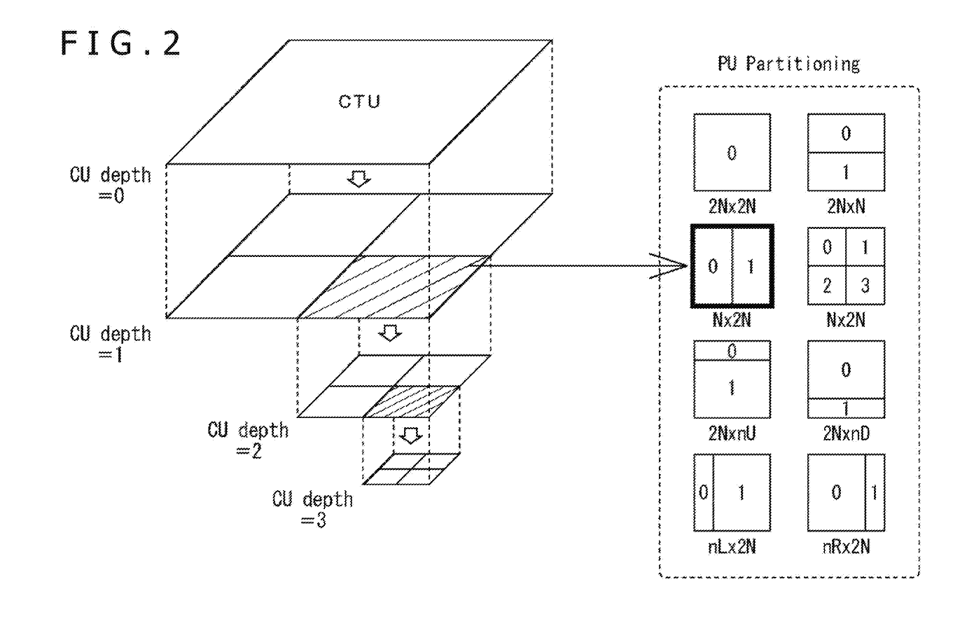

A PU is a processing unit for a prediction process including intra prediction and inter prediction. A PU is formed by partitioning a CU by one of several partition patterns. FIG. 2 is an explanatory view illustrating setting of a PU to the CU depicted in FIG. 1. On the right side in FIG. 2, eight different partition patterns of 2N×2N, 2N×N, N×2N, N×N, 2N×nU, 2N×nD, nL×2N and nR×2N are depicted. In intra prediction, the two patterns of 2N×2N and N×N can be selected from among the partition patterns specified above (N×N can be selected only for an SCU). In contrast, in inter prediction, where asymmetric motion partition is enabled, all of the eight partition patterns can be selected.

<Setting of TU to CU>

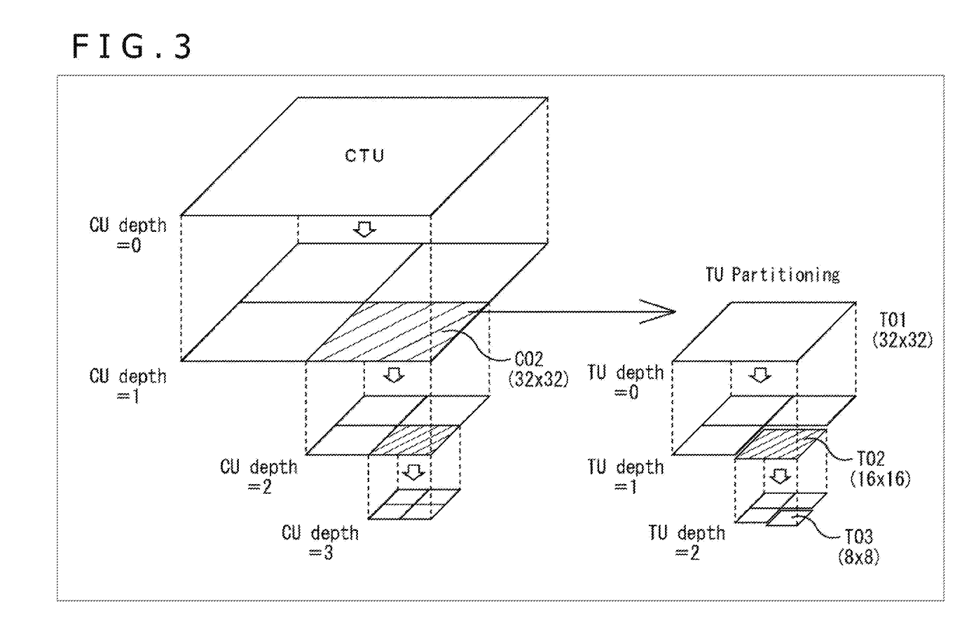

A TU is a processing unit in an orthogonal transform process. A TU is formed by partitioning a CU (in an intra CU, each PU in the CU) to a certain depth. FIG. 3 is an explanatory view illustrating setting of a TU to the CU depicted in FIG. 1. On the right side in FIG. 3, one or more TUs that can be set to C02 are depicted. For example, T01 that is a TU has a size of 32×32 pixels, and the depth of TU partition is equal to 0. T02 that is a TU has a size of 16×16 pixels, and the depth of TU partition is equal to 1. T03 that is a TU has a size of 8×8 pixels, and the depth of the TU partition is equal to 2.

What block partition is to be performed in order to set such blocks as a CU, a PU and a TU as described above to an image is determined typically on the basis of comparison in cost that affects the encoding efficiency. An encoder compares the cost, for example, between one CU of 2M×2M pixels and four CUs of M×M pixels, and if the encoding efficiency is higher where the four CUs of M×M pixels are set, then the encoder determines that a CU of 2M×2M pixels is to be partitioned into four CUs of M×M pixels.

<Scanning Order of CU and PU>

When an image is to be encoded, CTBs (or LCUs) set in a lattice pattern in the image (or a slice or a tile) are scanned in a raster scan order.

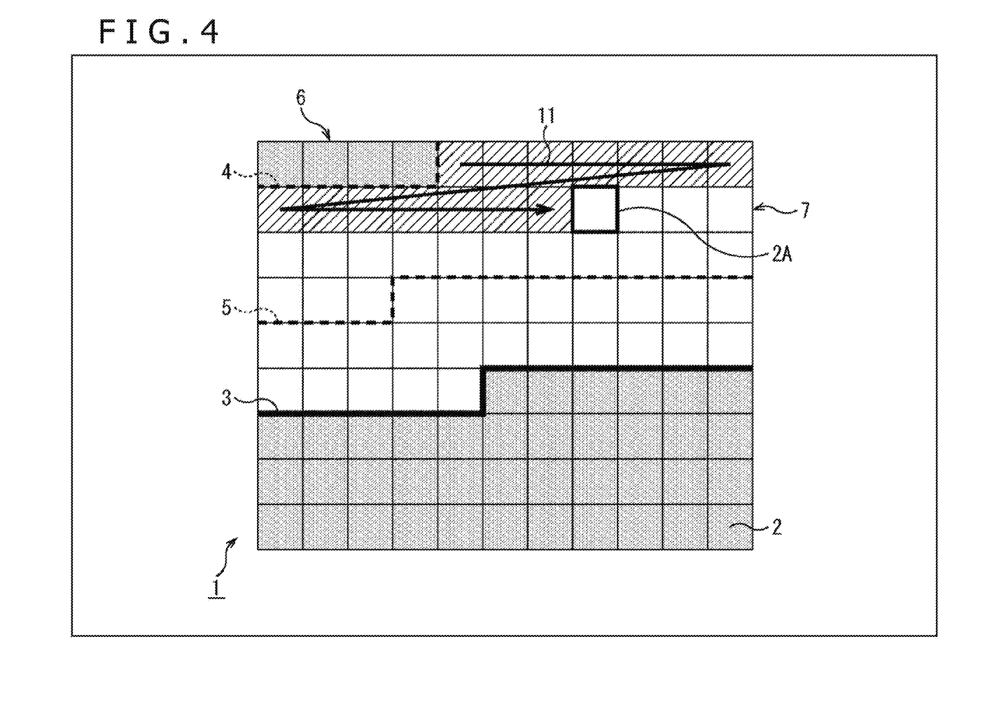

For example, a picture 1 of FIG. 4 is processed for each LCU 2 indicated by a quadrangle in FIG. 4. It is to be noted that, in FIG. 4, a reference numeral is applied only to the LCU in the right lower corner for the convenience of illustration. The picture 1 is delimited by a slice boundary 3 indicated by a thick line in FIG. 4 to form two slices. The first slice (upper side slice in FIG. 4) of the picture 1 is further delimited by a slice segment boundary 4 and another slice segment boundary 5 each indicated by a broken line in FIG. 4. For example, the first slice segment (four LCUs 2 in the left upper corner in FIG. 4) of the picture 1 is an independent slice segment 6. Meanwhile, the second slice segment (LCU group between the slice segment boundary 4 and the slice segment boundary 5 in FIG. 4) in the picture 1 is a dependent slice segment 7.

In each slice segment, the respective LCUs 2 are processed in a raster scan order. For example, in the dependent slice segment 7, the respective LCUs 2 are processed in such an order as indicated by an arrow mark 11. Accordingly, for example, if the LCU 2A is a processing target, then the LCUs 2 indicated by a slanting line pattern are LCUs processed already at the point of time.

Then, within one CTB (or LCU), CUs are scanned in a Z order in such a manner as to follow the quad tree from left to right and from top to bottom.

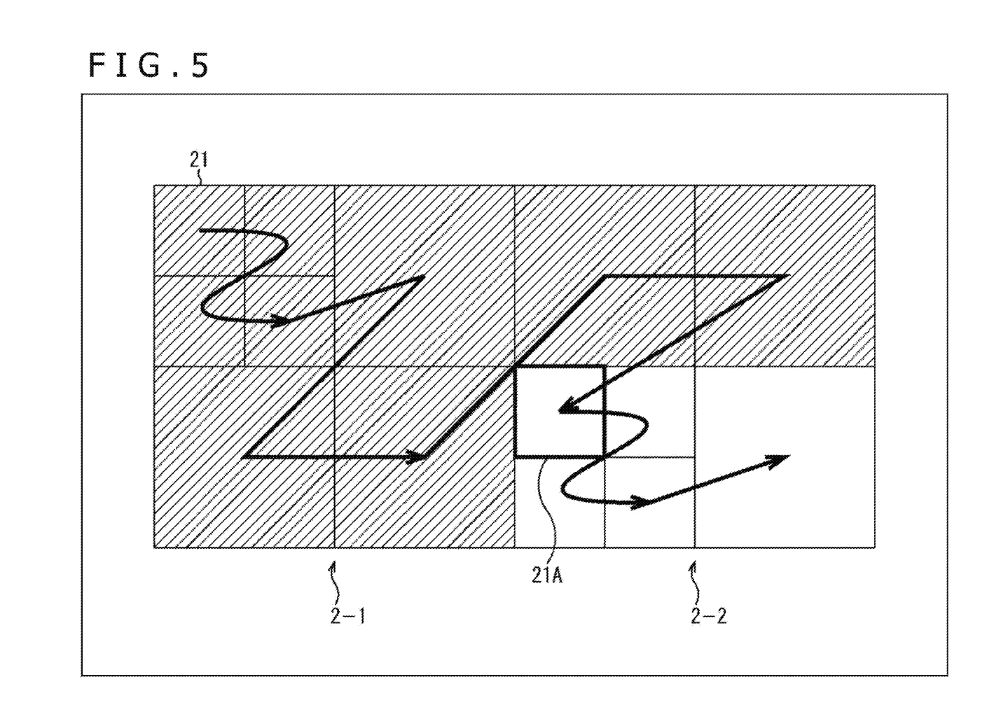

For example, FIG. 5 depicts a processing order of CUs in two LCUs 2 (LCU 2-1 and LCU 2-2). As depicted in FIG. 5, in the LCU 2-1 and the LCU 2-2, 14 CUs 21 are formed. It is to be noted that, in FIG. 5, a reference numeral is applied only to the CU in the left upper corner for the convenience of illustration. The CUs 21 are processed in an order indicated by an arrow mark (Z order). Accordingly, if it is assumed that the CU 21A is a processing target, for example, then the CUs 21 indicated by the slanting lines are CUs processed already at the point of time.

<Reference Pixel in Intra Prediction>

In intra prediction, pixels in a region (blocks such as LCUs, CUs or the like) processed already in generation of a prediction image (pixels of a reconstruction image) are referred to. In other words, although pixels on the upper side or the left side of a processing target region (block such as an LCU or a CU) can be referred to, pixels on the right side or the lower side cannot be referred to because they are not processed as yet.

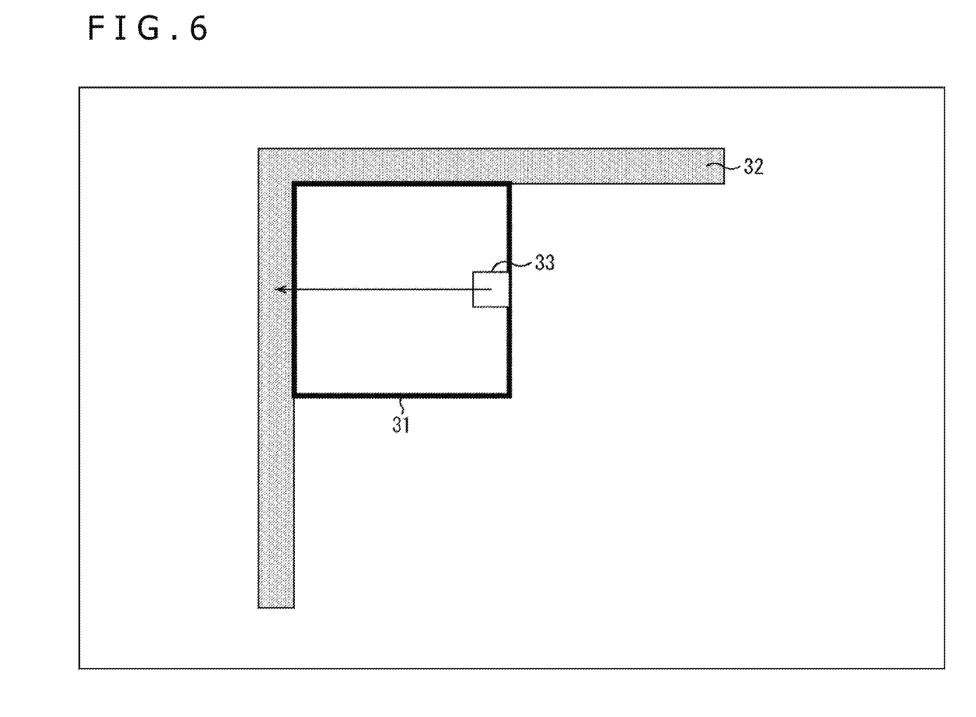

In particular, in intra prediction, as depicted in FIG. 6, for a processing target region 31, pixels in a gray region 32 of a reconstruction image (left lower, left, left upper, upper and right upper pixels of the processing target region 31) become candidates for a reference pixel (namely, can become reference pixels). It is to be noted that a left lower pixel and a left pixel with respect to the processing target region 31 are each referred to also as left side pixel with respect to the processing target region 31, and an upper pixel and a right upper pixel with respect to the processing target region 31 are each referred to also as upper side pixel with respect to the processing target region 31. A left upper pixel with respect to the processing target region 31 may be referred to as left side pixel with respect to the processing target region 31 or may be referred to as upper side pixel with respect to the processing target region 31. Accordingly, for example, where an intra prediction mode (prediction direction) is indicated by an arrow mark in FIG. 6 (horizontal direction), a prediction image (prediction pixel value) of a pixel 33 is generated by referring to a left pixel value with respect to the processing target region 31 (pixel at the tip of the arrow mark indicated in FIG. 6).

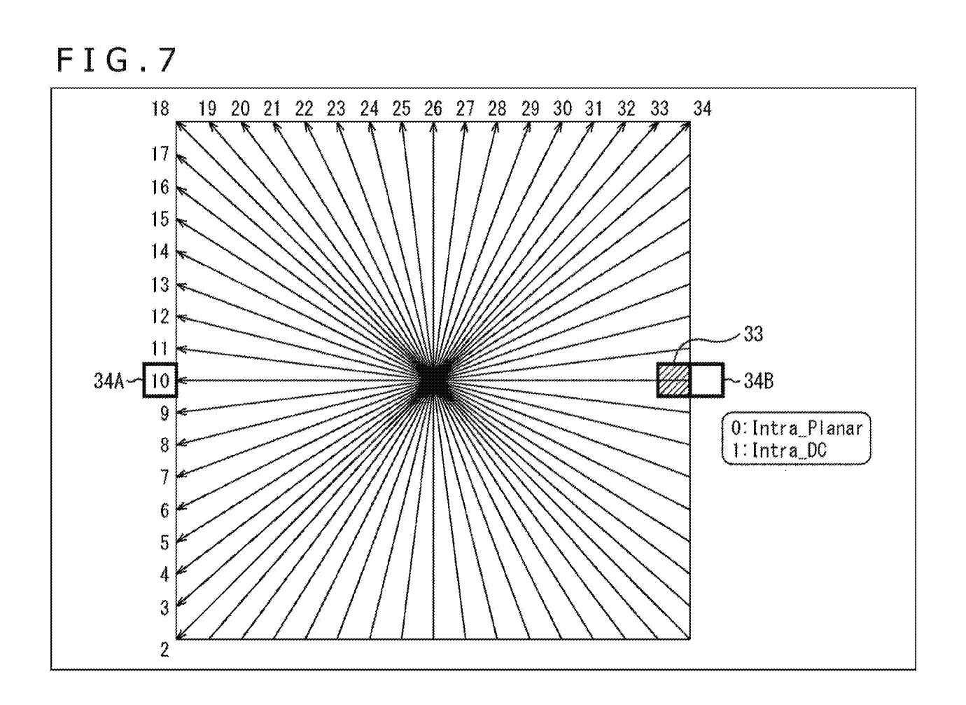

In intra prediction, as the distance between a processing target pixel and a reference pixel decreases, generally the prediction accuracy of the prediction image increases, and the code amount can be reduced or reduction of the picture quality of the decoded image can be suppressed. However, a region positioned on the right side or a region positioned on the lower side with respect to the processing target region 31 is not processed as yet and a reconstruction image does not exist as described above. Therefore, although the prediction mode is allocated from “0” to “34” as depicted in FIG. 7, the prediction mode is not allocated in a direction toward the right side or the bottom side (including a direction toward the right lower corner) of the processing target region 31 that is a non-processed region.

Accordingly, for example, when a pixel in a horizontal direction is to be referred to in prediction of the pixel 33 at the right end of the processing target region 31, a pixel 34B neighboring with the pixel 33 (pixel neighboring with the right side of the processing target region 31) is not referred, but a pixel 34A that is a pixel on the opposite side to the processing target pixel is referred to (prediction mode “10” is selected). Accordingly, the distance between the processing target pixel and the reference pixel increases, and there is the possibility that the prediction accuracy of the prediction image may decrease as much. In other words, there is the possibility that the prediction accuracy of a pixel near to the right side or the bottom side of the processing target region may degrade.

<Setting of Reference Pixel>

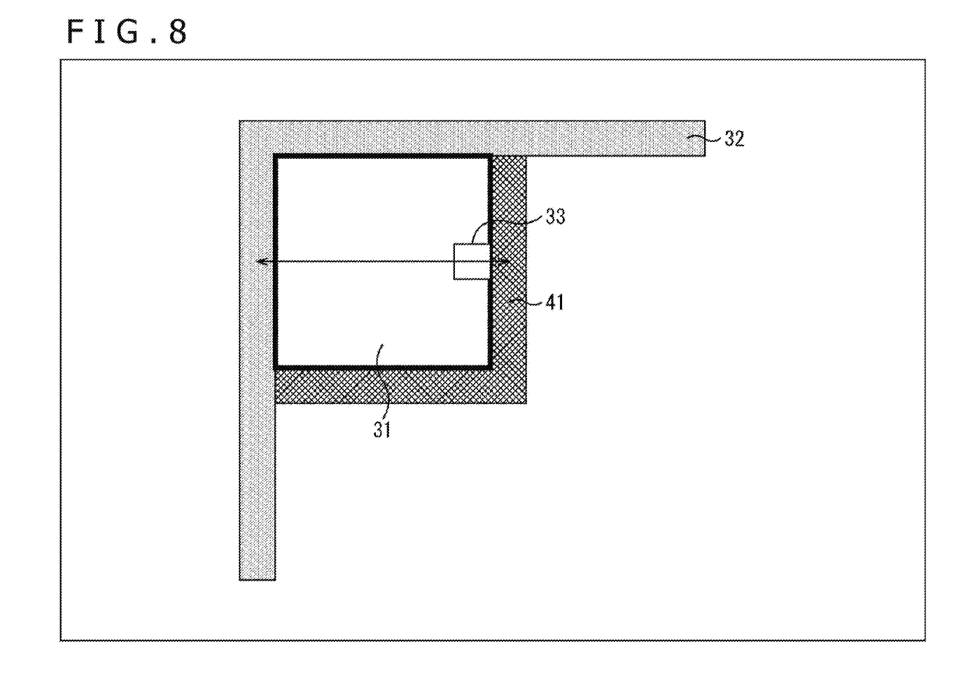

Therefore, it is made possible to set a reference pixel at a position at which a reference pixel is not set in intra prediction of AVC, HEVC or the like. The position of the reference pixel is arbitrary if it is a position different from the position of a reference pixel in the conventional technology. For example, it may be made possible to set a reference pixel at a position adjacent the right side of a processing target region (referred to also as current block) like a region 41 in FIG. 8 or at a position adjacent the lower side of a current block. It is to be noted that the reference pixel may not be positioned adjacent the current block. In other words, it may be made possible to set a reference pixel to the right side or the lower side with respect to a current block for which intra prediction is to be performed. Here, the region (block) is an arbitrary region configured from a single pixel or a plurality of pixels and is, for example, a TU, a PU, a CU, an SCU, an LCU, a CTU, a CTB, a macro block, a sub macro block, a tile, a slice, a picture or the like. Further, a pixel positioned on the right side with respect to a current block may include not only a pixel positioned on the right of the current block but also a pixel positioned rightwardly upwards of the current block. Further, a pixel on the lower side with respect to the current block may include not only a pixel positioned below the current block but also a pixel positioned leftwardly downwards with respect to the current block. Furthermore, the pixel positioned rightwardly downwards with respect to the current block may be a pixel on the right side with respect to the current block or a pixel on the lower side with respect to the current block.

By setting a greater number of candidates for a reference pixel than before in this manner, it becomes possible to perform intra prediction utilizing reference pixels at more various positions. Consequently, since it becomes possible to refer to a reference pixel with higher prediction accuracy, reduction of the quality (prediction accuracy) of a prediction image can be suppressed and a residual component can be reduced and besides reduction of the encoding efficiency can be suppressed. In short, the code amount of a bit stream can be reduced. In other words, the quality of a decoded image can be improved by keeping the code amount. Further, since the number of pixels that can be referred to increases, discontinuous components on the boundary between blocks in intra prediction decrease, and therefore, the picture quality of a decoded image can be improved.

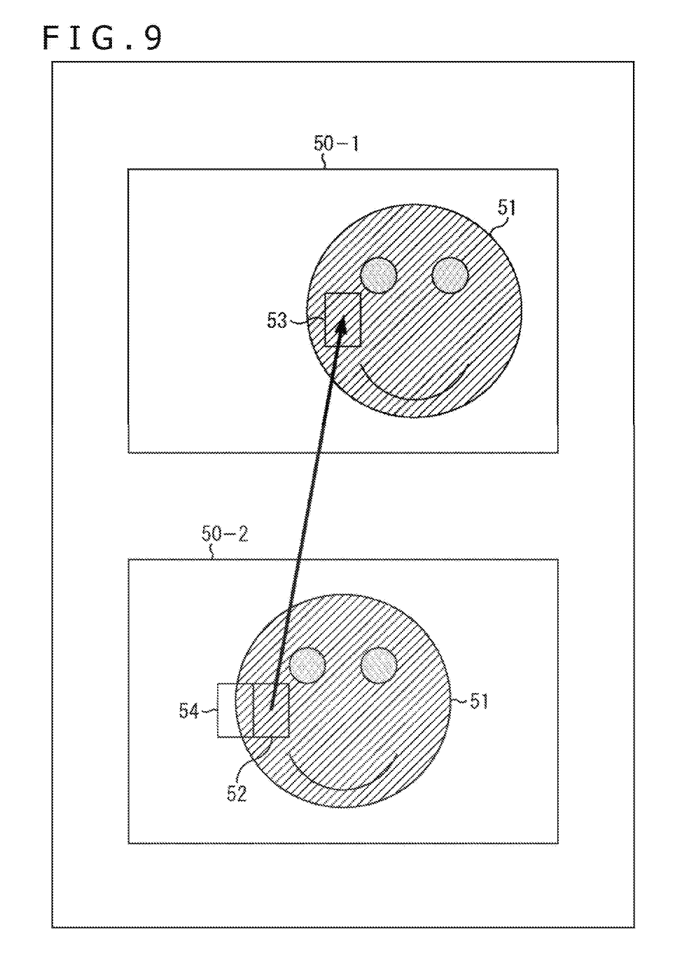

For example, a frame 50-1 in FIG. 9 is a frame preceding in time to a frame 50-2. In particular, the images are two frames of a moving image in which the face 51 moves from the right to the left in FIG. 9. When this moving image is to be encoded, a region 52 of the frame 50-2 can be inter-predicted with high prediction accuracy by using a reconstruction image of a region 53 of the frame 50-1.

However, there is the possibility that, in a region 54 of the frame 50-2, sufficient prediction accuracy may not be obtained by similar inter prediction. This is because the position of the face 51 is different between the frame 50-1 and the frame 50-2. The region 54 includes not only the face 51 but also a portion of the background. Since the position of the face 51 in the frame 50-1 is different from that in the frame 50-2, the images of the background part may not be same (or proximate). If the images of the background part are different from each other, then there is the possibility that the prediction accuracy may degrade as much by the inter prediction described above.

However, in intra prediction, since only it is possible to refer to reconstruction images at left, left upper, upper, and right upper positions and so forth of the region 54, there is the possibility that sufficient prediction accuracy may not be obtained. Especially in the case of the example of FIG. 9, since the region 54 includes a plurality of regions that are much different in characteristic from each other like the part of the face 51 and the part of the background, there is the possibility that the prediction accuracy in intra prediction may reduce.

Therefore, it is made possible to set a reference pixel at a position adjacent the right side of the region 54 or at a position adjacent the lower side of the region 54 as described hereinabove. For example, it is made possible to refer to a pixel at a position of the region 52. This makes it possible to suppress reduction of the prediction accuracy in intra prediction. Further, since the picture quality of a prediction image is improved, residual information can be reduced, and the bit amount to be included in a bit stream can be reduced. In other words, reduction of the encoding efficiency can be suppressed.

For example, in the case of conventional intra prediction, left, left upper and upper reconstruction images of a current block are referred to. Therefore, when the region 54 is to be intra-predicted, it is difficult to accurately predict a portion at an end of the face 51, and there is the possibility that such an image that the face 51 is cut at an end may be obtained. That is, there is the possibility that the picture quality may be deteriorated discontinuously in the vicinity of the boundary of the bottom and the right of the region 54. As described hereinabove, by making it possible to set a reference pixel to a position adjacent the right side of the region 54 or a position adjacent the lower side of the region 54 as described above, it is possible to suppress occurrence of discontinuity on such a region boundary and suppress reduction of the picture quality.

A generation method of such a reference pixel as described above can be selected arbitrarily.

(A) For example, a reference pixel may be generated using an arbitrary pixel (existing pixel) of a reconstruction image generated by a prediction process performed already.

(A-1) This existing pixel may be any pixel if it is a pixel of a reconstruction image (namely, a pixel for which a prediction process is performed already).

(A-1-1) For example, the existing pixel may be a pixel of a picture of a processing target (also referred to as current picture). For example, the existing pixel may be a pixel positioned in the proximity of a reference pixel to be set in the current picture. Alternatively, the existing pixel may be, for example, a pixel, which is positioned at a position same as that of a reference pixel to be set or a pixel positioned in the proximity of the reference pixel, of an image of a different component of the current picture. The pixel of the different component is, for example, where the reference pixel to be set is a luminance component, a pixel of a color difference component or the like.

(A-1-2) Alternatively, the existing pixel may be, for example, a pixel of an image of a frame processed already (past frame). For example, the existing pixel may be a pixel, which is positioned at a position same as that of the reference pixel to be set, of an image in a past frame different from the frame of the processing target (also referred to as current frame), or may be a pixel positioned in the proximity of the reference pixel or else may be a pixel at a destination of a motion vector (MV).

(A-1-3) Further, where the encoding method is multi-view encoding that encodes images at a plurality of points of view (views), the existing pixel may be a pixel of an image of a different view. For example, the existing pixel may be a pixel of the current picture of a different view. For example, the existing pixel may be a pixel, which is positioned in the proximity of the reference pixel to be set, of the current picture of a different view. Alternatively, for example, the existing pixel may be a pixel, which is positioned at a position same as that of the reference pixel to be set, of an image of a different component of the current picture of a different view, or may be a pixel positioned in the proximity of the reference pixel. Alternatively, the existing pixel may be a pixel of an image of a past frame of a different view, for example. For example, the existing pixel may be a pixel, which is positioned at a position same as that of the reference pixel to be set, of an image of a past frame of a different view, or may be a pixel positioned in the proximity of the reference pixel or else may be a pixel at a destination of a motion vector (MV).

(A-1-4) Alternatively, where the encoding method is hierarchical encoding of encoding images of a plurality of hierarchies (layers), the existing pixel may be a pixel of an image of a different layer. For example, the existing pixel may be a pixel of a current picture of a different layer. For example, the existing pixel may be a pixel, which is positioned in the proximity of the reference pixel to be set, of a current picture of a different layer. Alternatively, for example, the existing pixel may be a pixel, which is positioned at a position same as that of the reference pixel to be set, of an image of a different component of the current picture of a different layer or may be a pixel positioned in the proximity of the reference pixel. Further, for example, the existing pixel may be a pixel of an image of a past frame of a different layer. For example, the existing pixel may be a pixel, which is positioned at a position same as that of the reference pixel to be set, of an image of a past frame of a different layer or may be a pixel positioned in the proximity of the reference pixel or else may be a pixel at a destination of a motion vector (MV).

(A-1-5) Alternatively, two or more of the pixels among the respective pixels described hereinabove in (A-1-1) to (A-1-4) may be used.

(A-1-6) Alternatively, a single one or a plurality of ones from among two or more ones of the respective pixels described hereinabove in (A-1-1) to (A-1-4) may be selected and used as existing pixels. An arbitrary method may be used as the selection method in this case. For example, selectable pixels may be selected in accordance with a priority order. Alternatively, a pixel may be selected in accordance with a cost function value where each pixel is used as a reference pixel. Alternatively, a pixel may be selected in response to a designation from the outside such as, for example, a user or control information. Further, it may be made possible to set (for example, select) a selection method of such pixels to be utilized as the existing pixel as described above. It is to be noted that, where a pixel (position of a pixel) to be utilized as the existing pixel is set (selected) in this manner, information relating to the setting (selection) (for example, which pixel (pixel at which position) is to be used as the existing pixel, what selection method is used and so forth) may be transmitted to the decoding side.

(A-2) An arbitrary method may be used as a generation method of such a reference pixel in which an existing pixel is used.

(A-2-1) For example, the reference pixel may be generated directly utilizing an existing pixel. For example, a pixel value of an existing pixel may be duplicated (copied) to generate a reference pixel. In short, in this case, a number of reference pixels equal to the number of existing pixels are generated (in other words, a number of existing pixels equal to the number of reference pixels to be set are used).

(A-2-2) Alternatively, a reference pixel may be generated, for example, utilizing an existing pixel indirectly. For example, a reference pixel may be generated by interpolation or the like in which an existing pixel is utilized. In short, in this case, a greater number of reference pixels than the number of existing pixels are generated (in other words, a smaller number of existing pixels than the number of reference pixels to be set are used).

An arbitrary method may be used as the method for interpolation. For example, a reference pixel set on the basis of an existing pixel may be further duplicated (copied) to set a different reference pixel. In this case, the pixel values of the reference pixels set in this manner are equal. Alternatively, for example, a pixel value of a reference pixel set on the basis of an existing pixel may be linearly transformed to set a different reference pixel. In this case, the reference pixels set in this manner have pixel values according to a function for the linear transformation. An arbitrary function may be used as the function for the linear transformation, and the linear function may be a straight line (a primary function or like such as, for example, a proportional function) or may be a curve (for example, a function like an inverse proportional function or a quadratic or more function or the like). Alternatively, for example, a pixel value of a reference pixel set on the basis of an existing pixel may be nonlinearly transformed to set a different reference pixel.

It is to be noted that two or more of the generation methods described in (A-2-1) and (A-2-2) above may be used together. For example, some reference pixels may be generated by copying while the other reference pixels are determined by linear transformation. Alternatively, a single method or a plurality of method may be selected from among two or more of the generation methods described hereinabove. An arbitrary method may be used as the selection method in this case. For example, a selection method may be selected in accordance with cost function values where the respective methods are used. Further, a selection method may be selected in response to a designation from the outside such as, for example, a user or control information. It is to be noted that, where a generation method is set (selected) in this manner, information relating to the setting (selection) (for example, which method is to be used, parameters necessary for the method utilized thereupon and so forth) may be transmitted to the decoding side.

(B) Alternatively, a reference pixel may be generated by inter prediction. For example, inter prediction is performed for some region within a certain processing target region (current block), and then intra prediction is performed for the other region. Further, a reconstruction image generated using the prediction image of inter prediction is used to set a reference pixel to be used in intra prediction (reference pixel at a position that is not set in intra prediction of AVC, HEVC or the like). Such a prediction process as just described is referred to also as inter-destination intra prediction process. Details of the inter-destination intra prediction process are hereinafter described.

(C) Alternatively, as the generation method of a reference pixel, both of the various methods in which an existing pixel is used and the methods in which a reference image is generated by inter prediction described above in (A) and (B) may be used in conjunction. For example, some reference pixels may be generated using existing pixels while the other reference pixels are generated by inter prediction. Alternatively, as a generation method of a reference pixel, some of the various methods (a single method or a plurality of methods) described hereinabove in (A) and (B) may be selected. An arbitrary method may be used as the selection method in this case. For example, the generation methods may be selected in accordance with a priority order determined in advance. Further, a generation method or methods may be selected in response to cost function values where the respective methods are used. Furthermore, a generation method or methods may be selected in response to a designation from the outside such as, for example, a user or control information. It is to be noted that, where a generation method of a reference pixel is set (selected) in this manner, information relating to the setting (selection) (for example, which method is to be used, parameters necessary for the method utilized thereupon and so forth) may be transmitted to the decoding side.

A way of reference to a reference pixel in intra prediction set in such a manner as described above (generation method of an intra prediction image) can be determined arbitrarily.

(D) For example, similarly as in the case of AVC, HEVC or the like, one mode may be selected as an intra prediction mode such that, for each pixel of a current block, one reference pixel corresponding to the intra prediction mode is referred to to generate a prediction image (prediction pixel value).

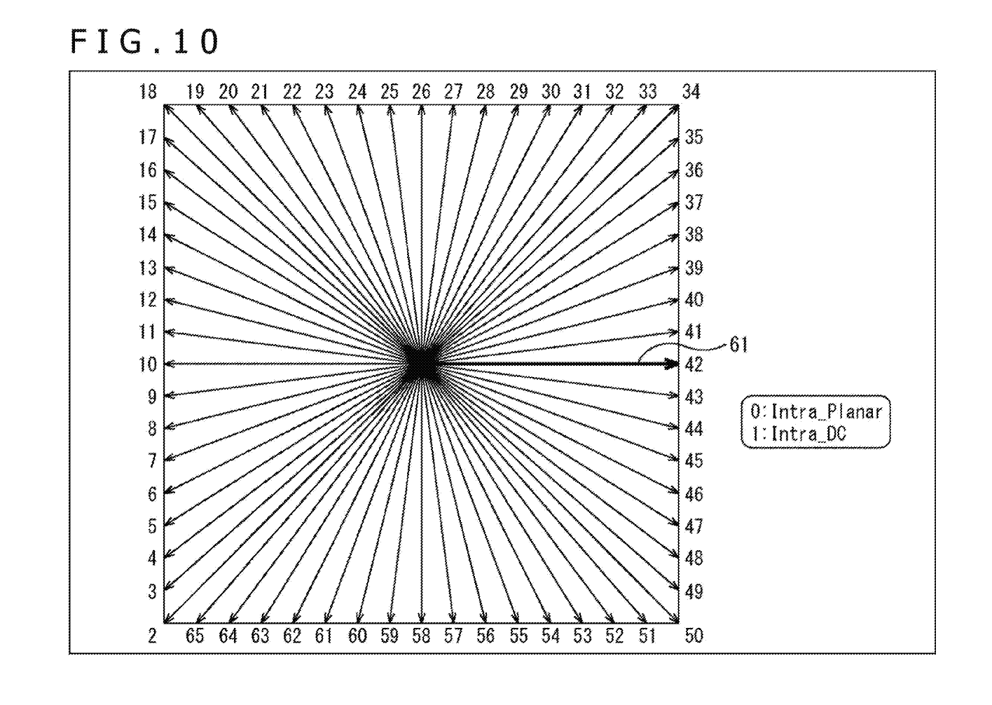

In this case, by setting a reference pixel to the right side or the lower side with reference to a current block, which is not set in intra prediction of AVC, HEVC or the like, the number of candidates for an intra prediction mode can be increased as in an example of FIG. 10. In the case of the example of FIG. 10, intra prediction modes “35” to “65” are set newly. For example, if the intra prediction mode “42” is selected as indicated by an arrow mark 61 of FIG. 10, then a reference pixel positioned on the right of the processing target pixel can be referred to. Since the number of candidates for the intra prediction mode (namely, the number of candidates for a prediction direction) increases in this manner, a reference pixel of higher prediction accuracy can be referred to, and reduction of the encoding efficiency can be suppressed. It is to be noted that, in this case, similarly as in the case of AVC or HEVC, information (index and so forth) that designates an intra prediction mode selected in intra prediction may be transmitted to the decoding side.

(E) Alternatively, for example, one mode may be selected as an intra prediction mode such that a plurality of reference pixels corresponding to an intra prediction mode for each pixel of a current block can be utilized for generation of a prediction image. For example, it may be made possible to utilize (refer to) two pixels including a reference pixel in a prediction direction corresponding to an intra prediction mode and another reference pixel positioned in the opposite direction (direction different by 180 degrees) to the prediction direction.

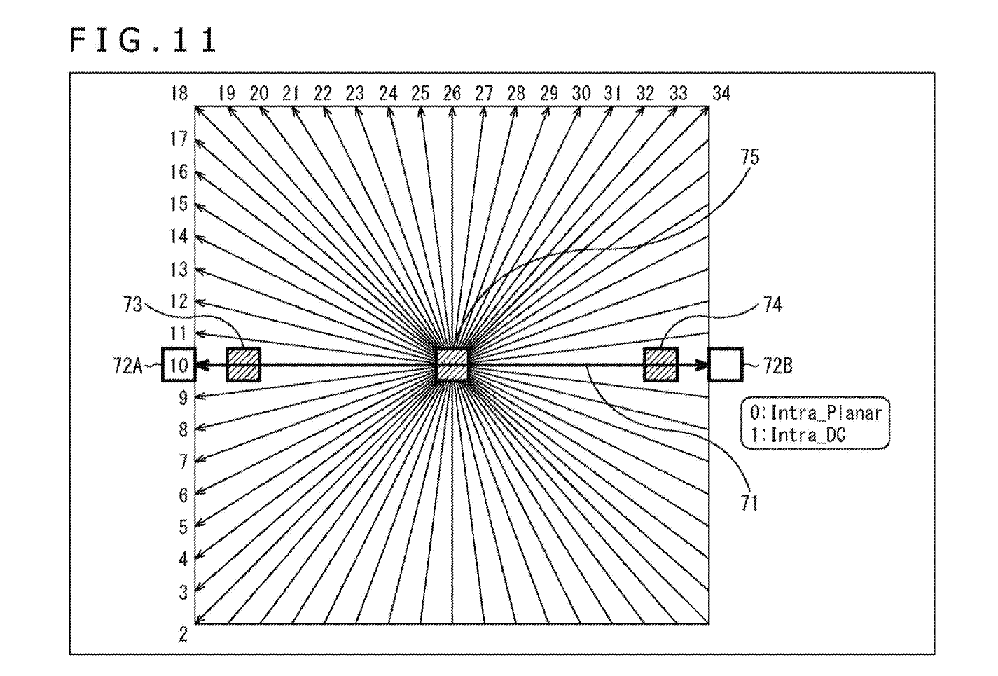

In this case, the number of candidates for an intra prediction mode is similar to that in the case of intra prediction in AVC, HEVC or the like as in an example depicted in FIG. 11. However, when one pixel of a prediction image is to be generated, reference pixels of two or more pixels can be referred to. An arbitrary method may be used as the reference method to such a plurality of reference pixels that can be referred to.

(E-1) For example, some (a single or a plurality of) reference pixels from among a plurality of reference pixels that can be referred to may be selected. For example, a reference pixel may be selected in response to a positional relationship between a processing target pixel (current pixel) for which a prediction pixel value is to be generated and the reference pixel. For example, a reference pixel nearer in position may be selected. For example, in the case of FIG. 11, an intra prediction mode “10” is selected. Accordingly, where a prediction image (prediction pixel value) of pixels 73 to 75 is to be generated, a reference pixel 72A and another reference pixel 72B positioned in the opposite directions to each other can be referred to. When a prediction image (prediction pixel value) of the pixel 73 is to be generated, since the reference pixel 72A is nearer to the pixel 73, the reference pixel 72A is referred to to generate a prediction pixel value of the pixel 73. In contrast, when a prediction image (prediction pixel value) of the pixel 74 is to be generated, since the reference pixel 72B is nearer to the pixel 74, the reference pixel 72B is referred to to generate a prediction pixel value of the pixel 74. It is to be noted that, when a prediction image (prediction pixel value) of the pixel 75 is to be generated, since the reference pixel 72A and the reference pixel 72B are positioned at equal distances from the pixel 75, one of the reference pixel 72A and the reference pixel 72B is referred to to generate a prediction pixel value of the pixel 75. Since this makes it possible to refer to a nearer pixel, reduction of the prediction accuracy can be suppressed.

Alternatively, a reference pixel may be selected in response not to a positional relationship between a current pixel and the reference pixel but to a pixel value of an input image. For example, a reference pixel having a pixel value nearer to that of a current pixel of an input image may be selected. It is to be noted that, in those cases, for example, information or the like that designates a reference pixel to be referred to may be transmitted to the decoding side.

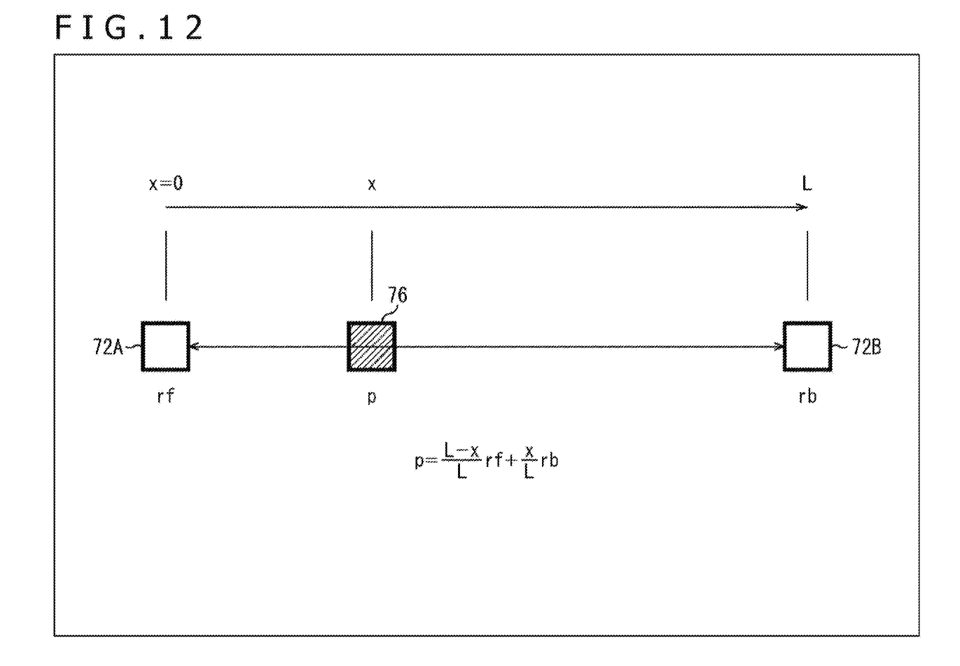

(E-2) Alternatively, a plurality of reference pixels may be referred to. For example, an average value of pixel values of a plurality of reference pixels or a value according to the average value may be determined as a prediction pixel value of a current pixel. It is to be noted that, for example, an arbitrary function value such as a median, a minimum value or a maximum value may naturally be used in place of an average value. Alternatively, pixel values of a plurality of reference pixels may be weighted-synthesized (also referred to as weighted-added) in response a positional relationship with a pixel position of the current pixel. For example, in the case of the example of FIG. 11, weighted addition may be performed as indicated in FIG. 12. In FIG. 12, x indicates a coordinate in the horizontal direction. For example, the x coordinate of a reference pixel 72A is “0” and the pixel value of it is “rf.” Meanwhile, the x coordinate of a reference pixel 72B is “L” and the pixel value of it is “rb.” In this case, the prediction pixel value “p” of a pixel 76 at the x coordinate “x” can be determined in accordance with the following expression (1).

$$p = \frac{L - x}{L} rf + \frac{x}{L} rb \qquad ( 1 )$$

Naturally, the pixel number of reference pixels that can be referred to may be 3 pixels or more. It is to be noted that, where a plurality of reference pixels are referred to in such a manner as described above, information indicative of an expression, coefficients and so forth for arithmetic operation in which the pixel values of the plurality of reference pixels are used may be transmitted to the decoding side.

(E-3) Further, the plurality of methods described in (E-1) and (E-2) may be used together. For example, for some of pixels of a current block, a prediction image may be generated using an average value of pixel values of a plurality of reference pixels while, for some other ones of the pixels of the current block, a prediction image is generated using weighted addition of a plurality of reference pixels and, for the remaining pixels, a prediction image is generated using some of the plurality of reference pixels. Alternatively, it may be made possible to set to which portions of a current block individual methods are to be applied. In this case, information that specifies a range to which each method is to be applied (partial region of the current block) may be transmitted to the decoding side. Alternatively, information that designates which method is to be applied to each partial region of the current block may be transmitted to the decoding side.

(E-4) Further, some of the methods described in (E-1) to (E-3) above may be selected. The selection method may be arbitrarily determined. For example, a selection method may be selected in accordance with a priority order determined in advance. Alternatively, a method may be selected in accordance with a cost function value where each method is used. Further, a method may be selected in response to a designation from the outside such as, for example, a user or control information. It is to be noted that, where a generation method for a prediction image (utilization method of a reference pixel) is set (selected) in this manner, information relating to the setting (selection) (for example, which method is to be used, parameters necessary for the method used thereupon and so forth) may be transmitted to the decoding side.

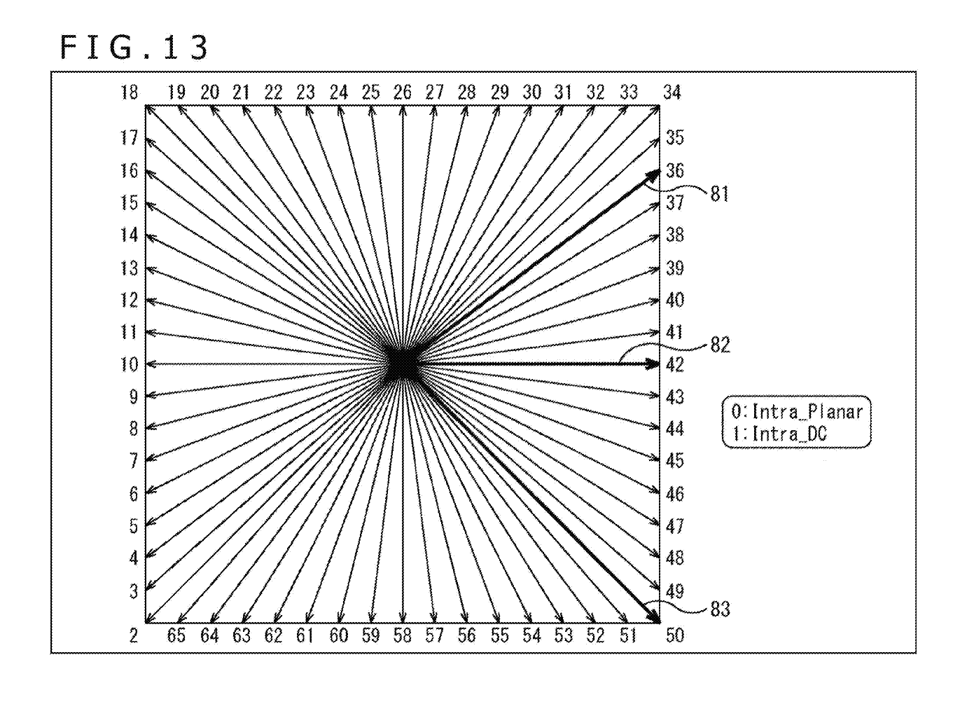

(F) For example, it may be made possible to select a plurality of modes as the intra prediction mode. For example, in the case of FIG. 13, an intra prediction mode “36” indicated by an arrow mark 81, another intra prediction mode “42” indicated by another arrow mark 82 and a further intra prediction mode “50” indicated by a further arrow mark 83 are selected. In particular, in this case, prediction in three directions is possible (reference pixels in the three directions can be referred to). Accordingly, since it is possible to select and refer to a reference pixel having higher prediction accuracy or to refer to and predict a plurality of reference pixels, it is possible to suppress reduction of the prediction accuracy in intra prediction and suppress reduction of the encoding efficiency.

(F-1) It is to be noted that the use method (of reference pixels) of a plurality of intra prediction modes can be determined arbitrarily. For example, it may be made possible to partition a current block into a plurality of partial regions (regions configured from a signal pixel or a plurality of pixels) and set prediction modes different from each other to the partial regions. By this method, since the prediction modes of the partial regions can be set independently of each other, for example, also it is possible to form a plurality of regions in which prediction directions are different from each other in the current block. For example, in such a case that the current block is a boundary portion between a plurality of pictures, there is the possibility that prediction modes suitable for the individual pictures may be set. It is to be noted that, in this case, information indicative of the setting of partial regions or the prediction modes and so forth to be applied to the partial regions may be transmitted to the decoding side.

(F-2) Alternatively, for example, a plurality of intra prediction modes (prediction directions or reference pixels) may be mixed. For example, a way of such mixture may be set in response to a pixel value, a pixel position or the like. For example, a plurality of intra prediction modes may be mixed after weighted in response to a pixel position of a current pixel. It is to be noted that such mixture may be mixture of directions or may be mixture of pixel values of reference pixels. In particular, prediction directions after mixture may be referred to or pixel values of reference pixels of respective prediction directions before mixture may be mixed. It is to be noted that, in this case, information indicative of designation of prediction modes to be mixed, a manner of mixture or the like may be transmitted to the decoding side.

(F-3) Alternatively, for example, the methods described in (F-1) and (F-2) above may be used together. In particular, in some of regions of a current block, one of a plurality of intra prediction modes may be selected while, in the other regions, the plurality of intra prediction modes are mixed.

(F-4) Alternatively, some of the methods described in (F-1) to (F-3) above may be selected. The selection method in this case may be determined arbitrarily. The methods may be selected in accordance with a priority order determined in advance. Alternatively, a method may be selected in response to a cost function value where each method is used. For example, a method may be selected in accordance with a priority order. Alternatively, a method may be selected in accordance with a cost function value where each method is used. Further, a method may be selected in response to a designation from the outside such as, for example, a user or control information. It is to be noted that, where a use method of an intra prediction mode is set (selected) in this manner, information relating to the setting (selection) (for example, which method is to be used, parameters necessary for the method utilized thereupon and so forth) may be transmitted to the decoding side.

It is to be noted that, for example, in the case of FIG. 8, when the intra prediction mode is “2” or “34,” there is the possibility that a plurality of reference pixels may exist in the same prediction direction. For example, where the intra prediction mode is “34,” if viewed from a right lower pixel position of the processing target region 31, then not only a pixel in the region 32 but also a pixel in the region 41 can become a reference pixel. In such a case as just described, both of the pixels in the region 32 and the region 41 may be set as reference pixels. Generally, a nearer pixel improves the prediction accuracy.

<Intra Prediction>

As described above, according to the present technology, intra prediction different from intra prediction in AVC or HEVC or from inter prediction is performed in a prediction process.

For example, a reference pixel adjacent a current block may be set to three or more sides of a current block such that intra prediction is performed using reference pixels including the set reference pixels.

Alternatively, for example, a reference pixel adjacent a current block may be set on at least two opposing sides of the current block such that intra prediction is performed using reference pixels including the set reference pixels.

Alternatively, for example, one or both of a reference pixel adjacent the right side of a current block and a reference pixel adjacent the lower side of the current block may be set such that intra prediction is performed using reference pixels including the set pixels.

Alternatively, for example, a reference pixel positioned in a block for which prediction has been performed and a reference pixel positioned in an adjacent block for which intra prediction has not been performed may be set such that intra prediction is performed using the reference pixels.

Alternatively, for example, a reference pixel positioned in an encoded block for which processing has been performed and a reference pixel, which is positioned adjacent a current prediction block of a current encoded block, in a current encoded block or an encoded block that has not been processed as yet are set such that intra prediction is performed using the reference pixels. Alternatively, for example, a reference pixel positioned in a processed encoded block and a reference pixel positioned in a non-processed encoded block may be set such that intra prediction is performed using the reference pixels.

### 2. Second Embodiment

<Image Encoding Apparatus>

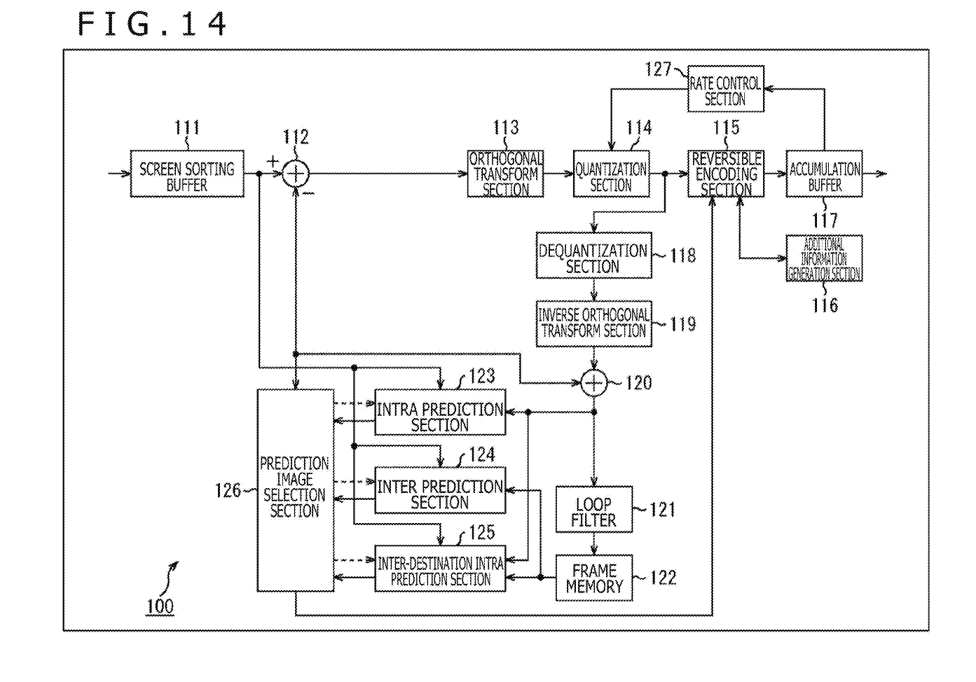

In the present embodiment, a particular example of inter-destination intra prediction described in (B) above and so forth of the first embodiment is described. FIG. 14 is a block diagram depicting an example of a configuration of an image encoding apparatus that is a mode of an image processing apparatus to which the present technology is applied. The image encoding apparatus 100 depicted in FIG. 14 encodes image data of a moving image using, for example, a prediction process of HEVC or a prediction process of a method conforming (or similar) to the prediction process of HEVC. It is to be noted that, in FIG. 14, main processing sections, flows of data and so forth are depicted, and elements depicted in FIG. 14 are not all elements. In other words, a processing section that is not indicated as a block in FIG. 14 may exist in the image encoding apparatus 100, or a process or a flow of data not depicted as an arrow mark or the like in FIG. 14 may exist.

As depicted in FIG. 14, the image encoding apparatus 100 includes a screen sorting buffer 111, an arithmetic operation section 112, an orthogonal transform section 113, a quantization section 114, a reversible encoding section 115, an additional information generation section 116, an accumulation buffer 117, a dequantization section 118 and an inverse orthogonal transform section 119. The image encoding apparatus 100 further includes an arithmetic operation section 120, a loop filter 121, a frame memory 122, an intra prediction section 123, an inter prediction section 124, an inter-destination intra prediction section 125, a prediction image selection section 126 and a rate controlling section 127.

The screen sorting buffer 111 stores images of respective frames of inputted image data in a displaying order of the images, sorts the stored images of the frames in the displaying order into those in an order of frames for encoding in response to GOPs (GOP: Group Of Picture), and supplies the images of the frames in the sorted order to the arithmetic operation section 112. Further, the screen sorting buffer 111 supplies the images of the frames in the sorted order also to the intra prediction section 123 to inter-destination intra prediction section 125.

The arithmetic operation section 112 subtracts a prediction image supplied from one of the intra prediction section 123 to inter-destination intra prediction section 125 through the prediction image selection section 126 from an image read out from the screen sorting buffer 111 and supplies difference information (residual data) to the orthogonal transform section 113. For example, in the case of an image for which intra encoding is to be performed, the arithmetic operation section 112 subtracts a prediction image supplied from the intra prediction section 123 from an image read out from the screen sorting buffer 111. Meanwhile, for example, in the case of an image for which inter encoding is to be performed, the arithmetic operation section 112 subtracts a prediction image supplied from the inter prediction section 124 from an image read out from the screen sorting buffer 111. Alternatively, for example, in the case of an image for which inter-destination intra encoding is to be performed, the arithmetic operation section 112 subtracts a prediction image supplied from the inter-destination intra prediction section 125 from an image read out from the screen sorting buffer 111.

The orthogonal transform section 113 performs discrete cosine transform or orthogonal transform such as Karhunen Loéve transform for the residual data supplied from the arithmetic operation section 112. The orthogonal transform section 113 supplies the residual data after the orthogonal transform to the quantization section 114.

The quantization section 114 quantizes the residual data after the orthogonal transform supplied from the orthogonal transform section 113. The quantization section 114 sets a quantization parameter on the basis of information relating to a target value of a code amount supplied from the rate controlling section 127 to perform the quantization. The quantization section 114 supplies the residual data after the quantization to the reversible encoding section 115.

The reversible encoding section 115 encodes the residual data after the quantization by an arbitrary encoding method to generate encoded data (referred to also as encoded stream).

As the encoding method of the reversible encoding section 115, for example, variable length encoding, arithmetic coding and so forth are available. As the variable length encoding, for example, CAVLC (Context-Adaptive Variable Length Coding) prescribed by the H.264/AVC method and so forth are available. Further, a TR code is used for a syntax process of coefficient information data called coeff_abs_level_remaining. As the arithmetic coding, for example, CABAC (Context-Adaptive Binary Arithmetic Coding) and so forth are available.

Further, the reversible encoding section 115 supplies various kinds of information to the additional information generation section 116 such that the information may be made information (additional information) to be added to encoded data. For example, the reversible encoding section 115 may supply information added to an input image or the like and relating to the input image, encoding and so forth to the additional information generation section 116 such that the information may be made additional information. Further, for example, the reversible encoding section 115 may supply the information added to the residual data by the orthogonal transform section 113, quantization section 114 or the like to the additional information generation section 116 such that the information may be made additional information. Further, for example, the reversible encoding section 115 may acquire information relating to intra prediction, inter prediction or inter-destination intra prediction from the prediction image selection section 126 and supply the information to the additional information generation section 116 such that the information may be made additional information. Further, the reversible encoding section 115 may acquire arbitrary information from a different processing section such as, for example, the loop filter 121 or the rate controlling section 127 and supply the information to the additional information generation section 116 such that the information may be made additional information. Furthermore, the reversible encoding section 115 may supply information or the like generated by the reversible encoding section 115 itself to the additional information generation section 116 such that the information may be made additional information.

The reversible encoding section 115 adds various kinds of additional information generated by the additional information generation section 116 to encoded data. Further, the reversible encoding section 115 supplies the encoded data to the accumulation buffer 117 so as to be accumulated.

The additional information generation section 116 generates information (additional information) to be added to the encoded data of image data (residual data). This additional information may be any information. For example, the additional information generation section 116 may generate, as additional information, such information as a video meter set (VPS (Video Parameter Set)), a sequence parameter set (SPS (Sequence Parameter Set)), a picture parameter set (PPS (Picture Parameter Set)) and a slice header. Alternatively, the additional information generation section 116 may generate, as the additional information, information to be added to the encoded data for each arbitrary data unit such as, for example, a slice, a tile, an LCU, a CU, a PU, a TU, a macro block or a sub macro block. Further, the additional information generation section 116 may generate, as the additional information, information as, for example, SEI (Supplemental Enhancement Information) or VUI (Video Usability Information). Naturally, the additional information generation section 116 may generate other information as the additional information.

The additional information generation section 116 may generate additional information, for example, using information supplied from the reversible encoding section 115. Further, the additional information generation section 116 may generate additional information, for example, using information generated by the additional information generation section 116 itself.

The additional information generation section 116 supplies the generated additional information to the reversible encoding section 115 so as to be added to encoded data.

The accumulation buffer 117 temporarily retains encoded data supplied from the reversible encoding section 115. The accumulation buffer 117 outputs the retained encoded data to the outside of the image encoding apparatus 100 at a predetermined timing. In other words, the accumulation buffer 117 is also a transmission section that transmits encoded data.

Further, the residual data after quantization obtained by the quantization section 114 is supplied also to the dequantization section 118. The dequantization section 118 dequantizes the residual data after the quantization by a method corresponding to the quantization by the quantization section 114. The dequantization section 118 supplies the residual data after the orthogonal transform obtained by the dequantization to the inverse orthogonal transform section 119.

The inverse orthogonal transform section 119 inversely orthogonally transforms the residual data after the orthogonal transform by a method corresponding to the orthogonal transform process by the orthogonal transform section 113. The inverse orthogonal transform section 119 supplies the inversely orthogonally transferred output (restored residual data) to the arithmetic operation section 120.

The arithmetic operation section 120 adds a prediction image supplied from the intra prediction section 123, inter prediction section 124 or inter-destination intra prediction section 125 through the prediction image selection section 126 to the restored residual data supplied from the inverse orthogonal transform section 119 to obtain a locally reconstructed image (hereinafter referred to as reconstruction image). The reconstruction image is supplied to the loop filter 121, intra prediction section 123 and inter-destination intra prediction section 125.

The loop filter 121 suitably performs a loop filter process for the decoded image supplied from the arithmetic operation section 120. The substance of the loop filter process is arbitrary. For example, the loop filter 121 may perform a deblocking process for the decoded image to remove deblock distortion. Alternatively, for example, the loop filter 121 may perform an adaptive loop filter process using a Wiener filter (Wiener Filter) to perform picture quality improvement. Furthermore, for example, the loop filter 121 may perform a sample adaptive offset (SAO (Sample Adaptive Offset)) process to reduce ringing arising from a motion compensation filter or correct displacement of a pixel value that may occur on a decode screen image to perform picture quality improvement. Alternatively, a filter process different from them may be performed. Furthermore, a plurality of filter processes may be performed.

The loop filter 121 can supply information of a filter coefficient used in the filter process and so forth to the reversible encoding section 115 so as to be encoded as occasion demands. The loop filter 121 supplies the reconstruction image (also referred to as decoded image) for which a filter process is performed suitably to the frame memory 122.

The frame memory 122 stores the decoded image supplied thereto and supplies, at a predetermined timing, the stored decoded image as a reference image to the inter prediction section 124 and the inter-destination intra prediction section 125.

The intra prediction section 123 performs intra prediction (in-screen prediction) of generating a prediction image using pixel values in a processing target picture that is the reconstruction image supplied as a reference image from the arithmetic operation section 120. The intra prediction section 123 performs this intra prediction in a plurality of intra prediction modes prepared in advance.

The intra prediction section 123 generates a prediction image in all intra prediction modes that become candidates, evaluates cost function values of the respective prediction images using the input image supplied from the screen sorting buffer 111 to select an optimum mode. After the optimum intra prediction mode is selected, the intra prediction section 123 supplies a prediction image generated by the optimum intra prediction mode, intra prediction mode information that is information relating to intra prediction such as an index indicative of the optimum intra prediction mode, the cost function value of the optimum intra prediction mode and so forth to the prediction image selection section 126.

The inter prediction section 124 performs an inter prediction process (motion prediction process and compensation process) using the input image supplied from the screen sorting buffer 111 and the reference image supplied from the frame memory 122. More particularly, the inter prediction section 124 performs, as the inter prediction process, a motion compensation process in response to a motion vector detected by performing motion prediction to generate a prediction image (inter prediction image information). The inter prediction section 124 performs such inter prediction in the plurality of inter prediction modes prepared in advance.

The inter prediction section 124 generates a prediction image in all inter prediction modes that become candidates. The inter prediction section 124 evaluates a cost function value of each prediction image using the input image supplied from the screen sorting buffer 111, information of the generated difference motion vector and so forth to select an optimum mode. After an optimum inter prediction mode is selected, the inter prediction section 124 supplies the prediction image generated in the optimum inter prediction mode, inter prediction mode information that is information relating to inter prediction such as an index indicative of the optimum inter prediction mode, motion information and so forth, cost function value of the optimum inter prediction mode and so forth to the prediction image selection section 126.

The inter-destination intra prediction section 125 is a form of a prediction section to which the present technology is applied. The inter-destination intra prediction section 125 performs an inter-destination intra prediction process using the input image supplied from the screen sorting buffer 111, reconstruction image supplied as a reference image from the arithmetic operation section 120 and reference image supplied from the frame memory 122. The inter-destination intra prediction process is a process of performing inter prediction for some region of a processing target region of an image, setting a reference pixel using a reconstruction image corresponding to a prediction image generated by the inter prediction and performing intra prediction using the set reference pixel for a different region of the processing target region.

For example, the inter-destination intra prediction section 125 may perform inter prediction for a region that is in contact with the right side or the lower side or both of the sides of a region for which intra prediction is to be performed in the processing target region, set one or both of a reference pixel adjacent the right side and a reference pixel adjacent the lower side of the region for which intra prediction is to be performed using a reconstruction image corresponding to a prediction image generated by the inter prediction and perform intra prediction using the set reference pixel or pixels.

Here, the processing target region may indicate an encoded block that becomes a unit of encoding while some region or the remaining region of the processing target region, namely, a region of a lower hierarchy, may indicate a prediction block that becomes a unit of a prediction process in the encoded block. In this case, the encoded block is, for example, a CU or the like. Meanwhile, the prediction block is, for example, a PU or the like. Naturally, the encoded block and the prediction block are not limited to the examples. For example, the encoded block and the prediction block may coincide with each other (namely, the processing target region is an encoded block and besides is a prediction block), and the region of the lower hierarchy may be a partial region in the prediction block.

More particularly describing, the inter-destination intra prediction section 125 performs an inter prediction process for some region in the processing target CU using the input image supplied from the screen sorting buffer 111 and the reference image supplied from the frame memory 122 similarly to the inter prediction section 124. Then, the inter-destination intra prediction section 125 sets a reference pixel using a reconstruction image generated from the prediction image (inter prediction image) generated by the inter prediction and performs intra prediction for the remaining region of the processing target region.

The inter-destination intra prediction section 125 performs such processes as described above in the plurality of modes and selects an optimum inter-destination intra prediction mode on the basis of the cost function values. After the optimum inter-destination intra prediction mode is selected, the inter-destination intra prediction section 125 supplies the prediction image generated in the optimum inter-destination intra prediction mode, inter-destination intra prediction mode information that is information relating to the inter-destination intra prediction, cost function value of the optimum inter-destination intra prediction mode to the prediction image selection section 126.

The prediction image selection section 126 controls the prediction process (intra prediction, inter prediction, or inter-destination intra prediction) by the intra prediction section 123 to inter-destination intra prediction section 125. More particularly, the prediction image selection section 126 sets a structure of a CTB (CU in an LCU) and a PU and performs control relating to the prediction process in those regions (blocks).

In regard to the control relating to the prediction process, for example, the prediction image selection section 126 controls the intra prediction section 123 to inter-destination intra prediction section 125 to cause them to each execute the prediction processes for the processing target region and acquires information relating to prediction results from each of them. The prediction image selection section 126 selects one of them to select a prediction mode in the region.

The prediction image selection section 126 supplies the prediction image of the selected mode to the arithmetic operation section 112 and the arithmetic operation section 120. Further, the prediction image selection section 126 supplies the prediction information of the selected mode and information (block information) relating to the setting of the block to the reversible encoding section 115.

The rate controlling section 127 controls the rate of the quantization operation of the quantization section 114 such that an overflow or an underflow may not occur on the basis of the code amount of the encoded data accumulated in the accumulation buffer 117.

<Inter-Destination Intra Prediction Section>

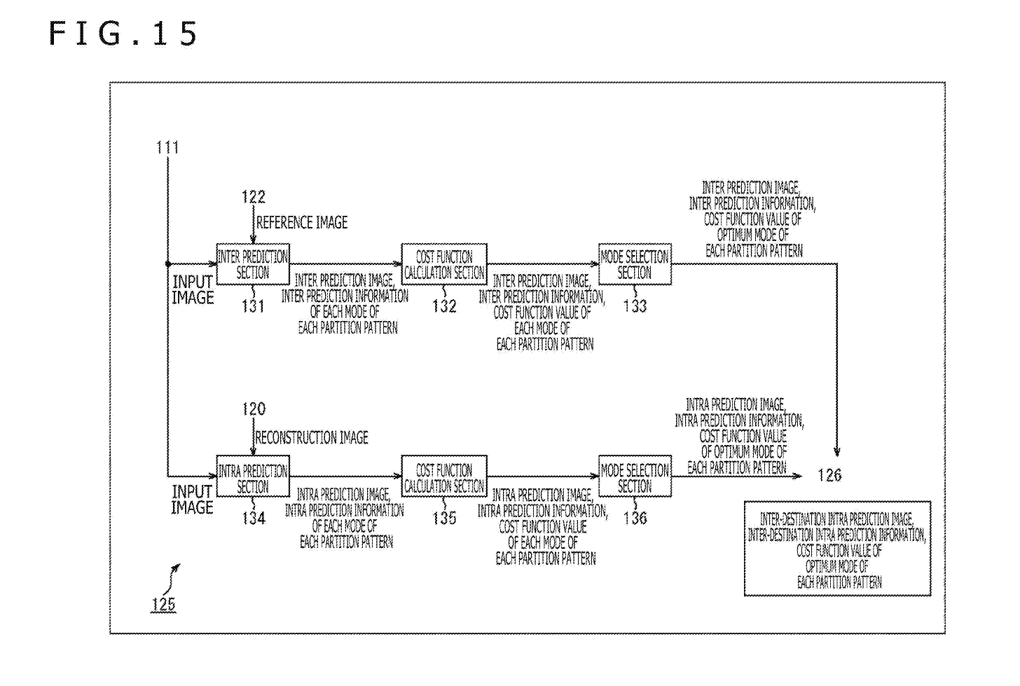

FIG. 15 is a block diagram depicting an example of a main configuration of the inter-destination intra prediction section 125. As depicted in FIG. 15, the inter-destination intra prediction section 125 includes an inter prediction section 131, a cost function calculation section 132, a mode selection section 133, an intra prediction section 134, a cost function calculation section 135 and a mode selection section 136.

The inter prediction section 131 performs a process relating to inter prediction for some region in a processing target region. The inter prediction section 131 acquires an input image from the screen sorting buffer 111 and acquires a reference image from the frame memory 122, and then performs inter prediction using them to generate an inter prediction image and inter prediction information of each mode of each partition pattern. Although details are hereinafter described, a region for which inter prediction is to be performed in a processing target region is set in response to a partition pattern of the processing target region. The inter prediction section 131 performs inter prediction for all partition patterns (for regions to which inter prediction is allocated in the respective partition patterns) to generate prediction images (and prediction information).

The inter prediction section 131 supplies the supplied information and the generated information to the cost function calculation section 132. For example, the inter prediction section 131 supplies the inter prediction images and the inter prediction information of the respective modes of the respective partition patterns to the cost function calculation section 132.

The cost function calculation section 132 calculates a cost function value of each mode of each partition pattern using the information supplied from the inter prediction section 131. Although this cost function is arbitrary, the cost function calculation section 132 performs, for example, RD optimization. In the RD optimization, a method whose RD cost is in the minimum is selected. The RD cost can be determined, for example, by the following expression (2).

J=D+λR (2)

Here, J indicates the RD cost. D indicates a distortion amount, and a squared error some (SSE: Sum of Square Error) from the input image is frequently used for the distortion amount D. R indicates a number of bits in a bit stream for the block (if the bit number is converted into a value per time, it corresponds to a bit rate). λ is a Lagrange coefficient in a Lagrange undetermined multiplier method.

The cost function calculation section 132 supplies the supplied information and the generated information to the mode selection section 133. For example, the cost function calculation section 132 supplies the inter prediction images, inter prediction information and cost function values of the respective modes of the respective partition patterns to the mode selection section 133.

The mode selection section 133 selects an optimum mode for each partition pattern on the basis of the cost function values. For example, the mode selection section 133 selects a mode whose RD cost is minimum for each partition pattern. The mode selection section 133 supplies information of the selected mode to the prediction image selection section 126. For example, the mode selection section 133 supplies the inter prediction image, inter prediction information and cost function value of the optimum mode of each partition pattern to the prediction image selection section 126.

The intra prediction section 134 performs processing relating to intra prediction for the remaining region in the processing target region. The intra prediction section 134 acquires an input image from the screen sorting buffer 111 and acquires a reconstruction image from the arithmetic operation section 120. This reconstruction image includes, in addition to a reconstruction image of the processing target region in the past (region for which a prediction process, encoding and so forth have been performed), a reconstruction image of the region for which inter prediction has been performed by the inter prediction section 131 in the processing target region.

The intra prediction section 134 performs intra prediction using the acquired information to generate an intra prediction image and intra prediction information for each mode of each partition pattern. As described in the description of the first embodiment, the intra prediction section 134 performs an intra prediction process by a method different from that of the intra prediction process (intra prediction process performed in AVC, HEVC or the like) performed by the intra prediction section 123.

In particular, the intra prediction section 134 performs intra prediction using a reference pixel set using a reconstruction image corresponding to a prediction image generated by inter prediction. For example, the intra prediction section 134 may utilize a reconstruction image obtained by such inter prediction as described above to set a reference pixel adjacent the right side or a reference pixel adjacent the lower side of the region for which intra prediction is to be performed or set both of them and perform intra prediction using the set reference pixels.

Further, thereupon, the intra prediction section 134 may further set a reference pixel using a reconstruction image in a region for which the prediction process has been performed and perform intra prediction using the set reference pixel similarly as in the case of AVC, HEVC or the like.

The way of such reference to a reference pixel in intra prediction by the intra prediction section 134 as described above is arbitrary as described hereinabove in connection with the first embodiment. For example, as described in (D) of the first embodiment, each pixel of a prediction image may be generated by referring to a single reference pixel corresponding to a single intra prediction mode.

Further, as described, for example, in (E) (including (E-1) to (E-4)) of the first embodiment, each pixel of a prediction image may be generated by referring to a plurality of reference pixels corresponding to a single intra prediction mode. In this case, each pixel of a prediction image to be generated may be generated using one of a plurality of reference pixels selected in response to the position of the pixel. Alternatively, each pixel of a prediction image to be generated may be generated by weighted arithmetic operation performed for a plurality of reference pixels, which are selected in response to the positions of the pixels, in response to the positions of the pixels. It is to be noted that the plurality of reference pixels here may be two pixels positioned in the opposite directions to each other as viewed from a pixel in a region for which intra prediction is to be performed.

Further, for example, as described in (F) (including (F-1) to (F-4)) of the first embodiment, it may be made possible to select a plurality of modes as an intra prediction mode.

The intra prediction section 134 supplies the information supplied thereto and the generated information to the cost function calculation section 135. For example, the intra prediction section 134 supplies an intra prediction image and intra prediction information for each mode of each partition pattern to the cost function calculation section 135.

The cost function calculation section 135 calculates a cost function value for each mode of each partition pattern using the information supplied from the intra prediction section 134. Although this cost function is arbitrary, the cost function calculation section 135 performs, for example, RD optimization.

The cost function calculation section 135 supplies the information supplied thereto and the generated information to the mode selection section 136. For example, the cost function calculation section 135 supplies the intra prediction image, intra prediction information and cost function value for each mode of each partition pattern to the mode selection section 136.

The mode selection section 136 selects an optimum mode for each partition pattern on the basis of the cost function values. For example, the mode selection section 136 selects a mode whose RD cost is in the minimum for each partition pattern. The mode selection section 136 supplies information of the selected mode to the prediction image selection section 126. For example, the mode selection section 136 supplies the intra prediction image, intra prediction information and cost function value of the optimum mode of each partition pattern to the prediction image selection section 126.

The prediction image selection section 126 acquires the information supplied from the mode selection section 133 and the mode selection section 136 as information relating to inter-destination intra prediction. For example, the prediction image selection section 126 acquires the inter prediction image of the optimum mode of each partition pattern supplied from the mode selection section 133 and the intra prediction image of the optimum mode of each partition pattern supplied from the mode selection section 136 as an inter-destination inter prediction image of the optimum mode of each partition pattern. Further, for example, the prediction image selection section 126 acquires the inter prediction information of the optimum mode of each partition pattern supplied from the mode selection section 133 and the intra prediction information of the optimum mode of each partition pattern supplied from the mode selection section 136 as inter-destination inter prediction information of the optimum mode of each partition pattern. Furthermore, for example, the prediction image selection section 126 acquires the cost function value of the optimum mode of each partition pattern supplied from the mode selection section 133 and the cost function value of the optimum mode of each partition pattern supplied from the mode selection section 136 as a cost function value of the optimum mode of each partition pattern.

<Prediction Image Selection Section>

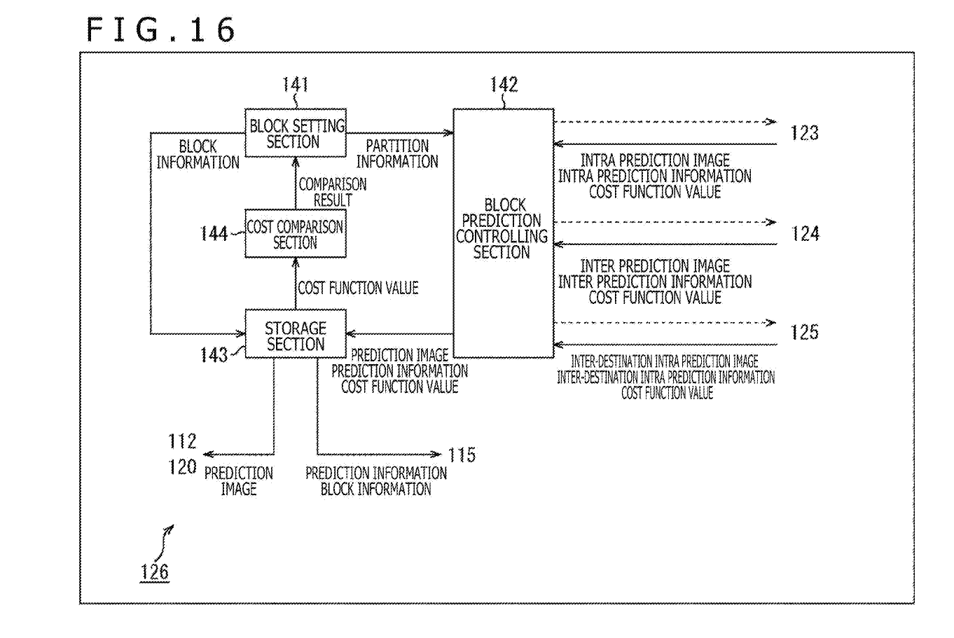

FIG. 16 is a block diagram depicting an example of a main configuration of the prediction image selection section 126. As depicted in FIG. 16, the prediction image selection section 126 includes a block setting section 141, a block prediction controlling section 142, a storage section 143 and a cost comparison section 144.

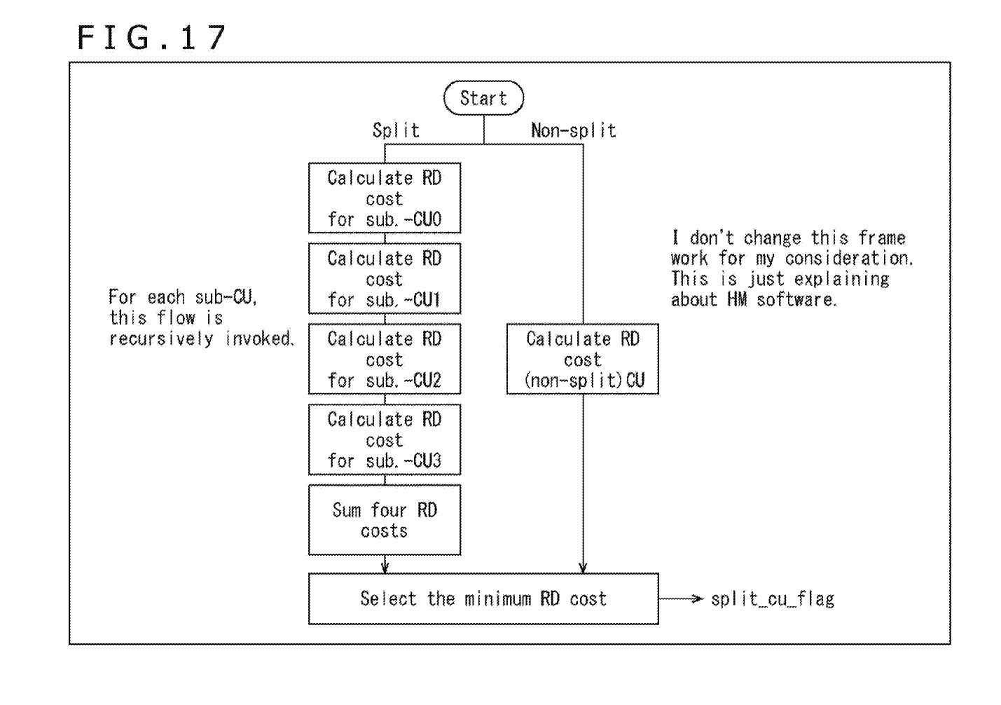

The block setting section 141 performs processing relating to setting of a block. As described hereinabove with reference to FIGS. 1 to 3, blocks are formed in a hierarchical structure (tree structure). The block setting section 141 sets such a structure of blocks as just described for each LCU. Although the structure of blocks may be set by any method, the setting is performed, for example, using a cost function value (for example, an RD cost) as depicted in FIG. 17. In this case, a cost function value is compared between that where the block is partitioned and that where the block is not partitioned, and the structure of a more appropriate one (in the case of the RD cost, the cost function value having a lower RD cost value) is selected. Information indicative of a result of the selection is set, for example, as split_cu_flag or the like. The split_cu_flag is information indicative of whether or not the block is to be partitioned. Naturally, the information indicative of a result of the selection is arbitrary and may include information other than the split_cu_flag. Such processing is recursively repeated from the LCU toward the lower position, and a block structure is determined in a state in which all blocks are not partitioned any more.

The block setting section 141 partitions of a block of a processing target into four to set blocks in the immediately lower hierarchy. The block setting section 141 supplies partition information that is information relating to the partitioned blocks to the block prediction controlling section 142.

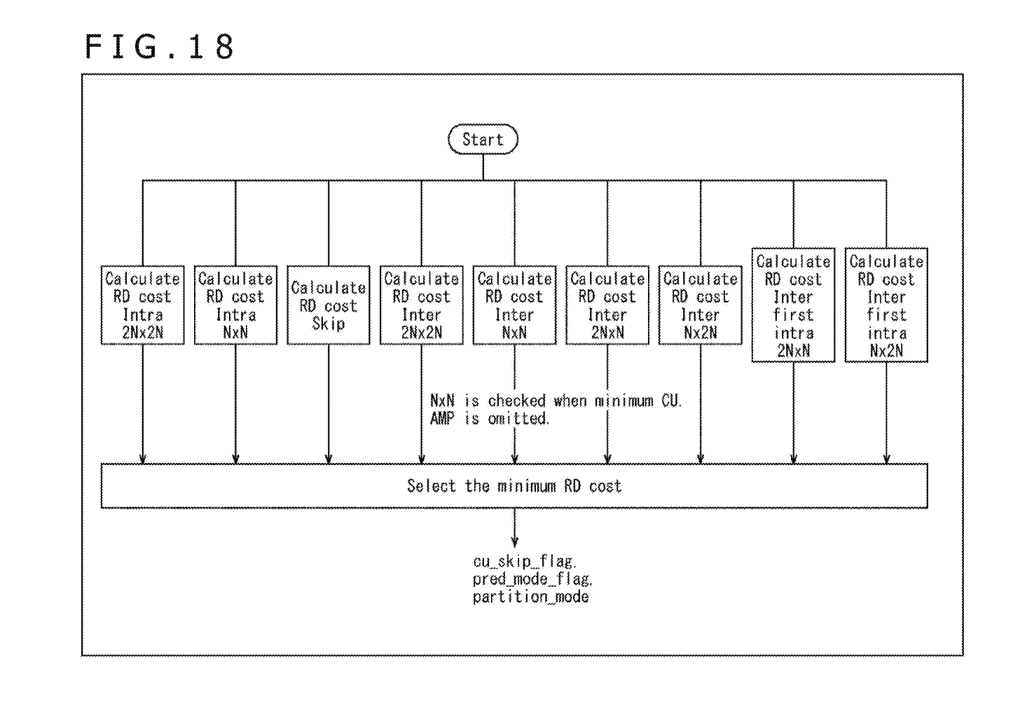

The block prediction controlling section 142 determines an optimum prediction mode for each block set by the block setting section 141. Although the determination method of an optimum prediction mode is arbitrary, the determination is performed, for example, using a cost function value (for example, an RD cost) as depicted in FIG. 18. In this case, RD costs of the optimum modes of the respective prediction modes (respective partition patterns of intra prediction, inter prediction and inter-destination intra prediction) are compared, and a more appropriate prediction mode (in the case of the RD cost, a prediction mode of a lower value) is selected.

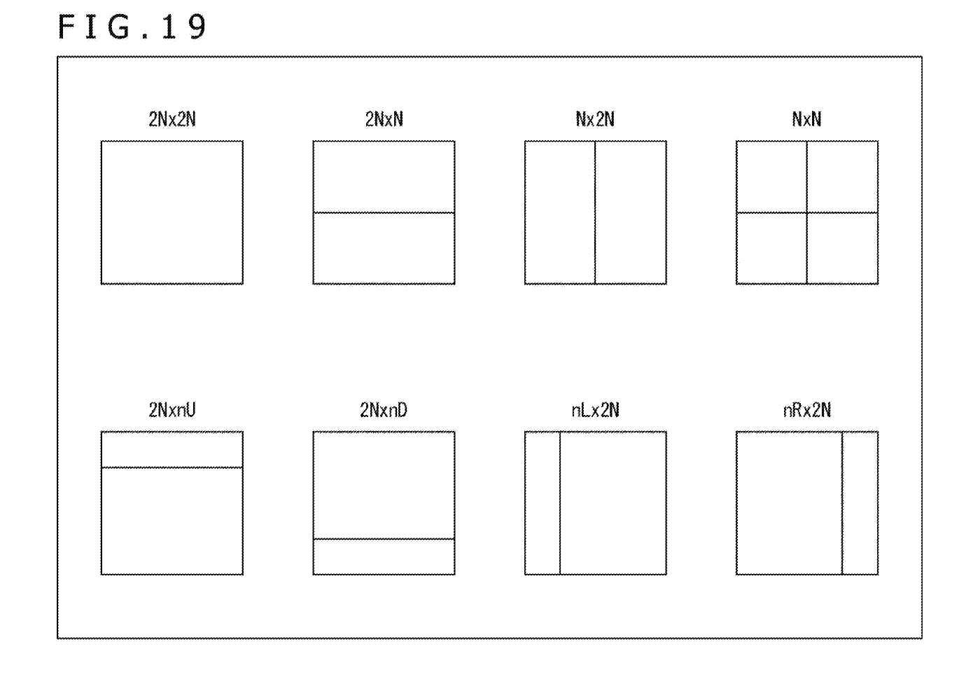

For example, in the case of HEVC, as a partition pattern of a block (CU), for example, such partition patterns as depicted in FIG. 19 are prepared. In a prediction process, each partitioned region (partition) is determined as PU. In the case of intra prediction, one of 2N×2N and N×N partition patterns can be selected. In the case of inter prediction, the eight patterns depicted in FIG. 19 can be selected. Also in the case of inter-destination intra prediction, the eight patterns depicted in FIG. 19 can be selected. Although, in FIG. 18, only part of partition patterns of inter-destination intra prediction are depicted, actually the RD costs of all partition patterns are compared. Naturally, partition patterns are arbitrary and are not limited to those of FIG. 18.

Information indicative of a result of the selection is set, for example, as cu_skip_flag, pred_mode_flag, partition_mode or the like. The cu_skip_flag is information indicative of whether or not a merge mode is to be applied; the pred_mode_flag is information indicative of a prediction method (intra prediction, inter prediction or inter-destination intra prediction); and the partition_mode is information indicative of a partition pattern (of which partition pattern the block is). Naturally, the information indicative of a result of the selection is arbitrary and may include information other than the information mentioned above.

More particularly describing, the block prediction controlling section 142 controls the intra prediction section 123 to inter-destination intra prediction section 125 on the basis of partition information acquired from the block setting section 141 to execute a prediction process for each of the blocks set by the block setting section 141. From the intra prediction section 123 to inter-destination intra prediction section 125, information of the optimum mode for each partition pattern of the individual prediction methods is supplied. The block prediction controlling section 142 selects an optimum mode from the modes on the basis of the cost function values.

The block prediction controlling section 142 supplies the prediction image, prediction information and cost function value of the selected optimum mode of each block to the storage section 143. It is to be noted that the information indicative of a result of selection, partition information and so forth described above are included into prediction information as occasion demands.

The storage section 143 stores the various kinds of information supplied from the block prediction controlling section 142.

The cost comparison section 144 acquires the cost function values of the respective blocks from the storage section 143, compares the cost function value of a processing target block and the sum total of the cost function values of the respective partitioned blocks in the immediately lower hierarchy with respect to the processing target block, and supplies information indicative of a result of the comparison (in the case of the RD cost, which one of the RD costs is lower) to the block setting section 141.

The block setting section 141 sets whether or not the processing target block is to be partitioned on the basis of the result of comparison by the cost comparison section 144. In particular, the block setting section 141 sets information indicative of the result of selection such as, for example, split_cu_flag as block information that is information relating to the block structure. The block setting section 141 supplies the block information to the storage section 143 so as to be stored.

Such processes as described above are recursively repeated from the LCU toward a lower hierarchy to set a block structure in the LCU and select an optimum prediction mode for each block.

The prediction images of the optimum prediction modes of the respective blocks stored in the storage section 143 are supplied suitably to the arithmetic operation section 112 and the arithmetic operation section 120. Further, the prediction information and the block information of the optimum prediction modes of the respective blocks stored in the storage section 143 are suitably supplied to the reversible encoding section 115.

<Allocation of Inter-Destination Intra Prediction>

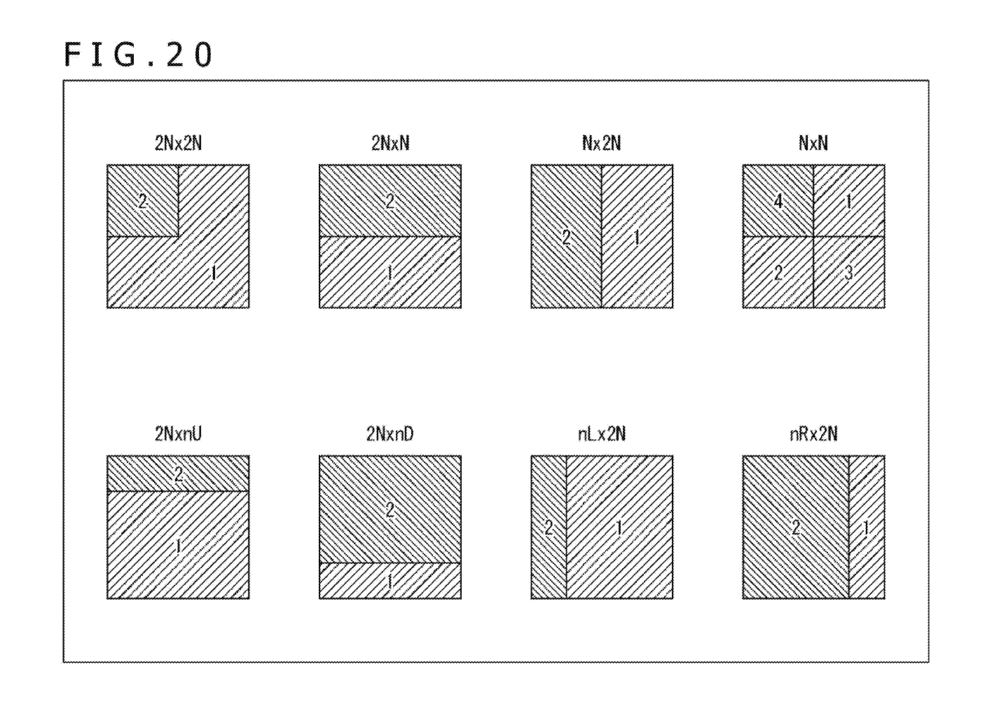

It is to be noted that, in the case of inter-destination intra prediction, a PU for which intra prediction is to be performed and a PU for which inter prediction is to be performed for each partition pattern depicted in FIG. 19 are allocated in such a manner as depicted in FIG. 20. In FIG. 20, a region indicated by a pattern of rightwardly upwardly inclined slanting lines is a PU for which inter prediction is performed, and a region indicated by a pattern of rightwardly downwardly inclined slanting lines is a PU for which intra prediction is performed. It is to be noted that a numeral in each PU indicates a processing order number. In particular, inter prediction is performed first, and intra prediction is performed utilizing a result of the inter prediction as a reference pixel.

Since the image encoding apparatus 100 performs image encoding using an inter-destination intra prediction process as described above, reduction of the encoding efficiency can be suppressed as described in the description of the first embodiment.

<Flow of Encoding Process>

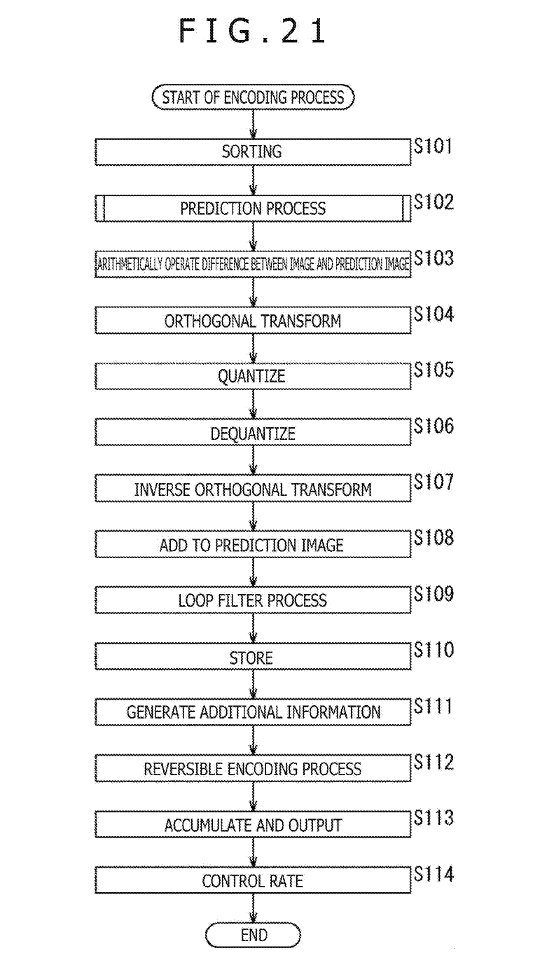

Now, an example of a flow of respective processes executed by the image encoding apparatus 100 is described. First, an example of a flow of an encoding process is described with reference to a flow chart of FIG. 21.

After the encoding process is started, at step S101, the screen sorting buffer 111 stores an image of respective frames (pictures) of an inputted moving image in an order in which they are to be displayed and performs sorting of the respective pictures from the displaying order into an order in which the pictures are to be encoded.

At step S102, the intra prediction section 123 to prediction image selection section 126 perform a prediction process.

At step S103, the arithmetic operation section 112 arithmetically operates a difference between the input image, whose frame order has been changed by sorting by the process at step S101, and a prediction image obtained by the prediction process at step S102. In short, the arithmetic operation section 112 generates residual data between the input image and the prediction image. The residual data determined in this manner have a data amount reduced in comparison with the original image data. Accordingly, the data amount can be compressed in comparison with that in an alternative case in which the images are encoded as they are.

At step S104, the orthogonal transform section 113 orthogonally transforms the residual data generated by the process at step S103.

At step S105, the quantization section 114 quantizes the residual data after the orthogonal transform generated by the process at step S104 using the quantization parameter calculated by the rate controlling section 127.

At step S106, the dequantization section 118 dequantizes the residual data after the quantization generated by the process at step S105 in accordance with characteristics corresponding to characteristics of the quantization.

At step S107, the inverse orthogonal transform section 119 inversely orthogonally transforms the residual data after the orthogonal transform obtained by the process at step S106.

At step S108, the arithmetic operation section 120 adds the prediction image obtained by the prediction process at step S102 to the residual data restored by the process at step S107 to generate image data of a reconstruction image.

At step S109, the loop filter 121 suitably performs a loop filter process for the image data of the reconstruction image obtained by the process at step S108.

At step S110, the frame memory 122 stores the locally decoded image obtained by the process at step S109.

At step S111, the additional information generation section 116 generates additional information to be added to the encoded data.

At step S112, the reversible encoding section 115 encodes the residual data after the quantization obtained by the process at step S105. In particular, reversible encoding such as variable length encoding or arithmetic coding is performed for the residual data after the quantization. Further, the reversible encoding section 115 adds the additional information generated by the process at step S111 to the encoded data.

At step S113, the accumulation buffer 117 accumulates the encoded data obtained by the process at step S112. The encoded data accumulated in the accumulation buffer 117 are suitably read out as a bit stream and transmitted to the decoding side through a transmission line or a recording medium.

At step S114, the rate controlling section 127 controls the rate of the quantization process at step S105 on the basis of the code amount (generated code amount) of the encoded data and so forth accumulated in the accumulation buffer 117 by the process at step S113 such that an overflow or an underflow may not occur.

When the process at step S114 ends, the encoding process ends.

<Flow of Prediction Process>

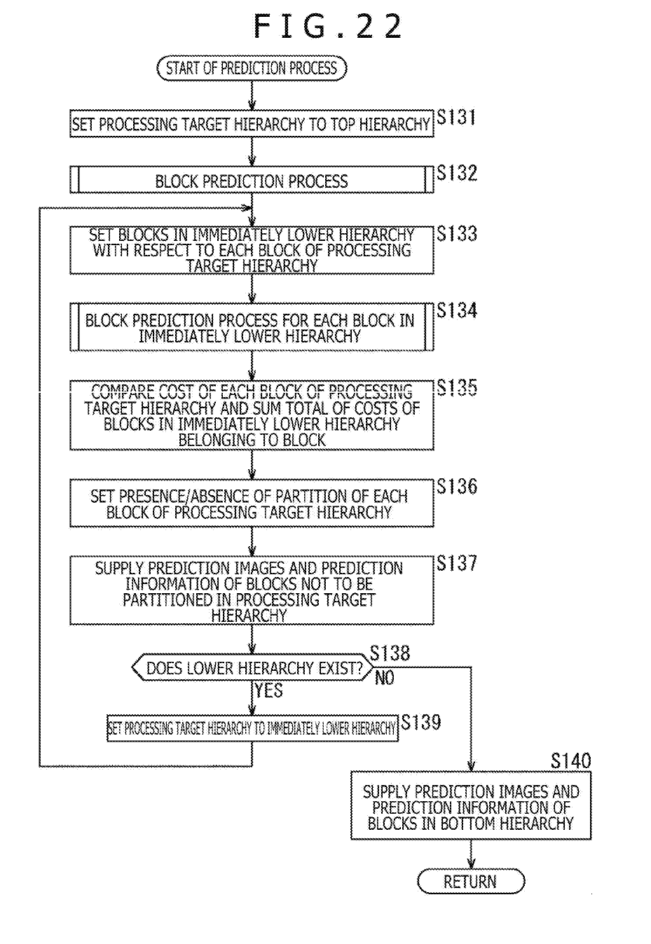

Now, an example of a flow of the prediction process executed at step S102 of FIG. 21 is described with reference to a flow chart of FIG. 22.

After the prediction process is started, the block setting section 141 of the prediction image selection section 126 sets the processing target hierarchy to the highest hierarchy (namely to the LCU) at step S131.

At step S132, the block prediction controlling section 142 controls the intra prediction section 123 to inter-destination intra prediction section 125 to perform a block prediction process for blocks of the processing target hierarchy (namely of the LOU).

At step S133, the block setting section 141 sets blocks in the immediately lower hierarchy with respect to each of the blocks of the processing target hierarchy.

At step S134, the block prediction controlling section 142 controls the intra prediction section 123 to inter-destination intra prediction section 125 to perform a block prediction process for the respective blocks in the immediately lower hierarchy with respect to the processing target hierarchy.

At step S135, the cost comparison section 144 compares the cost of each block of the processing target hierarchy and the sum total of the costs of the blocks that are in the immediately lower hierarchy with respect to the processing target hierarchy and belong to the block. The cost comparison section 144 performs such comparison for each block of the processing target hierarchy.

At step S136, the block setting section 141 sets presence or absence of partition of the block of the processing target hierarchy (whether or not the block is to be partitioned) on the basis of a result of the comparison at step S135. For example, if the RD cost of the block of the processing target hierarchy is lower than the sum total of the RD costs of the respective blocks (or equal to or lower than the sum total) in the immediately lower hierarchy with respect to the block, then the block setting section 141 sets such that the block of the processing target hierarchy is not to be partitioned. Inversely, if the RD cost of the block of the processing target hierarchy is equal to or higher than the sum total of the RD costs of the respective blocks (or higher than the sum total) in the immediately lower hierarchy with respect to the block, then the block setting section 141 sets such that the block of the processing target hierarchy is to be partitioned. The block setting section 141 performs such setting for each of the blocks of the processing target hierarchy.

At step S137, the storage section 143 supplies the prediction images stored therein of the respective blocks of the processing target hierarchy, which are not to be partitioned, to the arithmetic operation section 112 and the arithmetic operation section 120 and supplies the prediction information and block information of the respective blocks to the reversible encoding section 115.

At step S138, the block setting section 141 decides whether or not a lower hierarchy than the current processing target hierarchy exists in the block structure of the LCU. In particular, if it is set at step S136 that the block of the processing target hierarchy is to be partitioned, then the block setting section 141 decides that a lower hierarchy exists and advances the processing to step S139.

At step S139, the block setting section 141 changes the processing target hierarchy to the immediately lower hierarchy. After the processing target hierarchy is updated, the processing returns to step S133, and then the processes at the steps beginning with step S133 are repeated for the new processing target hierarchy. In short, the respective processes at steps S133 to S139 are executed for each hierarchy of the block structure.

Then, if it is set at step S136 that block partitioning is not to be performed for all blocks of the processing target hierarchy, then the block setting section 141 decides at step S138 that a lower hierarchy does not exist and advances the processing to step S140.

At step S140, the storage section 143 supplies the prediction images of the respective blocks of the bottom hierarchy to the arithmetic operation section 112 and the arithmetic operation section 120 and supplies the prediction information and the block information of the respective blocks to the reversible encoding section 115.

When the process at step S140 ends, the prediction process ends, and the processing returns to FIG. 21.

<Flow of Block Prediction Process>

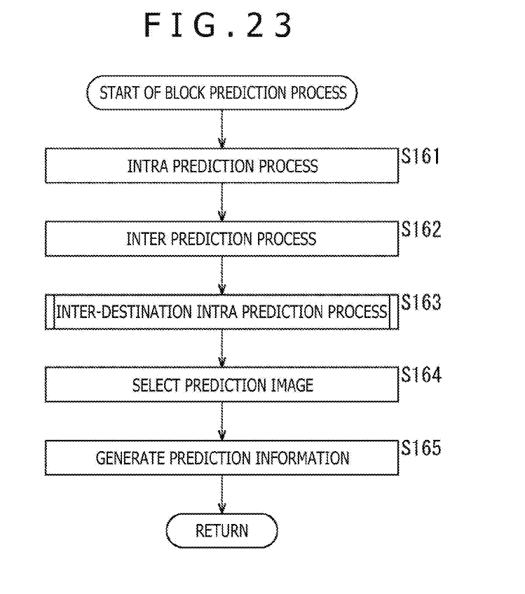

Now, an example of a flow of the block prediction process executed at steps S132 and S134 of FIG. 22 is described with reference to a flow chart of FIG. 23. It is to be noted that, when the block prediction process is executed at step S134, this block prediction process is executed for the respective blocks in the immediately lower hierarchy with respect to the processing target hierarchy. In other words, where a plurality of blocks exist in the immediately lower hierarchy with respect to the processing target hierarchy, the block prediction process is executed by a plural number of times.

After the block prediction process is started, the intra prediction section 123 performs an intra prediction process for the processing target block at step S161. This intra prediction process is performed utilizing a reference pixel similar to that in the conventional case of AVC or HEVC.

At step S162, the inter prediction section 124 performs an inter prediction process for the processing target block.

At step S163, the inter-destination intra prediction section 125 performs an inter-destination intra prediction process for the processing target block.

At step S164, the block prediction controlling section 142 compares the cost function values obtained in the respective processes at steps S161 to S163 and selects a prediction image in response to a result of the comparison. In short, an optimum prediction mode is set.

At step S165, the block prediction controlling section 142 generates prediction information of the optimum mode using the prediction information corresponding to the prediction image selected at step S164.

When the process at step S165 ends, the block prediction process ends, and the processing returns to FIG. 22.

<Flow of Inter-Destination Intra Prediction Process>

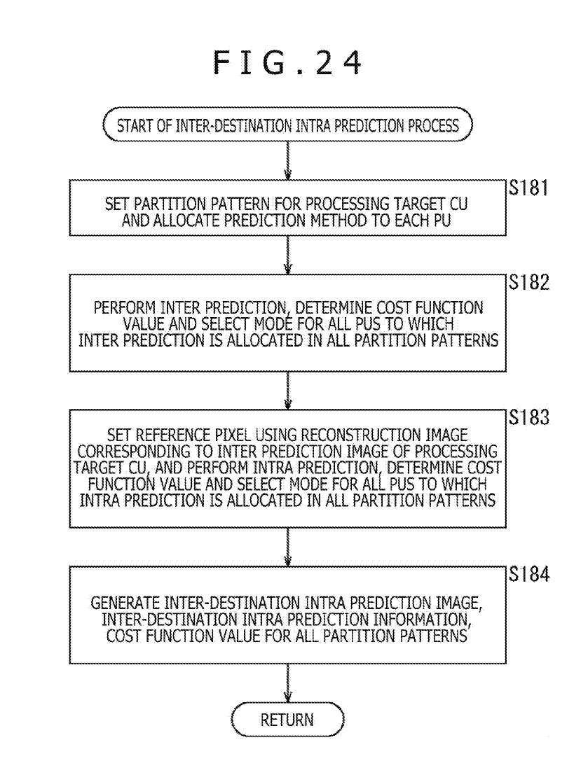

Now, an example of a flow of the inter-destination intra prediction process executed at step S163 of FIG. 23 is described with reference to a flow chart of FIG. 24.

After the inter-destination intra prediction process is started, the block prediction controlling section 142 sets partition patterns for the processing target CU and allocates a processing method to each PU at step S181. The block prediction controlling section 142 allocates the prediction methods, for example, as in the case of the example of FIG. 20.

At step S182, the inter prediction section 131 performs inter prediction in all modes for all PUs to which inter prediction of respective partition patterns is allocated. Further, the cost function calculation section 132 determines cost function values for all modes of all partition patterns. Furthermore, the mode selection section 133 selects an optimum mode on the basis of the cost function values.

At step S183, the intra prediction section 134 uses a reconstruction image obtained by the process at step S182 to perform intra prediction in all modes for all PUs to which intra prediction of the respective partition patterns is allocated. Further, the cost function calculation section 135 determines cost function values in all modes of all partition patterns. Furthermore, the mode selection section 136 selects an optimum mode on the basis of the cost function values.

At step S184, the prediction image selection section 126 uses results of the processes at steps S182 and S183 to generate an inter-destination intra prediction image, inter-destination intra prediction information and a cost function value of the optimum mode for all partition patterns.

After the process at step S184 ends, the processing returns to FIG. 23.

By executing the respective processes in such a manner as described above, a reference pixel can be set at a position at which a reference pixel is not set in a conventional intra prediction process of AVC or HEVC, and therefore, reduction of the prediction accuracy of intra prediction can be suppressed. Thus, reduction of encoding efficiency can be suppressed. In other words, it is possible to suppress increase of the code amount and suppress reduction of the picture quality.

<Process of 2N×2N>

Now, a more particular example of the inter-destination intra prediction process described above is described. First, a manner of the inter-destination intra prediction process for a CU of the partition pattern 2N×2N is described.

In the case of the partition pattern 2N×2N, as depicted in FIG. 20, intra prediction is allocated to the left upper region of one fourth of a CU (intra region) and inter prediction is allocated to the other region (inter region).

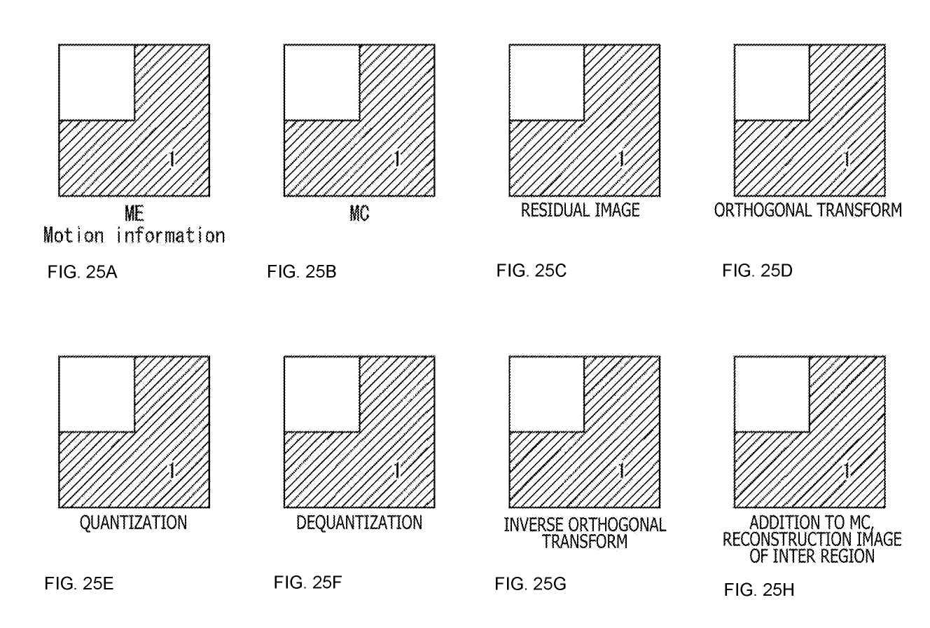

First, respective processes for inter prediction are performed for the inter region as indicated in FIG. 25. First, motion prediction (ME (Motion Estimation)) is performed for the inter region to obtain motion information (A of FIG. 25). Then, motion compensation (MC (Motion Compensation)) is performed using the motion information to generate a prediction image (inter prediction image) (B of FIG. 25). Then, residual data (residual image) between the input image and the inter prediction image is obtained (C of FIG. 25). Then, the residual data are orthogonally transferred (D of FIG. 25). Then, the residual data are quantized (E of FIG. 25). The residual data after the quantization obtained in this manner are encoded. Further, the residual data after the quantization are dequantized (F of FIG. 25). Then, the residual data after the dequantization are inversely orthogonally transformed (G of FIG. 25). Then, the inter prediction image is added to the residual data after the inverse orthogonal transform to obtain a reconstruction image of the inter region (H of FIG. 25).

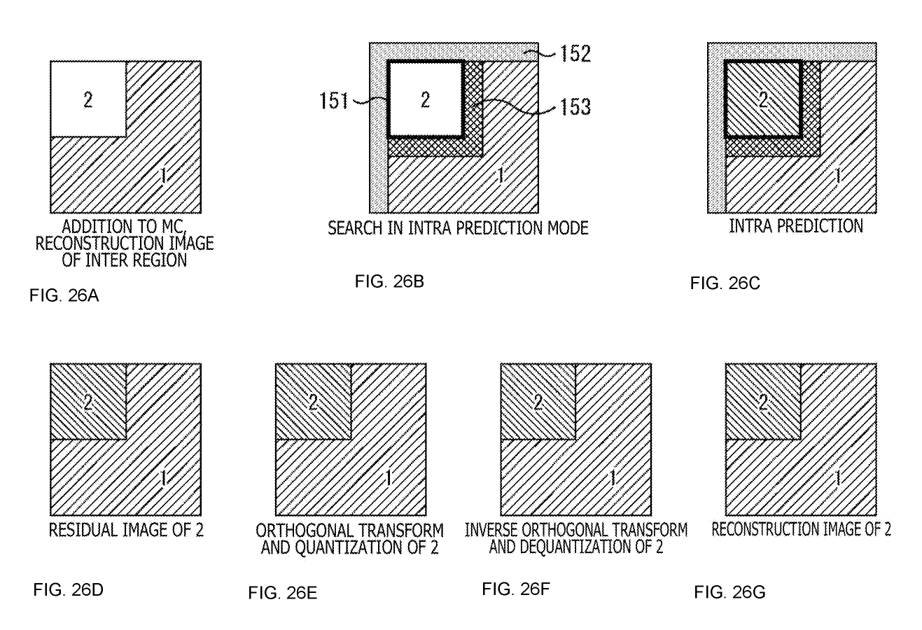

Then, respective processes for intra prediction are performed for the intra region as depicted in FIG. 26. In this intra prediction, a result of the process (reconstruction image) of inter prediction for the inter region is utilized (A of FIG. 26). First, a reference pixel is set (B of FIG. 26). In particular, a reference pixel positioned in a region 152 (reference pixel on the upper side or the left side with respect to the intra region 151) is set using the reconstruction image of the CU for which a prediction process has been performed for the intra region 151. Furthermore, a reference pixel positioned in a region 153 (reference pixel on the right side or the lower side with respect to the intra region 151) is set for the intra region 151 using the reconstruction image of the inter region of the CU.

Then, intra prediction is performed for the intra region using the reference pixel to generate a prediction image (intra prediction image) (C of FIG. 26). Then, residual data (residual image) between the input image and the intra prediction image (D of FIG. 26) are obtained. Then, the residual data are orthogonally transformed and quantized (E of FIG. 26). The residual data after the quantization obtained in this manner are encoded. Further, the residual data after the quantization are dequantized and inversely orthogonally transformed (F of FIG. 26). Then, the intra prediction image is added to the residual data after the inverse orthogonal transform to obtain a reconstruction image of the intra region (G of FIG. 26).

It is to be noted that processes also in the case of the partition pattern N×N are performed similarly to those as in the case of 2N×2N. In short, the PU at the left upper corner is set as an intra region while the remaining PU is set as an inter region.

<Process of 2N×N>

Now, a manner of the inter-destination intra prediction process for a CU of the partition pattern 2N×N is described.

In the case of the partition pattern 2N×N, as depicted in FIG. 20, intra prediction is allocated to a region of an upper half of the CU (intra region) while inter prediction is allocated to a region of a lower half of the CU (inter region).

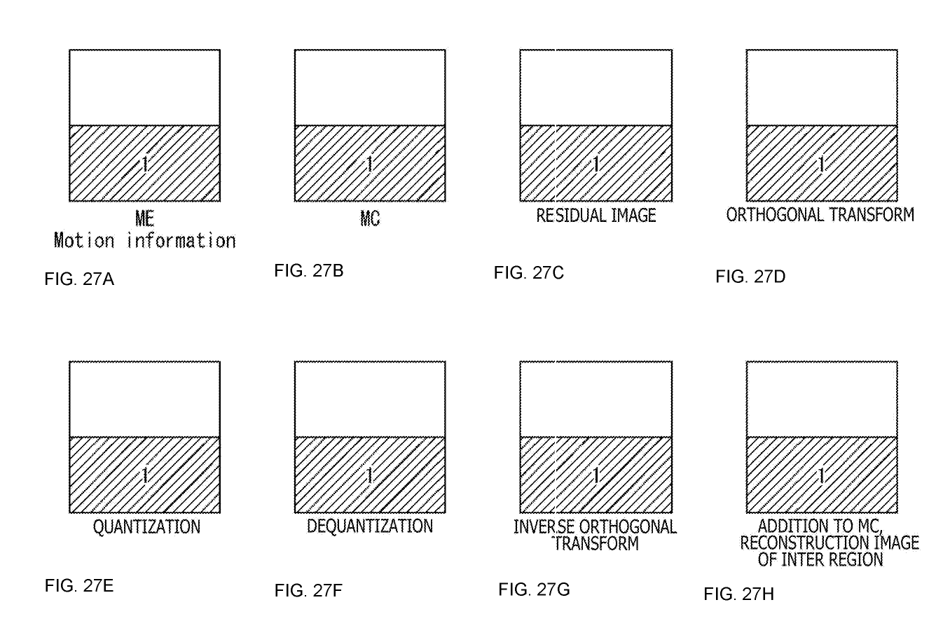

First, respective processes of inter prediction are performed for the inter region as depicted in FIG. 27. First, motion prediction (ME) is performed for the inter region to obtain motion information (A of FIG. 27). Then, the motion information is used to perform motion compensation (MC) to generate an inter prediction image (B of FIG. 27). Then, residual data between the input image and the inter prediction image are obtained (C of FIG. 27). Then, the residual data are orthogonally transformed (D of FIG. 27). Then, the residual data after the orthogonal transform are quantized (E of FIG. 27). The residual data after the quantization obtained in this manner are encoded. Further, the residual data after the quantization are dequantized (F of FIG. 27). Then, the residual data after the dequantization are inversely orthogonally transformed (G of FIG. 27). Then, the inter prediction image is added to the residual data after the inverse orthogonal transform to obtain a reconstruction image of the inter region (H of FIG. 27).

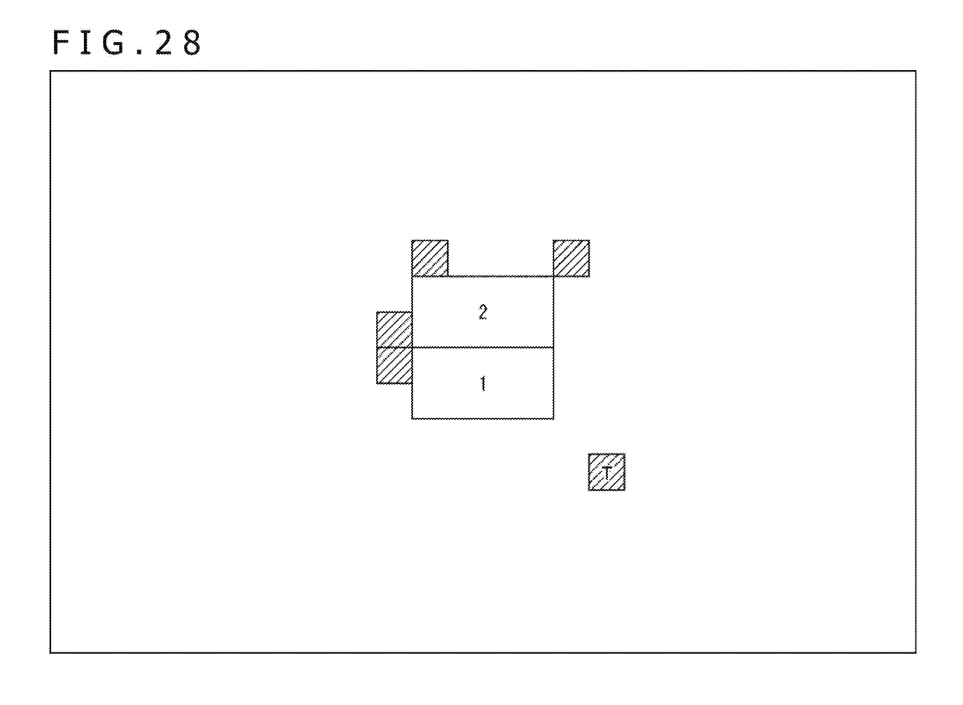

It is to be noted that, in the case of inter prediction similar to that of conventional AVC or HEVC (for example, in the case of inter prediction by the inter prediction section 124), since inter prediction is performed also for the intra region, motion information exists and can be utilized upon motion prediction of the inter region. However, in the case of inter prediction by the inter-destination intra prediction section 125, upon motion prediction of the inter region, motion information of the intra region of the CU cannot be referred to (no motion information exists). Therefore, it is made possible to refer to motion information of a block indicated by a slanting line pattern in FIG. 28. It is to be noted that a block denoted by “T” in FIG. 28 indicates a block of a frame in the past with respect to a current frame (the block is positioned arbitrarily).

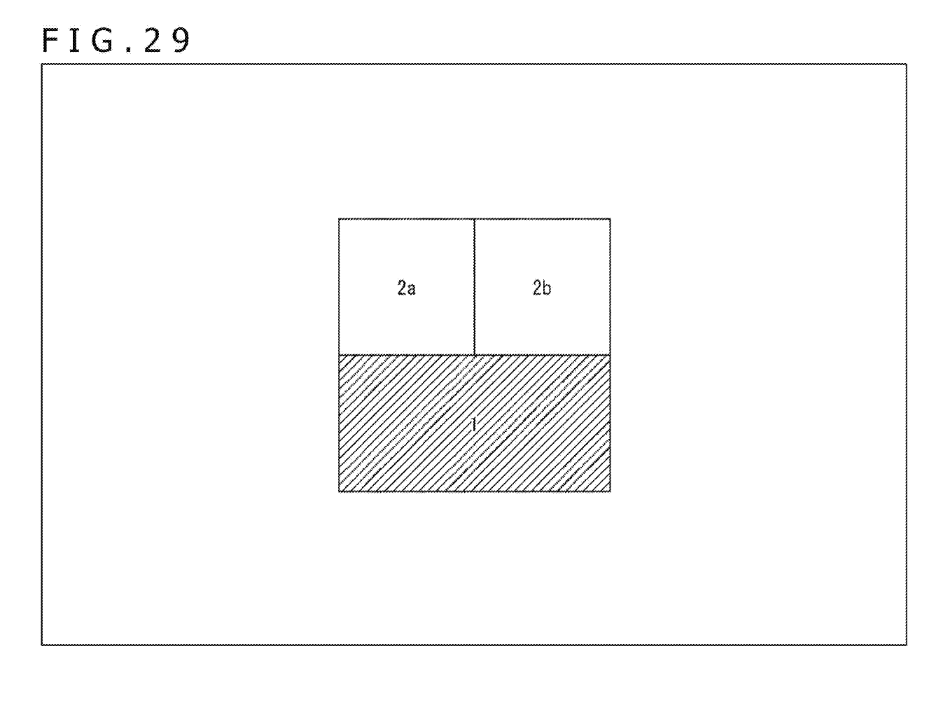

Then, intra prediction is performed for the intra region. It is to be noted that, in this case, since the intra region has a rectangular shape, this intra region is partitioned into two regions (2a and 2b) as depicted in FIG. 29 and then processed.

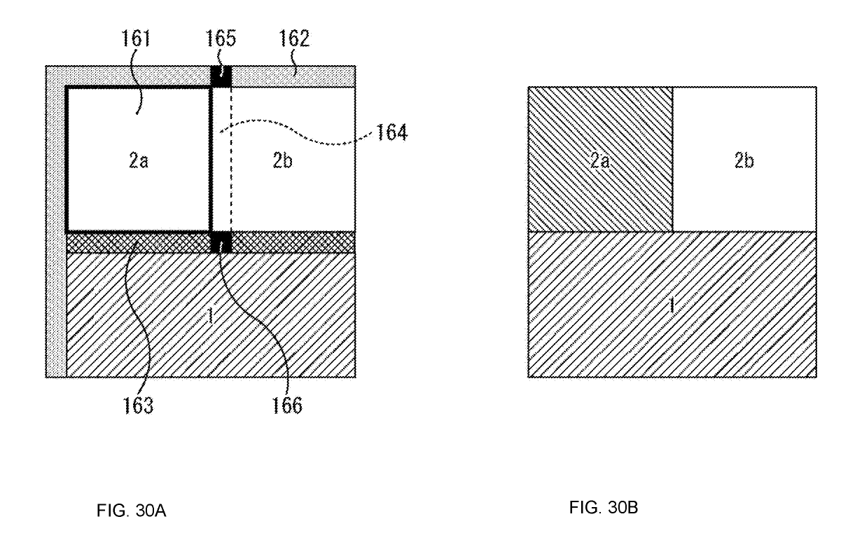

First, as depicted in A of FIG. 30, intra prediction is performed for a region 161 (2a) on the left side in FIG. 30 in the intra region. First, a reference pixel is set. For example, a reference pixel positioned in a region 162 (reference pixel on the upper side or the left side with respect to the intra region 161) can be set using the reconstruction image of the CU for which a prediction process has been performed already. Further, a reference pixel positioned in a region 163 indicated by a shaded pattern (reference pixel on the lower side with respect to the intra region 161) can be set, because the inter region indicated by a slanting line pattern has been subjected to inter prediction to generate a reconstruction image, using the reconstruction image.

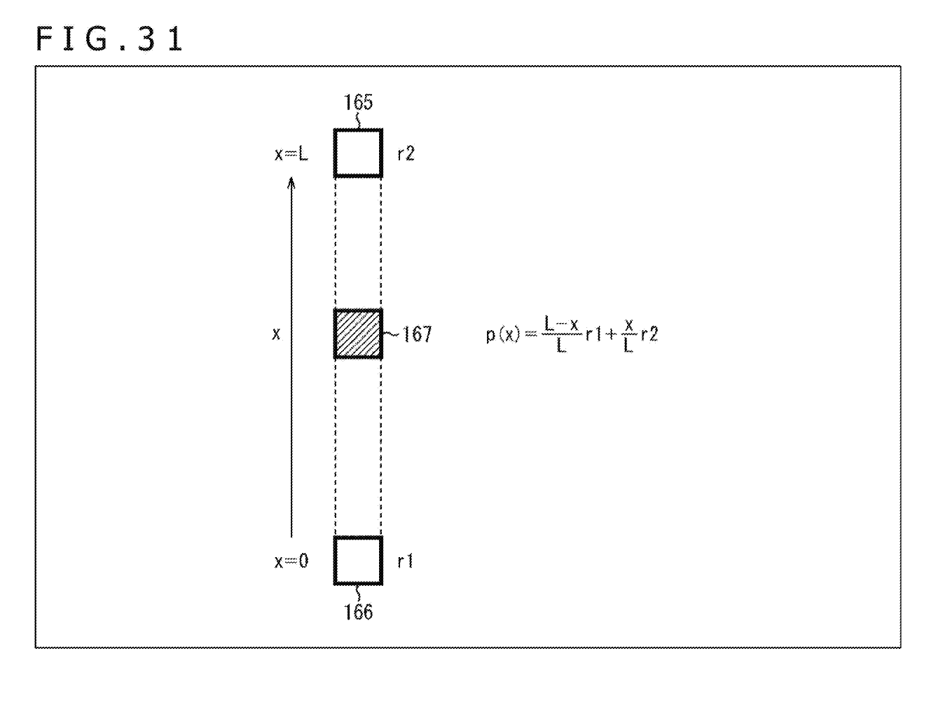

At this point of time, a reconstruction image of a region 164 indicated by a broken line frame does not exist. Therefore, intra prediction may be performed using a reference pixel at a position in the region 162 or the region 163 without setting a reference pixel at a position in the region 164 (reference pixel on the right side with respect to the intra region 161). Alternatively, a reference pixel positioned in the region 164 may be set by an interpolation process using the reconstruction image of a pixel 165 and another pixel 166. In this case, the method for interpolation is arbitrary as described in (A-2-2) of the description of the first embodiment. For example, weighted addition may be applied as depicted in FIG. 31. In FIG. 31, x indicates a coordinate in the vertical direction. For example, the x coordinate of the pixel 165 is “L” and the pixel value is “r2.” Meanwhile, the x coordinate of the pixel 166 is “0” and the pixel value is “r1.” In this case, the reference pixel value “p” of a pixel 167 of the x coordinate “x” can be determined in a manner indicated by the following expression (3).

$$p ( x ) = \frac{L - x}{L} r 1 + \frac{x}{L} r 2 \qquad ( 3 )$$

Then, the reference pixels are used to perform intra prediction for the intra region 161 to generate an intra prediction image, and a reconstruction image of the region 161 (2a) is generated (B of FIG. 30).

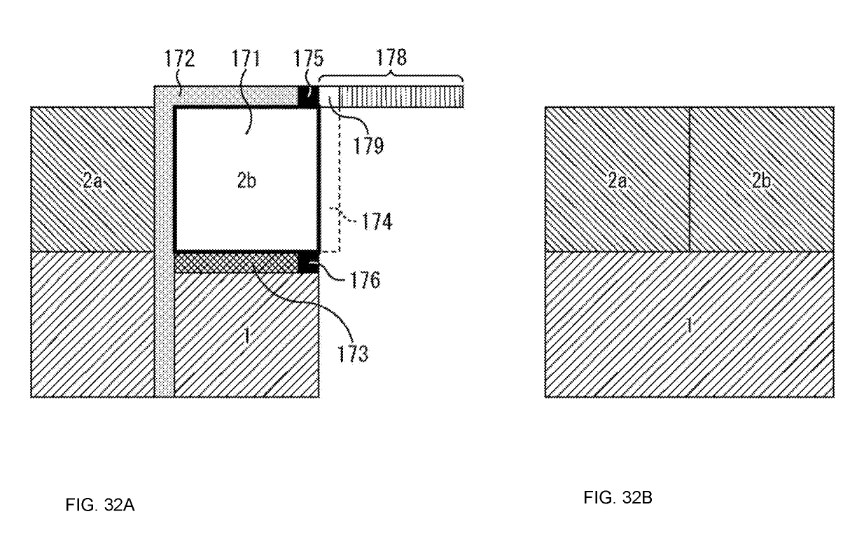

Then, as indicated in A of FIG. 32, intra prediction is performed for a region 171 (2b) on the right side in FIG. 32 of the intra region. First, a reference pixel is set. For example, a reference pixel positioned in a region 172 (reference pixel at part of the upper side or at the left side with respect to the intra region 171) can be set using the reconstruction image of the CU for which the prediction process has been performed already or the reconstruction image of the inter region indicated by a slanting line pattern. It is to be noted that the remaining reference pixel on the upper side with respect to the intra region 171 (right upper reference pixel in the intra region 171) may be set, when a reconstruction image of a region 178 exists, using the pixel value of the reconstruction image. On the other hand, where the reconstruction image of the region 178 does not exist, the reference pixels may be set, for example, by duplicating the pixel value of a pixel 175 of the reconstruction image.

Meanwhile, the reference pixels positioned in a region 173 indicated by a shadow pattern (reference pixel on the lower side with respect to the intra region 171) can be set using the reconstruction image of the inter region indicated by a slanting line pattern.

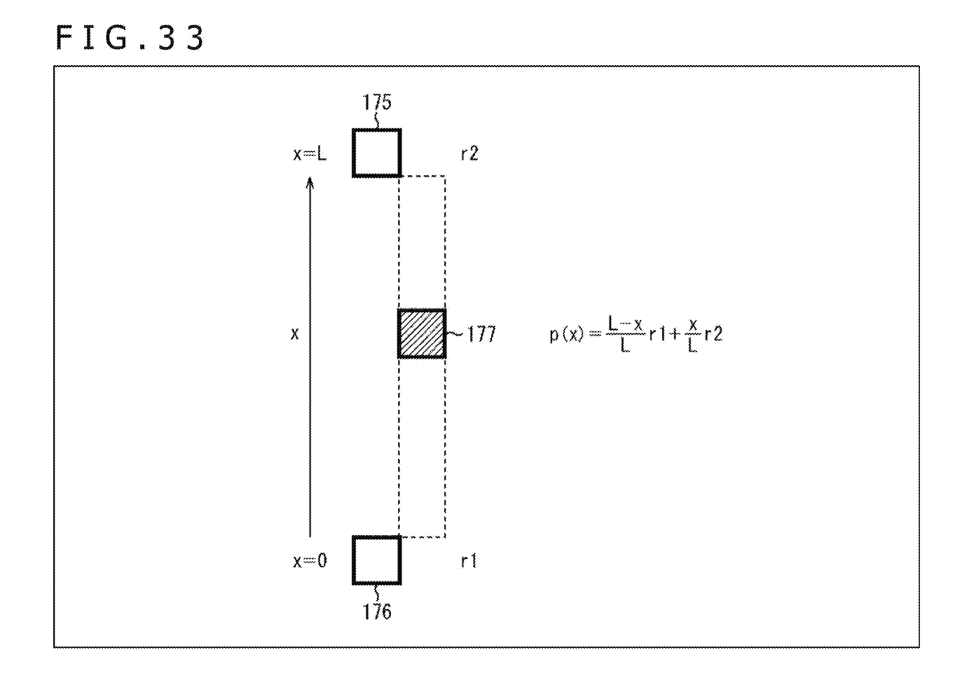

At this point of time, the reconstruction image of a region 174 indicated by a broken line frame does not exist. Therefore, intra prediction may be performed using a reference pixel at a position in the region 178 without setting a reference pixel at a position in the region 174 (reference pixel on the right side with respect to the intra region 171). Alternatively, a reference pixel positioned in the region 174 may be set by an interpolation process using the reconstruction images of the pixel 175 and a pixel 176. In this case, since there is the possibility that the reconstruction images at upper and lower pixel positions of the region 174 may not exist at this point of time, leftwardly adjacent pixels are used instead. As described in (A-2-2) of the description of the first embodiment, the method of interpolation is arbitrary. For example, weighted addition may be applied as depicted in FIG. 33. Referring to FIG. 33, x indicates a coordinate in the vertical direction in FIG. 33. For example, the x coordinate of the pixel 175 is “L” and the pixel value is “r2.” Meanwhile, the x coordinate of the pixel 176 is “0” and the pixel value is “r1.” In this case, the reference pixel value “p” of a pixel 177 of the x coordinate “x” can be determined in accordance with the (3) given hereinabove. It is to be noted that, for example, when a reconstruction image of the region 178 exists, in the interpolation process described above, the pixel value of a pixel 179 may be used in place of the pixel value of the pixel 175 of the reconstruction image.

Then, those reference pixels are used to perform intra prediction for the intra region 171 to generate an intra prediction image, and a reconstruction image of the region 171 (2b) is generated (B of FIG. 32).

Intra prediction of the intra region is performed in such a manner as described above. It is to be noted that, also in the case of the partition pattern 2N×nU or 2N×nD, intra prediction is performed basically similarly to that of the case of the partition pattern 2N×N. Intra prediction may be executed suitably partitioning an intra region into such a shape that intra prediction can be executed.

<Process of N×2N>

Now, a manner of the inter-destination intra prediction process for a CU of the partition pattern N×2N is described.

In the case of the partition pattern N×2N, as depicted in FIG. 20, intra prediction is allocated to a region of a left half of the CU (intra region) while inter prediction is allocated to a region of a right half of the CU (inter region).

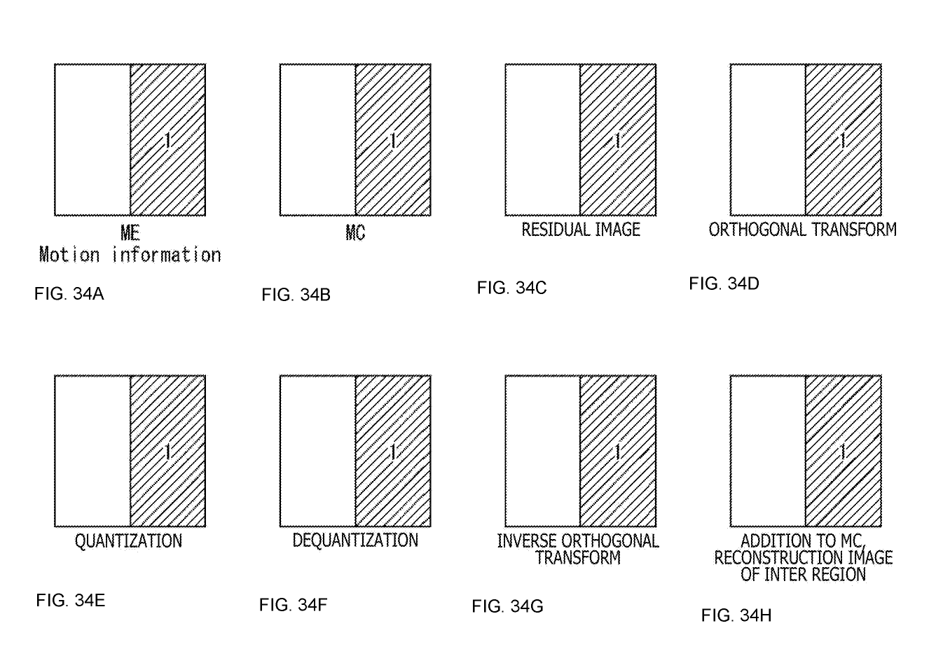

First, respective processes for inter prediction are performed for the inter region as depicted in FIG. 34. First, motion prediction (ME) is performed for the inter region to obtain motion information (A of FIG. 34). Then, the motion information is used to perform motion compensation (MC) to generate an inter prediction image (B of FIG. 34). Then, residual data between the input image and the inter prediction image are obtained (C of FIG. 34). Then, the residual data are orthogonally transformed (D of FIG. 34). Then, the residual data after the orthogonal transform are quantized (E of FIG. 34). The residual data after the quantization obtained in this manner are encoded. Further, the residual data after the quantization are dequantized (F of FIG. 34). Then, the residual data after the dequantization are inversely orthogonally transformed (G of FIG. 34). Then, the inter prediction image is added to the residual data after the inverse orthogonal transform to obtain a reconstruction image of the inter region (H of FIG. 34).

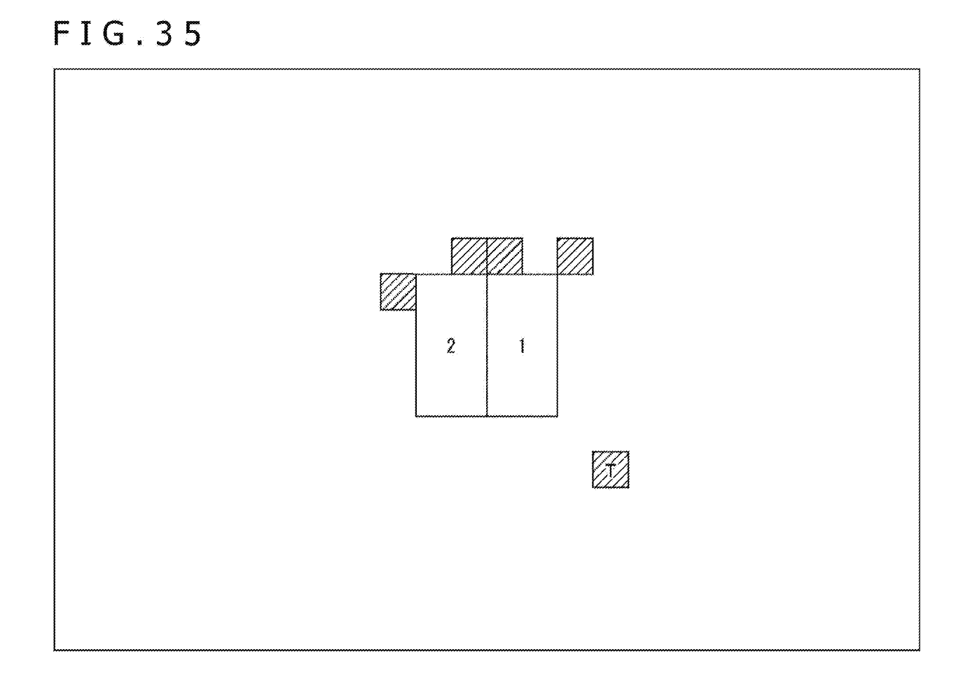

It is to be noted that, in the case of inter prediction by the inter-destination intra prediction section 125, upon motion prediction of the inter region, motion information of the intra region of the CU cannot be referred to (no motion information exists). Therefore, it is made possible to refer to motion information of a block indicated by a slanting line pattern in FIG. 35. It is to be noted that a block denoted by “T” in FIG. 35 indicates a block of a frame in the past with respect to a current frame (the position of the block is arbitrary).

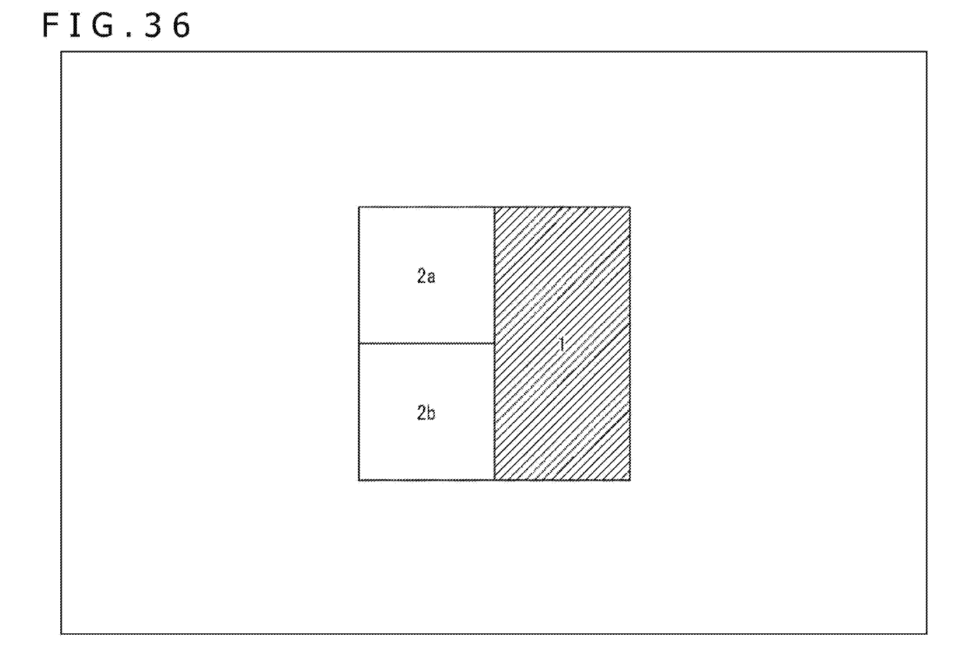

Then, intra prediction is performed for the intra region. It is to be noted that, in this case, since the intra region has a rectangular shape, this intra region is partitioned into two regions (2a and 2b) as depicted in FIG. 36 and then processed.

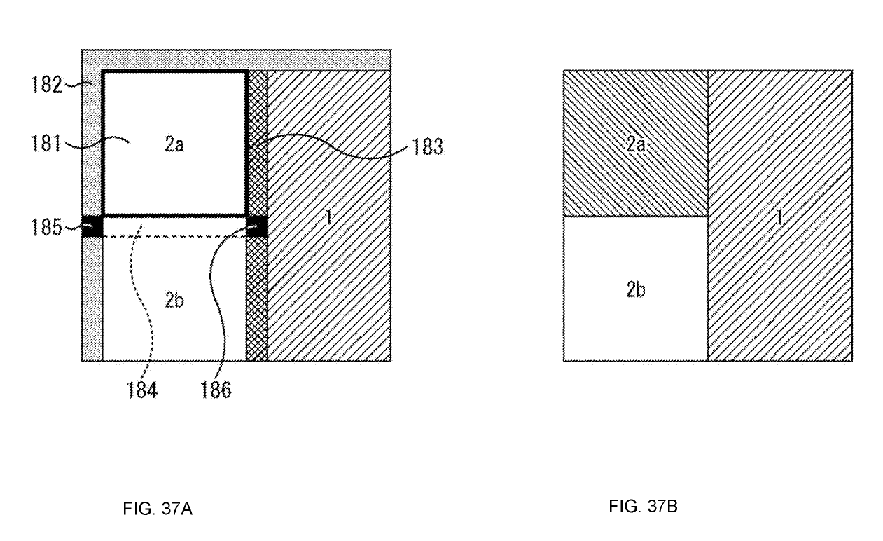

First, as depicted in A of FIG. 37, intra prediction is performed for a region 181 (2a) on the upper side in FIG. 37 in the intra region. First, a reference pixel is set. For example, a reference pixel positioned in a region 182 (reference pixel on the upper side or the left side with respect to the intra region 181) can be set using the reconstruction image of the CU for which a prediction process has been performed already. Further, a reference pixel positioned in a region 183 indicated by a shaded pattern (reference pixel on the right side with respect to the intra region 161) can be set, because the inter region indicated by a slanting line pattern has been subjected to inter prediction to generate a reconstruction image, using the reconstruction image.

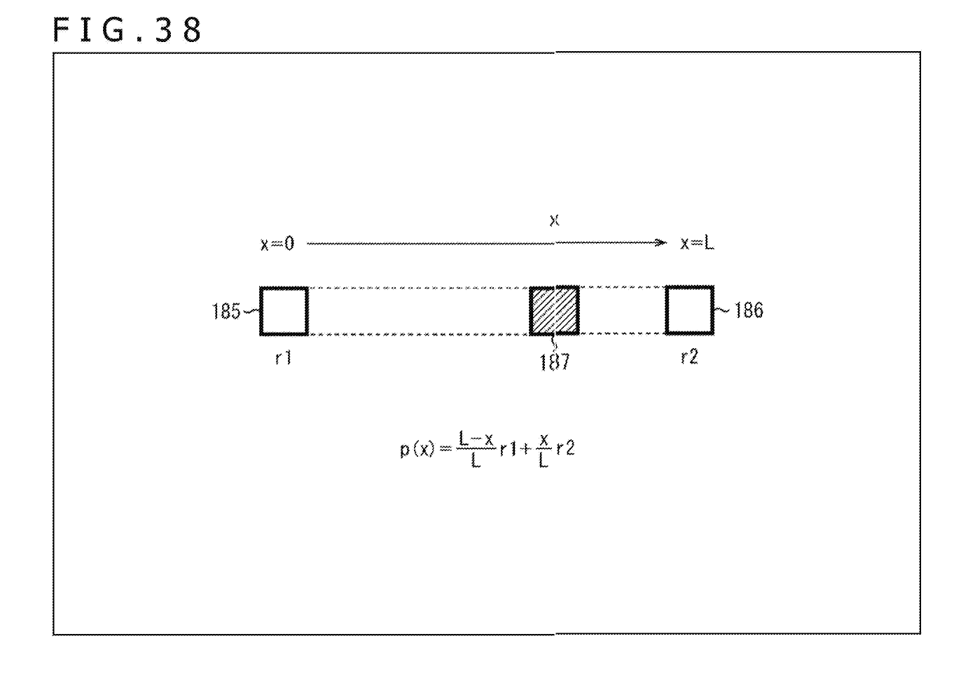

At this point of time, a reconstruction image of a region 184 indicated by a broken line frame does not exist. Therefore, intra prediction may be performed using a reference pixel at a position in the region 182 or the region 183 without setting a reference pixel at a position in the region 184 (reference pixel on the lower side with respect to the intra region 181). Alternatively, a reference pixel positioned in the region 184 may be set by an interpolation process using the reconstruction image of a pixel 185 and another pixel 186. In this case, the method for interpolation is arbitrary as described in (A-2-2) of the description of the first embodiment. For example, weighted addition may be applied as depicted in FIG. 38. In FIG. 38, x indicates a coordinate in the horizontal direction. For example, the x coordinate of the pixel 185 is “0” and the pixel value is “r1.” Meanwhile, the x coordinate of the pixel 186 is “L” and the pixel value is “r2.” In this case, the reference pixel value “p” of a pixel 187 of the x coordinate “x” can be determined in such a manner as indicated by the expression (3) given hereinabove.

Then, the reference pixels are used to perform intra prediction for the intra region 181 to generate an intra prediction image, and a reconstruction image of the region 181 (2a) is generated (B of FIG. 37).

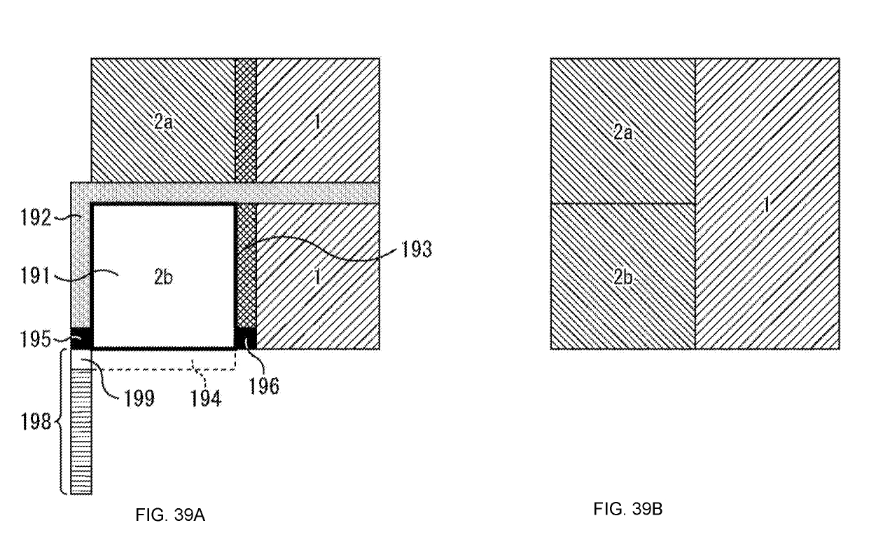

Then, intra prediction is performed for the region 191 (2b) on the right side in FIG. 39 of the intra region as indicated in A of FIG. 39. First, a reference pixel is set. For example, a reference pixel positioned in a region 192 (reference pixel at part of the upper side or at the left side with respect to the intra region 191) can be set using the reconstruction image of the CU for which the prediction process has been performed already or the reconstruction image of the inter region indicated by a slanting line pattern. It is to be noted that the remaining reference pixel on the left side with respect to the intra region 191 (left lower reference pixel in the intra region 191) may be set, when the reconstruction image of a region 198 exists, using the pixel value of the reconstruction image. On the other hand, where the reconstruction image of the region 198 does not exist, the reference pixels may be set, for example, by duplicating the pixel values of a pixel 195 of the reconstruction image.

Meanwhile, a reference pixel positioned in a region 193 indicated by a shadow pattern (reference pixels on the right side with respect to the intra region 191) can be set using the reconstruction image of the inter region indicated by a slanting line pattern.

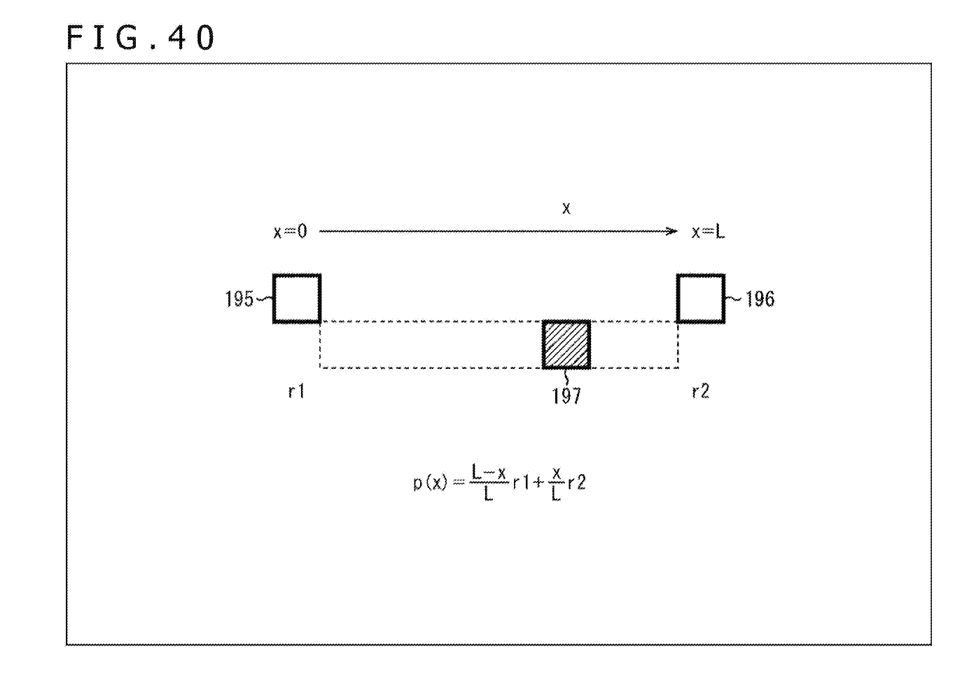

At this point of time, the reconstruction image of a region 194 indicated by a broken line frame does not exist. Therefore, intra prediction may be performed using a reference pixel at a position in the region 198 without setting a reference pixel at a position in the region 194 (reference pixel on the lower side with respect to the intra region 191). Alternatively, a reference pixel positioned in the region 194 may be set by an interpolation process using the reconstruction images of the pixel 195 and another pixel 196. In this case, since there is the possibility that the reconstruction images at left and right pixel positions of the region 194 may not exist at this point of time, an upwardly adjacent pixel is used instead. As described in (A-2-2) of the description of the first embodiment, the method of interpolation is arbitrary. For example, weighted addition may be applied as depicted in FIG. 40. Referring to FIG. 40, x indicates a coordinate in the horizontal direction in FIG. 40. For example, the x coordinate of the pixel 195 is “0” and the pixel value is “r1.” Meanwhile, the x coordinate of the pixel 196 is “L” and the pixel value is “r2.” In this case, the reference pixel value “p” of a pixel 197 of the x coordinate “x” can be determined in accordance with the (3) given hereinabove. It is to be noted that, for example, when a reconstruction image of the region 198 exists, in the interpolation process described above, the pixel value of a pixel 199 may be used in place of the pixel value of the pixel 195 of the reconstruction image.

Then, those reference pixels are used to perform intra prediction for the intra region 191 to generate an intra prediction image, and a reconstruction image of the region 191 (2b) is generated (B of FIG. 39).

Intra prediction of the intra region is performed in such a manner as described above. It is to be noted that, also in the case of the partition pattern nL×2N or nR×2N, intra prediction is performed basically similarly to that of the case of the partition pattern N×2N. Intra prediction may be executed suitably partitioning an intra region into such a shape that intra prediction can be executed.

It is to be noted that the pixel values of a reconstruction image to be used for an interpolation process for reference pixel generation described above may be pixel values of different pictures. For example, the pixel values may be those in a past frame or may be those of a different view or else may be those of a different layer or may be pixel values of a different component.

<Additional Information>

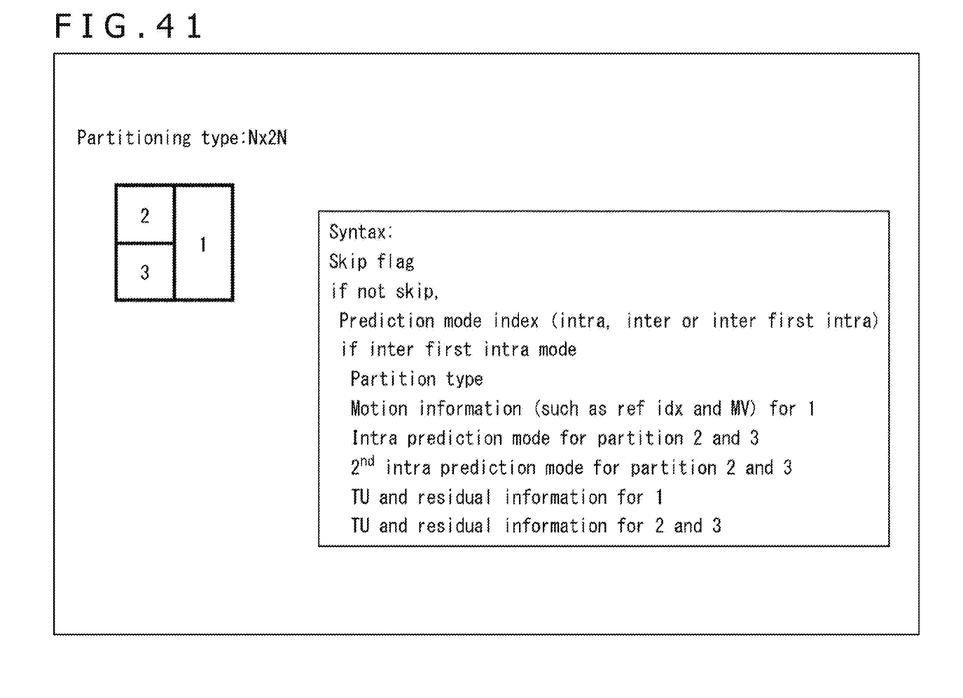

Now, information to be transmitted to the decoding side as additional information relating to inter-destination intra prediction is described. For example, in the case of the partition pattern N×2N as depicted in FIG. 41, such information as depicted in FIG. 41 is transmitted as additional information to the decoding side.

The additional information may include any information. For example, the additional information may include information relating to prediction (prediction information). The prediction information may be, for example, intra prediction information that is information relating to intra prediction or may be inter prediction information that is information relating to inter prediction or else may be inter-destination intra prediction information that is information relating to inter-destination intra prediction.

The inter-destination intra prediction information may include any information. For example, the inter-destination intra prediction information includes inter prediction information relating to inter prediction executed as a process of inter-destination intra prediction. This inter prediction information includes, for example, information indicative of an adopted inter prediction mode, motion information and so forth.

Further, the inter-destination intra prediction information may include intra prediction information that is information relating to intra prediction executed as a process for inter-destination intra prediction. This intra prediction information includes, for example, information indicative of an adopted intra prediction mode. Further, this intra prediction information may include, for example, reference pixel generation method information that is information relating to a generation method of a reference pixel.

This reference pixel generation method information may include, for example, information indicative of a generation method of a reference pixel. Alternatively, for example, where the generation method for a reference pixel is an interpolation process, information that designates a method of the interpolation process may be included. Furthermore, for example, where the method of an interpolation process is a method of mixing a plurality of pixel values, information indicative of a way of the mixture or the like may be included. This information indicative of a way of mixture may, for example, include information of a function, a coefficient and so forth.

Further, the intra prediction information may include, for example, utilization reconstruction image information that is information of a reconstruction image utilized for generation of a reference pixel. This utilization reconstruction image information may include, for example, information indicative of which pixel of a reconstruction image the pixel utilized for generation of a reference pixel is, information indicative of the position of the pixel and so forth.

Further, the intra prediction information may include reference method information that is information relating to a reference method of a reference pixel. This reference method information may include, for example, information indicative of a reference method. Further, for example, where the reference method is a method for mixing a plurality of reference pixels, information indicative of a way of the mixing may be included. The information indicative of the way of mixing may include, for example, information of a function, a coefficient and so forth.

Alternatively, for example, the additional information may include block information that is information relating to a block or a structure of a block. The block information may include information of, for example, a partition flag (split_cu_flag), a partition mode (partition_mode), a skip flag (cu_skip_flag), a prediction mode (pred_mode_flag) and so forth.

Furthermore, for example, the additional information may include control information for controlling a prediction process. This control information may include, for example, information relating to control of inter-destination intra prediction. For example, the control information may include information indicative of whether or not inter-destination intra prediction is to be permitted (able) in a region (for example, a CU, a PU or the like) belonging to the region (for example, a picture, a slice, a tile, an LCU, a CU, a PU or the like) to which the information is allocated, namely, in a region of a lower hierarchy in the region. In other words, the control information may include information indicative of whether or not inter-destination intra prediction is to be inhibited (disable) in a region belonging to the region.

Alternatively, the control information may include, for example, information relating to restriction to a generation method of a reference pixel. For example, the control information may include information indicative of whether or not a predetermined generation method of a reference pixel is to be permitted (able) in a region (for example, a CU, a PU or the like) belonging to the region (for example, a picture, a slice, a tile, an LCU, a CU, a PU or the like) to which the information is allocated. In other words, the control information may include information indicative of whether or not the generation method is to be inhibited (disable) in a region belonging to the region.

It is to be noted that the generation method that becomes a target of such restriction is arbitrary. For example, the generation method may be duplication (copy), may be an interpolation process or may be inter-destination intra prediction. Alternatively, a plurality of methods among them may be made a target of restriction. Where a plurality of generation methods are made a target of restriction, the respective methods may be restricted individually or may be restricted collectively.

Alternatively, the control information may include, for example, information relating to restriction to pixels of a reconstruction image to be utilized for generation of a reference pixel. For example, the control information may include information indicative of whether or not utilization of a predetermined pixel of a reconstruction image to generation of a reference pixel is to be permitted (able) in a region (for example, a CU, a PU or the like) belonging to the region (for example, a picture, a slice, a tile, an LCU, a CU, a PU or the like) to which the information is allocated. In other words, the control information may include information indicative of whether or not utilization of a predetermined pixel of a reconstruction image to generation of a reference pixel is to be inhibited (disable) in a region belonging to the region.

This restriction may be performed in a unit of a pixel or may be performed for each region configured from a plurality of pixels.

Further, the control information may include, for example, information relating to restriction to a reference method (way of reference) to a reference pixel. For example, the control information may include information indicative of whether or not a predetermined reference method to a reference pixel is to be permitted (able) in a region (for example, a CU, a PU or the like) belonging to the region (for example, a picture, a slice, a tile, an LCU, a CU, a PU or the like) to which the information is allocated. In other words, the control information may include information indicative of whether or not a predetermined reference method to a reference pixel is to be inhibited (disable) in a region belonging to the region.

The reference method (way of reference) that is made a target of restriction is arbitrary. For example, the reference method may be a method by which one mode is selected as the intra prediction mode and, at each pixel of a current block, one reference pixel in a reference direction corresponding to the intra prediction mode is referred to to generate a prediction pixel value. Alternatively, the reference method may be a method by which, for example, one mode is selected as an intra prediction mode and, at each pixel of a current block, a plurality of reference pixels corresponding to the intra prediction mode are utilized for generation of a prediction image. Furthermore, for example, the reference method may be a method by which a plurality of modes are selected as an intra prediction mode. Alternatively, a plurality of ones of the methods may be made a target of restriction. Further, in this case, the methods may be restricted independently of each other or a plurality of methods may be restricted collectively.

Furthermore, details of the methods may be restricted. For example, it may be made possible to restrict a mode (prediction direction) that can be designated (or whose designation is inhibited). Alternatively, for example, where a plurality of reference pixels are mixed upon reference, the function, coefficient or the like may be restricted.

Further, the control information may include, for example, information relating to restriction to other information. For example, the control information may include information for restricting the size (for example, a lower limit to the CU size) of a region (for example, a CU, a PU or the like) belonging to the region (for example, a picture, a slice, a tile, an LCU, a CU, a PU or the like) to which the information is allocated. Further, for example, the control information may include information for restricting partition patterns that can be set in a region (for example, a CU, a PU or the like) belonging to the region (for example, a picture, a slice, a tile, an LCU, a CU, a PU or the like) to which the information is allocated.

Further, the control information may include initial values of various parameters in a region (for example, a picture, a slice, a tile, an LCU, a CU, a PU or the like) to which the control information is allocated.

Naturally, the control information may include information other than the examples described above.

### 3. Third Embodiment

<Image Decoding Apparatus>

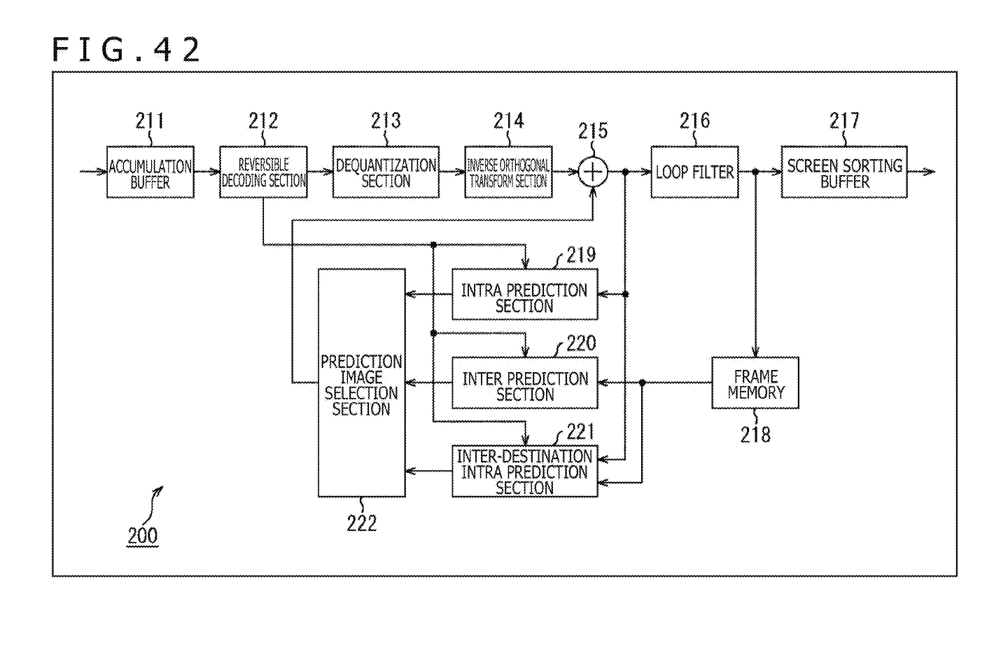

Now, decoding of encoded data encoded in such a manner as described above is described. FIG. 42 is a block diagram depicting an example of a configuration of an image decoding apparatus that is a form of the image processing apparatus to which the present technology is applied. The image decoding apparatus 200 depicted in FIG. 42 is an image decoding apparatus that corresponds to the image encoding apparatus 100 of FIG. 14 and decodes encoded data generated by the image encoding apparatus 100 in accordance with a decoding method corresponding to the encoding method. It is to be noted that, in FIG. 42, main processing sections, flows of data and so forth are depicted, and elements depicted in FIG. 42 are not all elements. In other words, a processing section that is not indicated as a block in FIG. 42 may exist in the image decoding apparatus 200, or a process or a flow of data not depicted as an arrow mark or the like in FIG. 42 may exist.

As depicted in FIG. 42, the image decoding apparatus 200 includes an accumulation buffer 211, a reversible decoding section 212, a dequantization section 213, an inverse orthogonal transform section 214, an arithmetic operation section 215, a loop filter 216, and a screen sorting buffer 217. The image decoding apparatus 200 further includes a frame memory 218, an intra prediction section 219, an inter prediction section 220, an inter-destination intra prediction section 221 and a prediction image selection section 222.

The accumulation buffer 211 accumulates encoded data transmitted thereto and supplies the encoded data to the reversible decoding section 212 at a predetermined timing. The reversible decoding section 212 decodes the encoded data supplied from the accumulation buffer 211 in accordance with a method corresponding to the encoding method of the reversible encoding section 115 of FIG. 14. After the reversible decoding section 212 decodes the encoded data to obtain residual data after quantization, it supplies the residual data to the dequantization section 213.

Further, the reversible decoding section 212 refers to prediction information included in additional information obtained by decoding the encoded data to decide whether intra prediction is selected, inter prediction is selected or inter-destination intra prediction is selected. The reversible decoding section 212 supplies, on the basis of a result of the decision, information necessary for a prediction process such as prediction information and block information to the intra prediction section 219, inter prediction section 220 or inter-destination intra prediction section 221.

The dequantization section 213 dequantizes the residual data after the quantization supplied from the reversible decoding section 212. In particular, the dequantization section 213 performs dequantization in accordance with a method corresponding to the quantization method of the quantization section 114 of FIG. 14. After the dequantization section 213 acquires the residual data after orthogonal transform by the dequantization, it supplies the residual data to the inverse orthogonal transform section 214.

The inverse orthogonal transform section 214 inversely orthogonally transforms the residual data after the orthogonal transform supplied from the dequantization section 213. In particular, the inverse orthogonal transform section 214 performs inverse orthogonal transform in accordance with a method corresponding to the orthogonal transform method of the orthogonal transform section 113 of FIG. 14. After the inverse orthogonal transform section 214 acquires the residual data by the inverse orthogonal transform process, it supplies the residual data to the arithmetic operation section 215.

The arithmetic operation section 215 adds the prediction image supplied from the prediction image selection section 222 to the residual data supplied from the inverse orthogonal transform section 214 to obtain a reconstruction image. The arithmetic operation section 215 supplies the reconstruction image to the loop filter 216, intra prediction section 219 and inter-destination intra prediction section 221.

The loop filter 216 performs a loop filter process similar to that performed by the loop filter 121 of FIG. 14. Thereupon, the loop filter 216 may perform the loop filter process using a filter coefficient and so forth supplied from the image encoding apparatus 100 of FIG. 14. The loop filter 216 supplies a decoded image that is a result of the filter process to the screen sorting buffer 217 and the frame memory 218.

The screen sorting buffer 217 performs sorting of the decoded image supplied thereto. In particular, the order of frames having been sorted into those of the encoding order by the screen sorting buffer 111 of FIG. 14 is changed into the original displaying order. The screen sorting buffer 217 outputs the decoded image data whose frames have been sorted to the outside of the image decoding apparatus 200.

The frame memory 218 stores the decoded image supplied thereto. Further, the frame memory 218 supplies the decoded image and so forth stored therein to the inter prediction section 220 or the inter-destination intra prediction section 221 in accordance with an external request of the inter prediction section 220, inter-destination intra prediction section 221 or the like.

The intra prediction section 219 performs intra prediction utilizing the reconstruction image supplied from the arithmetic operation section 215. The inter prediction section 220 performs inter prediction utilizing the decoded image supplied from the frame memory 218. The inter-destination intra prediction section 221 is a form of the prediction section to which the present technology is applied. The inter-destination intra prediction section 221 performs an inter-destination intra prediction process utilizing the reconstruction image supplied from the arithmetic operation section 215 and the decoded image supplied from the frame memory 218.

The intra prediction section 219 to inter-destination intra prediction section 221 perform a prediction process in accordance with the prediction information, block information and so forth supplied from the reversible decoding section 212. In particular, the intra prediction section 219 to inter-destination intra prediction section 221 perform a prediction process in accordance with a method adopted by the encoding side (prediction method, partition pattern, prediction mode or the like). For example, the inter-destination intra prediction section 221 performs inter prediction for some region of a processing target region of the image, set a reference pixel using a reconstruction image corresponding to a prediction image generated by the inter prediction, and performs intra prediction using the set reference pixel for the other region of the processing target region.

In this manner, for each CU, intra prediction by the intra prediction section 219, inter prediction by the inter prediction section 220 or inter-destination intra prediction by the inter-destination intra prediction section 221 is performed. The prediction section that has performed the prediction (one of the intra prediction section 219 to inter-destination intra prediction section 221) supplies a prediction image as a result of the prediction to the prediction image selection section 222. The prediction image selection section 222 supplies the prediction image supplied thereto to the arithmetic operation section 215.

As described above, the arithmetic operation section 215 generates a reconstruction image (decoded image) using the residual data (residual image) obtained by decoding and the prediction image generated by the inter-destination intra prediction section 221 or the like.

<Inter-Destination Intra Prediction Section>

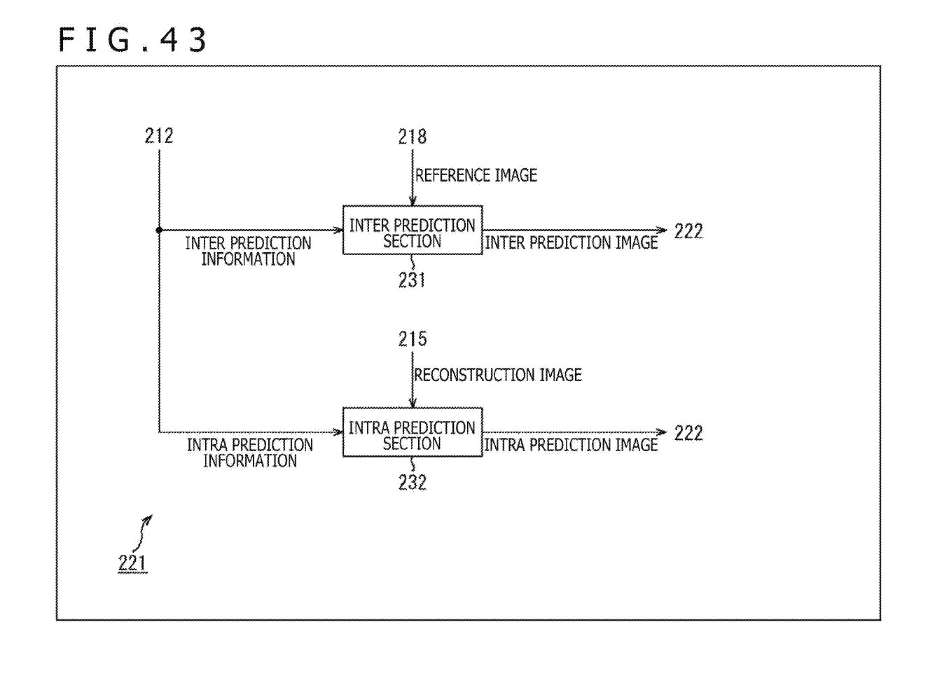

FIG. 43 is a block diagram depicting an example of a main configuration of the inter-destination intra prediction section 221. As depicted in FIG. 43, the inter-destination intra prediction section 221 includes an inter prediction section 231 and an intra prediction section 232.

The inter prediction section 231 performs a process relating to inter prediction. For example, the inter prediction section 231 acquires a reference image from the frame memory 218 on the basis of the inter prediction information supplied from the reversible decoding section 212 and performs inter prediction for an inter region using the reference image to generate an inter prediction image relating to the inter region. The inter prediction section 231 supplies the generated inter prediction image to the prediction image selection section 222.

The intra prediction section 232 performs a process relating to intra prediction. For example, the intra prediction section 232 acquires a reconstruction image including a reconstruction image of the inter region from the arithmetic operation section 215 on the basis of intra prediction information supplied from the reversible decoding section 212 and performs intra prediction of an intra region using the reconstruction image to generate an intra prediction image relating to the intra region. The intra prediction section 232 supplies the generated intra prediction image to the prediction image selection section 222.

Since the image decoding apparatus 200 performs a prediction process in accordance with a method similar to that adopted by the image encoding apparatus 100 as described above, it can correctly decode a bit stream encoded by the image encoding apparatus 100. Accordingly, the image decoding apparatus 200 can implement suppression of reduction of the encoding efficiency.

<Flow of Decoding Process>

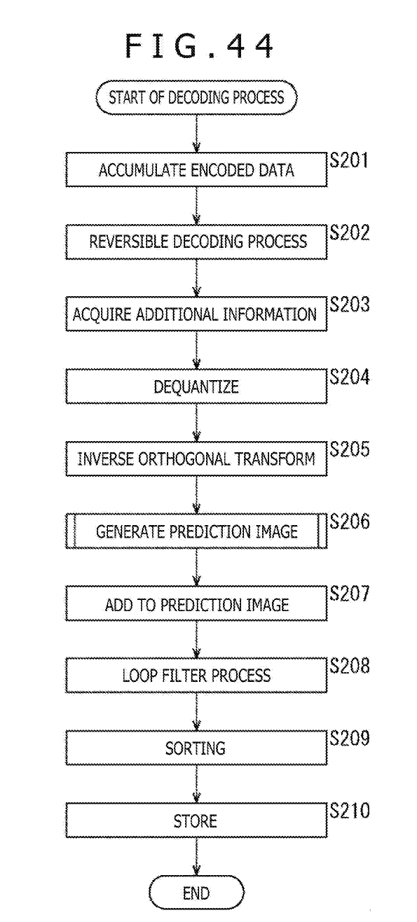

Now, a flow of respective processes executed by such an image decoding apparatus 200 as described above is described. First, an example of a flow of a decoding process is described with reference to a flow chart of FIG. 44.

After a decoding process is started, the accumulation buffer 211 accumulates encoded data (bit stream) transmitted thereto at step S201. At step S202, the reversible decoding section 212 decodes the encoded data supplied from the accumulation buffer 211. At step S203, the reversible decoding section 212 extracts and acquires additional information from the encoded data.

At step S204, the dequantization section 213 dequantizes residual data after quantization obtained by decoding the encoded data by the process at step S202. At step S205, the inverse orthogonal transform section 214 inversely orthogonally transforms the residual data after orthogonal transform obtained by dequantization at step S204.

At step S206, one of the reversible decoding section 212 and the intra prediction section 219 to inter-destination intra prediction section 221 performs a prediction process using the information supplied thereto to generate a prediction image. At step S207, the arithmetic operation section 215 adds the prediction image generated at step S206 to the residual data obtained by the inverse orthogonal transform at step S205. A reconstruction image is generated thereby.

At step S208, the loop filter 216 suitably performs a loop filter process for the reconstruction image obtained at step S207 to generate a decoded image.

At step S209, the screen sorting buffer 217 performs sorting of the decoded image generated by the loop filter process at step S208. In particular, the frames obtained by sorting for encoding by the screen sorting buffer 111 of the image encoding apparatus 100 are sorted back into those of the displaying order.

At step S210, the frame memory 218 stores the decoded image obtained by the loop filter process at step S208. This decoded image is utilized as a reference image in inter prediction or inter-destination intra prediction.

When the process at step S210 ends, the decoding process is ended.

<Flow of Prediction Process>

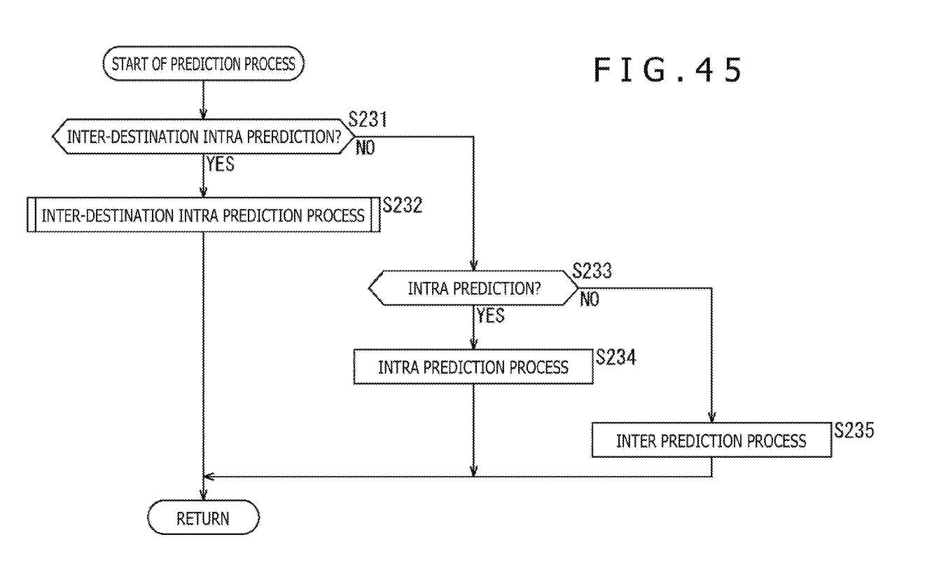

Now, an example of a flow of the prediction process performed at step S206 of FIG. 44 is described with reference to the flow chart of FIG. 45.

After the prediction process is started, at step S231, the reversible decoding section 212 decides on the basis of additional information acquired from the encoded data whether or not the prediction method adopted by the image encoding apparatus 100 for a block (CU) of a processing target is inter-destination intra prediction. If it is decided that inter-destination intra prediction is adopted by the image encoding apparatus 100, then the processing advances to step S232. At step S232, the inter-destination intra prediction section 221 performs an inter-destination intra prediction process to generate a prediction image for the block of the processing target. After the prediction image is generated, the prediction process ends, and the processing returns to FIG. 44.

On the other hand, if it is decided at step S231 that inter-destination intra prediction is not adopted, then the processing advances to step S233. At step S233, the reversible decoding section 212 decides on the basis of the additional information acquired from the encoded data whether or not the prediction method adopted by the image encoding apparatus 100 for the block (CU) of the processing target is intra prediction. If it is decided that intra prediction is adopted by the image encoding apparatus 100, then the processing advances to step S234. At step S234, the intra prediction section 219 performs an intra prediction process to generate a prediction image of the block of the processing target. After the prediction image is generated, the prediction process ends, and the processing returns to FIG. 44.

On the other hand, if it is decided at step S233 that intra prediction is not adopted, then the processing advances to step S235. At step S235, the inter prediction section 220 performs inter prediction to generate a prediction image of the block of the processing target. After the prediction image is generated, then prediction process ends, and the processing returns to FIG. 44.

<Flow of Inter-Destination Intra Prediction Process>

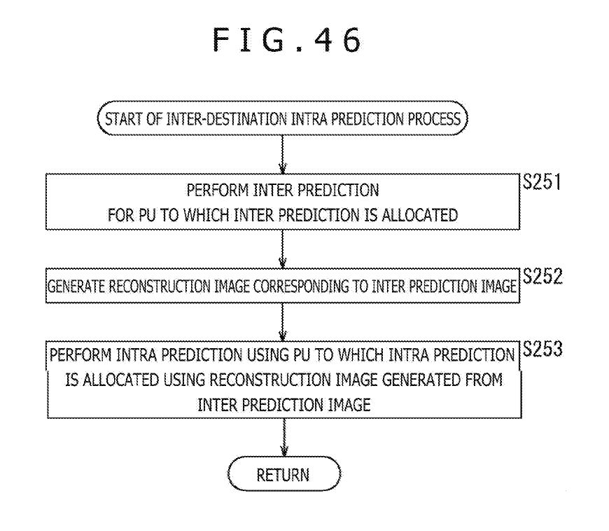

Now, an example of a flow of the inter-destination intra prediction process executed at step S232 of FIG. 45 is described with reference to the flow chart of FIG. 46.

After the inter-destination intra prediction process is started, the inter prediction section 231 performs, at step S251, inter prediction for an inter region (PU) to which inter prediction is allocated in the block (CU) of the processing target to generate an inter prediction image.

At step S252, the inter prediction section 231 supplies the inter prediction image generated by the process at step S251 to the prediction image selection section 222 such that the arithmetic operation section 215 adds the inter prediction image to the residual data to generate a reconstruction image corresponding to the inter prediction image (namely, a reconstruction image of the inter region).

At step S253, the intra prediction section 232 uses the reconstruction image obtained by the process at step S252 to perform intra prediction for an intra region (PU) to which intra prediction is allocated in the block (CU) of the processing target to generate an intra prediction image of the intra region. After the process at step S253 ends, the processing returns to FIG. 45.

By executing the respective processes as described above, the image decoding apparatus 200 can implement suppression of reduction of the encoding efficiency.

### 4. Fourth Embodiment

<Inter-Destination Intra Prediction of LCU>

In the foregoing description, a case is described in which a processing target region indicates an encoded block that becomes a unit of encoding and a region of a lower hierarchy indicates a prediction block that becomes a unit of a prediction process in the encoded block. However, the processing target region and the region of the lower hierarchy may be other than them. For example, both the processing target region and the region of the lower hierarchy may each be an encoded block. In particular, the processing target region may be a set of a plurality of encoded blocks, and the region of the lower hierarchy may be an encoded block. For example, the processing target region may be an LCU or a CU, and the region of the lower hierarchy may be a CU of a lower hierarchy.

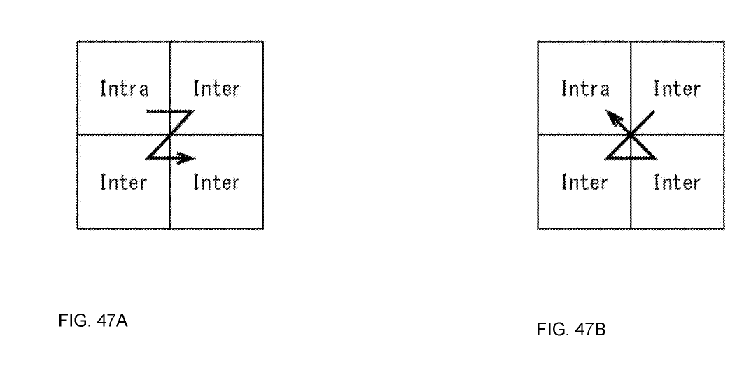

In the case of AVC or HEVC, for example, when a CU of a predetermined hierarchy such as the LCU includes a plurality of CUs of a lower hierarchy, prediction processes for the CUs in the lower hierarchy are scanned in a Z order as indicated by A of FIG. 47. Accordingly, in this case, when the right upper CU in A of FIG. 47 is to be intra-predicted, the right side or the upper side of the CU cannot be referred to, and there is the possibility that the encoding efficiency may be reduced.

Therefore, where a CU of a predetermined hierarchy such as the LCU includes a plurality of CUs of a lower hierarchy, as indicated by B of FIG. 47, the prediction process for the CUs of the lower hierarchy is performed such that a CU for which inter prediction is to be performed is processed earlier than a CU for which intra prediction is to be performed. In other words, inter-destination intra prediction is performed in a unit of a CU.

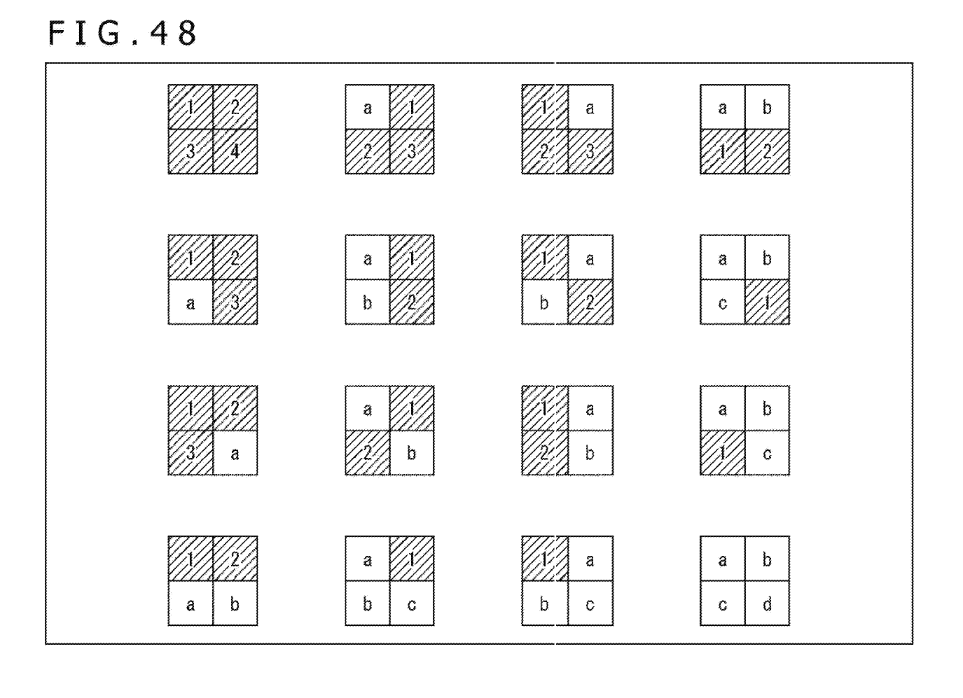

As described with reference to FIGS. 1 to 3, a CU is partitioned, where CUs of a lower hierarchy are to be formed, into four as in the example of FIG. 47. It is arbitrary to which CU intra prediction is to be allocated and to which CU inter prediction is to be allocated from among the four CUs in the lower hierarchy. For example, such allocation patterns as depicted in FIG. 48 may be prepared in advance such that a desired pattern is selected from among the allocation patterns. In FIG. 48, a rectangle to which a slanting line pattern is applied is a CU to which inter prediction is allocated, and a plain square is a CU to which intra prediction is applied. It is to be noted that a numeral or an alphabet in each CU indicates a processing order number. Between CUs of numerals, they are processed in an ascending order of the numerals. Between CUs of alphabets, they are processed in the order of a, b, c and d. Further, a CU of a numeral is a CU for which inter prediction is performed, and a CU of an alphabet is a CU for which intra prediction is performed, and therefore, CUs of numerals are processed earlier than CUs of alphabets.

Which allocation pattern is to be selected can be set by an arbitrary method. For example, an allocation pattern may be selected on the basis of a cost function value (for example, a pattern of the lowest RD cost may be selected).

Where intra prediction is performed in such a prediction process as described above, processing is performed utilizing a result of processing (reconstruction image) of inter prediction similarly as in the case of the second embodiment. Consequently, intra prediction can be performed utilizing reference pixels at more various positions, and reduction of the encoding efficiency can be suppressed. In short, the code amount of a bit stream can be reduced. In other words, if the code amount is kept, then the picture quality of a decoded image can be improved. Further, since pixels that can be referred to increase, discontinuous components on the boundary between blocks in intra prediction decrease, and therefore, the picture quality of a decoded image can be improved.

<Image Encoding Apparatus>

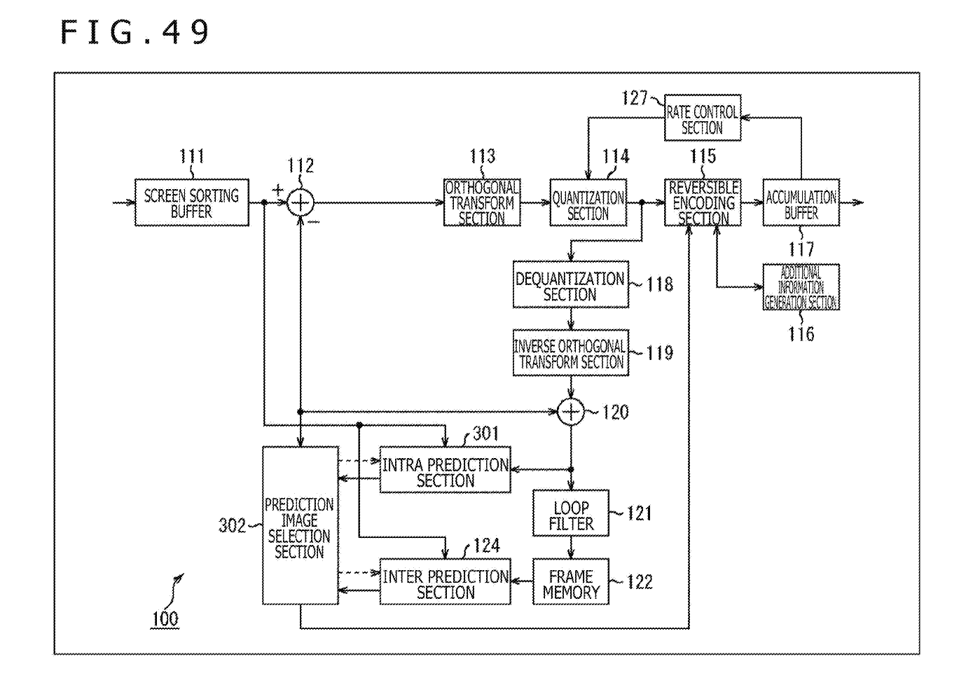

An example of a main configuration of the image encoding apparatus 100 in this case is depicted in FIG. 49. It is to be noted that, in FIG. 49, main elements such as a processing section or a flow of data are depicted, and elements depicted in FIG. 49 are not all elements. In other words, main processing sections, flows of data and so forth are depicted, and elements depicted in FIG. 49 are not all elements. In other words, a processing section that is not indicated as a block in FIG. 49 may exist in the image encoding apparatus 100, or a process or a flow of data not depicted as an arrow mark or the like in FIG. 49 may exist.

As depicted in FIG. 49, also in this case, the image encoding apparatus 100 has a configuration basically similar to that of the case of FIG. 14. However, the image encoding apparatus 100 includes an intra prediction section 301 in place of the intra prediction section 123 and the inter-destination intra prediction section 125 and includes a prediction image selection section 302 in place of the prediction image selection section 126.

The intra prediction section 301 performs intra prediction for a CU of a processing target similarly as in the case of the intra prediction section 123. However, the intra prediction section 301 performs intra expectation using a result of processing of inter prediction similarly to the intra prediction section 134. In particular, the intra prediction section 301 performs intra prediction using a reconstruction image generated using an inter prediction image generated by the inter prediction section 124.

Although the prediction image selection section 302 performs processing basically similar to that of the prediction image selection section 126, it controls the intra prediction section 301 and the inter prediction section 124.

<Prediction Image Selection Section>

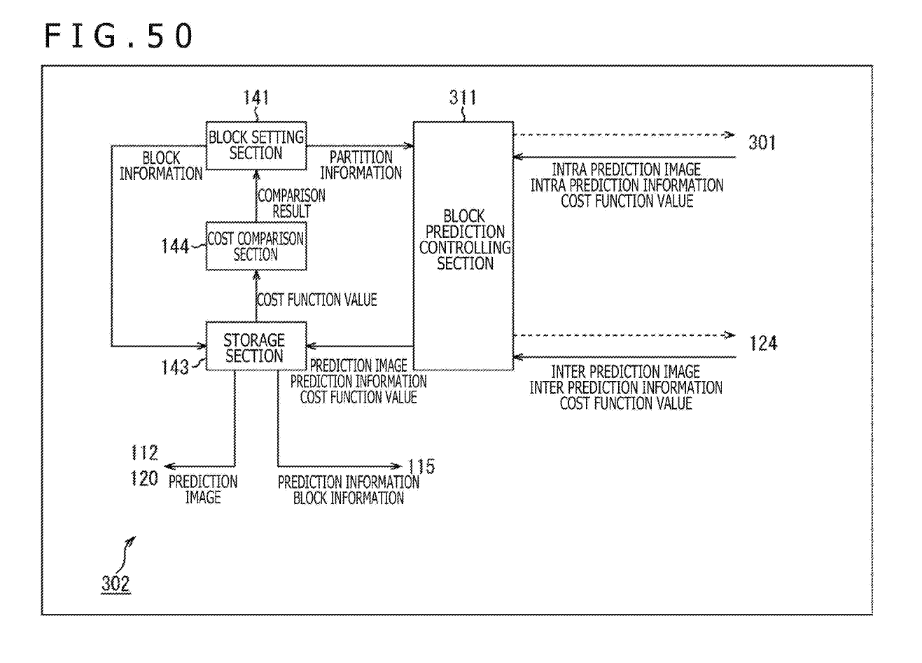

FIG. 50 is a block diagram depicting an example of a main configuration of the prediction image selection section 302. As depicted in FIG. 50, the prediction image selection section 302 has a configuration basically similar to that of the prediction image selection section 126. However, the prediction image selection section 302 includes a block prediction controlling section 311 in place of the block prediction controlling section 142.

Although the block prediction controlling section 311 performs processing basically similar to that of the block prediction controlling section 142, it controls the intra prediction section 301 and the inter prediction section 124. In particular, the block prediction controlling section 311 controls the intra prediction section 301 and the inter prediction section 124 on the basis of partition information acquired from the block setting section 141 to execute a prediction process for each block set by the block setting section 141.

Thereafter, the block prediction controlling section 311 causes inter prediction for a CU to which inter prediction is allocated to be executed before intra prediction for a CU to which intra prediction is allocated in response to a set allocation pattern. Then, the block prediction controlling section 311 controls the intra prediction section 301 to execute intra prediction utilizing a result of the process of inter prediction (reconstruction image corresponding to the inter prediction image).

The block prediction controlling section 311 supplies a prediction image, prediction information and a cost function value of the selected optimum mode of each block to the storage section 143. It is to be noted that information indicative of a result of the selection, partition information and so forth described above are included in the prediction information as occasion demands.

By such a configuration as described above, since inter-destination intra prediction in which inter prediction is processed before intra prediction can be performed in a unit of a block, the image encoding apparatus 100 can suppress reduction of the encoding efficiency similarly as in the case of the second embodiment.

It is to be noted that, also in this case, by transmitting such various kinds of information as depicted in the description of the first embodiment or the second embodiment as additional information to the decoding side, the decoding side can correctly decode the encoded data generated by the image encoding apparatus 100.

<Flow of Prediction Process>

Also in this case, the encoding process is executed in such a flow as described hereinabove with reference to the flow chart of FIG. 21 similarly as in the case of the second embodiment.

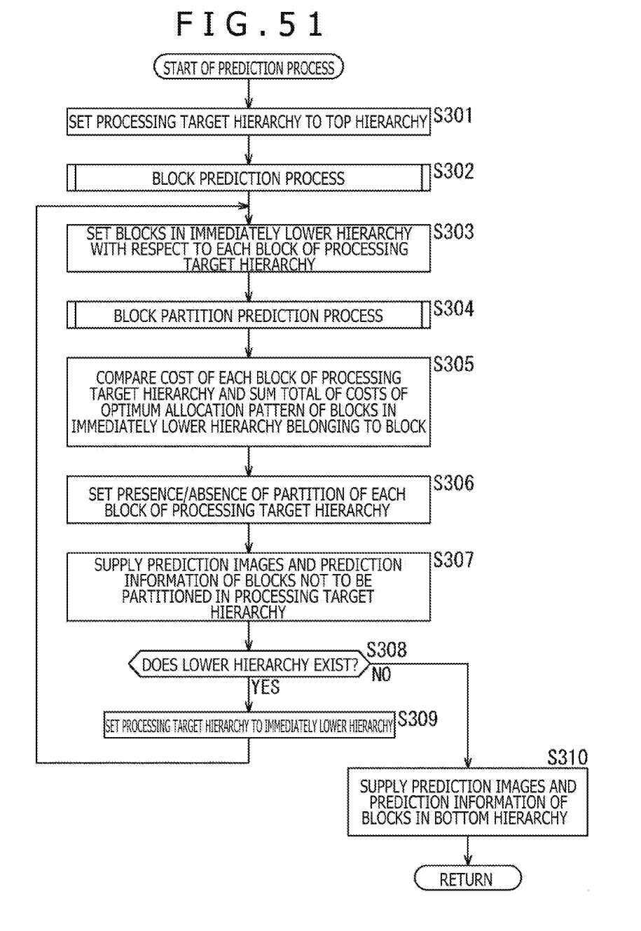

An example of a flow of the prediction process executed at step S102 of FIG. 21 in this case is described with reference to a flow chart of FIG. 51.

After the prediction process is started, the block setting section 141 of the prediction image selection section 126 sets a processing target hierarchy to the top hierarchy (namely, to the LCU) at step S301.

At step S302, the block prediction controlling section 311 controls the intra prediction section 301 and the inter prediction section 124 to perform a block prediction process for a block of the processing target hierarchy (namely, for the LCU).

At step S303, the block setting section 141 sets blocks in the immediately lower hierarchy with respect to each block of the processing target hierarchy.

At step S304, the block prediction controlling section 311 controls the intra prediction section 301 and the inter prediction section 124 to perform a block partition prediction process by which inter-destination intra prediction and selection of an optimum allocation pattern of prediction methods are performed.

At step S305, the cost comparison section 144 compares the cost of the block of the processing target hierarchy and the sum total of the costs of the optimum allocation pattern of the blocks, which belongs to the block, of the immediately lower hierarchy with each other. The cost comparison section 144 performs such comparison for each of the blocks of the processing target hierarchy.

The respective processes at steps S306 to S310 are executed similarly to the processes at steps S136 to S140 of FIG. 22.

<Flow of Block Prediction Process>

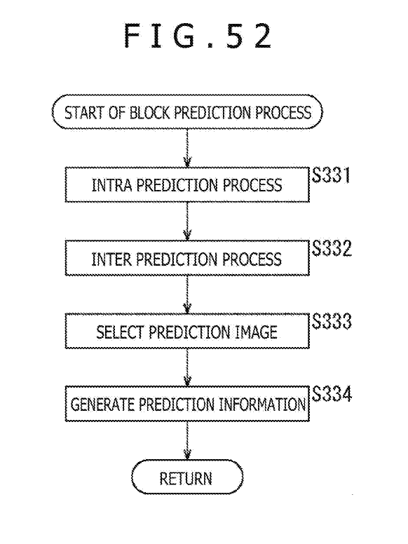

Now, an example of a flow of the block prediction process executed at step S302 of FIG. 51 is described with reference to a flow chart of FIG. 52.

After the block prediction process is started, the intra prediction section 301 performs an intra prediction process for the processing target block at step S331. This intra prediction process is performed utilizing a reference pixel similar to that in the case of conventional AVC or HEVC.

At step S332, the inter prediction section 124 performs an inter prediction process for the processing target block.

At step S333, the block prediction controlling section 311 compares the cost function values obtained by the processes at steps S331 and S332 with each other and selects a prediction image in response to a result of the comparison. In short, an optimum prediction mode is set.

At step S334, the block prediction controlling section 311 generates prediction information of the optimum mode using prediction information corresponding to the prediction image selected at step S333.

When the process at step S165 ends, the block prediction process is ended, and the processing returns to FIG. 51.

<Flow of Block Partition Prediction Process>

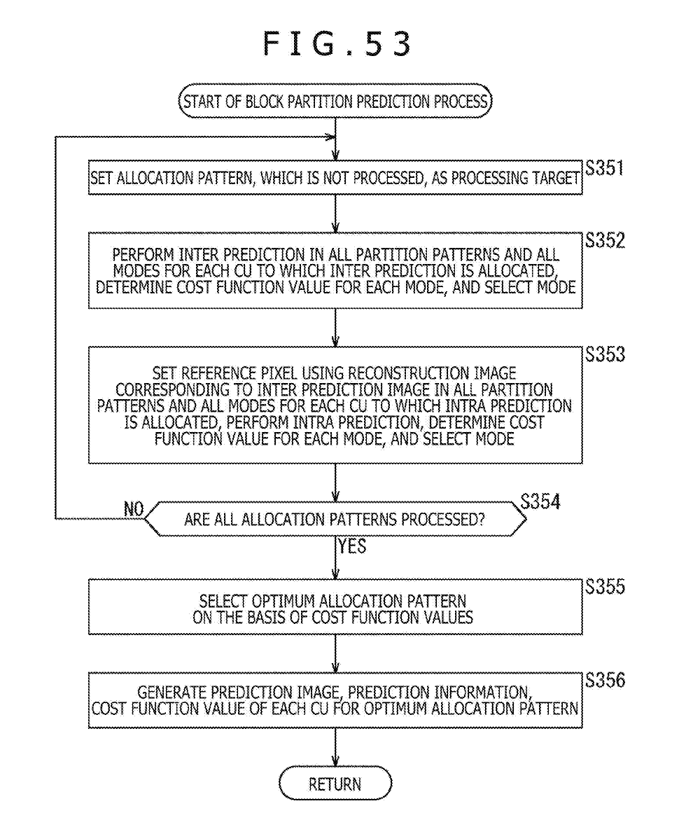

Now, an example of a flow of the block partition prediction process executed at step S304 of FIG. 51 is described with reference to a flow chart of FIG. 53.

After the block partition prediction process is started, the block prediction controlling section 311 sets an allocation pattern that has not been processed as yet as a processing target at step S351.

At step S352, the inter prediction section 124 performs, under the control of the block prediction controlling section 311, inter prediction in all modes for all partition patterns, determines cost function values of the respective modes and selects a mode for each of CUs to which inter prediction is allocated.

At step S353, the intra prediction section 301 sets, for each of CUs to which intra prediction is allocated, a reference pixel using a reconstruction image corresponding to an inter prediction image in all modes for all partition patterns, performs intra prediction, determines a cost function value for each mode and selects a mode.

At step S354, the block prediction controlling section 311 decides whether or not all allocation patterns are processed. If it is decided that an allocation pattern that has not been processed as yet exists, then the processing returns to step S351 to repeat the processes at the steps beginning with step S351.

If it is decided at step S354 that all allocation patterns are processed, then the processing advances to step S355.

At step S355, the block prediction controlling section 311 selects an optimum pattern on the basis of the cost function values.

At step S356, the block prediction controlling section 311 uses information supplied from the inter prediction section 124 and the intra prediction section 301 to generate a prediction image, prediction information and a cost function value of each CU regarding the optimum allocation pattern.

When the process at step S356 ends, the block partition prediction process ends, and the processing returns to FIG. 51.

By executing the respective processes as described above, a reference pixel can be set to a position at which a reference pixel is not set in an intra prediction process of conventional AVC or HEVC, and therefore, reduction of the prediction accuracy of intra prediction can be suppressed. Consequently, reduction of the encoding efficiency can be suppressed. In other words, it is possible to suppress increase of the code amount or suppress reduction of the picture quality.

### 5. Fifth Embodiment

<Image Decoding Apparatus>

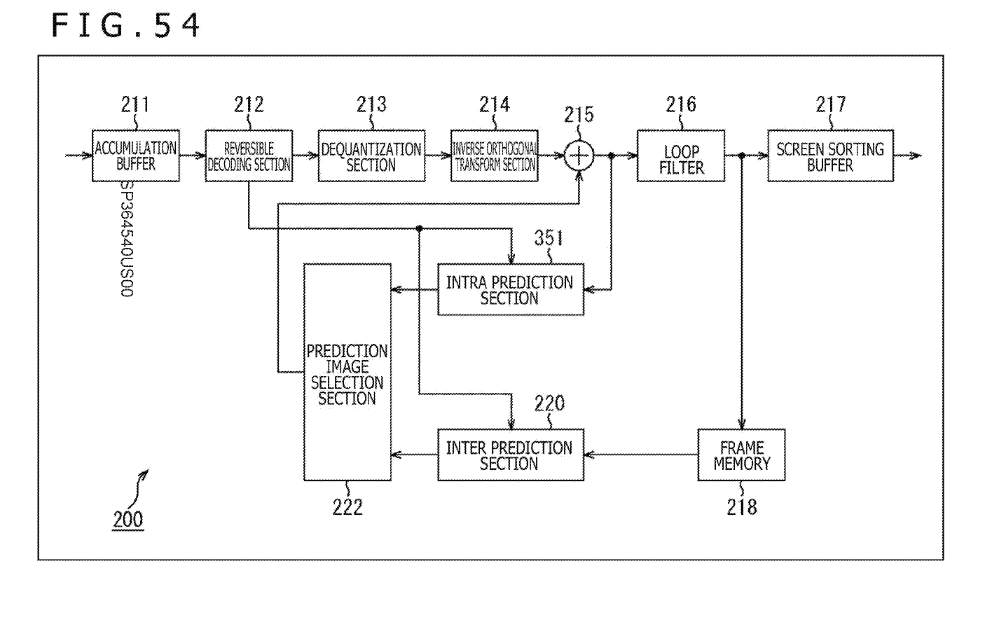

FIG. 54 is a block diagram depicting an example of a main configuration of the image decoding apparatus 200 in this case. The image decoding apparatus 200 depicted in FIG. 54 is an image decoding apparatus corresponding to the image encoding apparatus 100 of FIG. 49 and decodes encoded data generated by the image encoding apparatus 100 by a decoding method corresponding to the encoding method by the image encoding apparatus 100. It is to be noted that, in FIG. 54, main processing sections, flows of data and so forth are depicted, and elements depicted in FIG. 54 are not all elements. In other words, a processing section that is not indicated as a block in FIG. 54 may exist in the image decoding apparatus 200, or a process or a flow of data not depicted as an arrow mark or the like in FIG. 54 may exist.

As depicted in FIG. 54, the image decoding apparatus 200 has, also in this case, a configuration basically similar to that of the case of FIG. 42. However, the image decoding apparatus 200 includes an intra prediction section 351 in place of the intra prediction section 219 and the inter-destination intra prediction section 221.

The intra prediction section 351 performs intra prediction for a CU of a processing target similarly as in the case of the intra prediction section 219. However, the intra prediction section 351 performs intra prediction using a result of processing of inter prediction similarly to the intra prediction section 232.

As described hereinabove in connection with the fourth embodiment, if, upon encoding, a CU for which inter prediction is to be performed and another CU for which intra prediction is to be performed exist in a mixed manner in a region of a certain processing target, then inter prediction is performed first, and intra prediction is performed using a reconstruction image generated using an inter prediction image obtained by the inter prediction. Also the image decoding apparatus 200 performs inter prediction and intra prediction in a similar procedure. Since this procedure is indicated by a configuration of encoded data, additional information and so forth, the image decoding apparatus 200 may process each CU in accordance with the procedure. In particular, when the intra prediction section 351 performs intra prediction, since inter prediction of a CU in the proximity of the CU is ended, the intra prediction section 351 sets a reference pixel using a reconstruction image generated using the inter prediction image and performs intra prediction.

As described above, also in this case, since the image decoding apparatus 200 performs a prediction process by a method similar to the method adopted in the image encoding apparatus 100, it can correctly decode a bit stream encoded by the image encoding apparatus 100. Accordingly, the image decoding apparatus 200 can implement suppression of reduction of the encoding efficiency.

<Flow of Decoding Process>

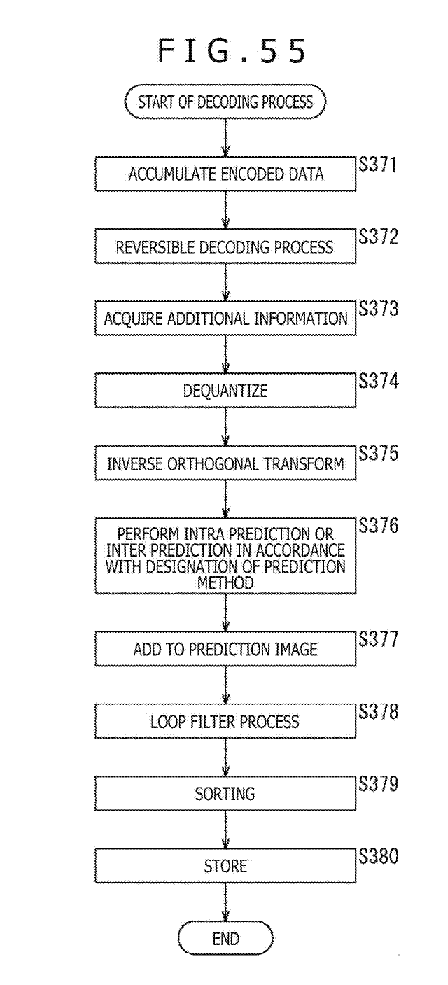

An example of a flow of the decoding process in this case is described with reference to a flow chart of FIG. 55. Processes at steps S371 to S375 are executed similarly to the processes at steps S201 to S205 of FIG. 44, respectively.

At step S376, the inter prediction section 220 or the intra prediction section 351 performs intra prediction or inter prediction similarly as upon encoding for each CU in accordance with a prediction method designated by additional information or encoded data supplied from the encoding side.

In particular, the inter prediction section 220 performs inter prediction for CUs for which inter prediction has been performed upon encoding on the basis of the additional information, and the intra prediction section 351 performs intra prediction for the CUs for which intra prediction has been performed upon encoding on the basis of the additional information.

Processes at steps S377 to S380 are executed similarly to the processes at steps S207 to S210 of FIG. 44, respectively.

By executing the decoding process in this manner, the image decoding apparatus 200 can implement suppression of reduction of the encoding efficiency.

Although, in the fourth embodiment and the fifth embodiment described above, a case is described in which a processing target region and a region of a lower hierarchy are encoded blocks, the processing target region and the region of a lower hierarchy are arbitrary regions and may be regions different from the regions described above. For example, the processing target region may be any of a slice, a tile and a picture, and the region of a lower hierarchy may be any region if it is included in the processing target region.

### 6. Sixth Embodiment

<Reference to Plurality in Single Prediction Mode>

While the second to fifth embodiments are directed to an example in which the inter-destination intra prediction described in (B) of the first embodiment is applied as a reference pixel generation method, the generation method of a reference pixel is arbitrary and is not limited to this. For example, a reference pixel may be generated using an arbitrary pixel (existing pixel) of a reconstruction image generated by a prediction process performed already as described hereinabove in (A) (including (A-1), (A-1-1) to (A-1-6), (A-2), (A-2-1), and (A-2-2)) of the first embodiment.

For example, the way of reference to a reference pixel is arbitrary, and a plurality of reference pixels may be referred to in order to generate one pixel of a prediction image as described in (E) (including (E-1) to (E-4)) of the first embodiment.

As depicted in FIG. 11, in this case, one mode is selected as an optimum intra prediction mode. Then, when respective pixels of a prediction image are to be generated, a plurality of reference pixels corresponding to the optimum intra prediction mode are referred to. In the case of the example of FIG. 11, a reference pixel positioned in the prediction direction of the intra prediction mode and a reference pixel positioned in the opposite direction to the prediction direction are referred to. Thereupon, one of the reference pixels may be selected from the plurality of reference pixels (for example, a nearer one, a median or the like may be selected), or a plurality of reference pixels may be mixed (for example, averaged, weighted added or the like).

In a case in which such a way of reference is applied, as a method for generating a reference pixel, a method for generating a reference pixel using such an arbitrary pixel (existing pixel) of a reconstruction image generated by a prediction process performed already as described hereinabove in (A) (including (A-1), (A-1-1) to (A-1-6), (A-2), (A-2-1), and (A-2-2)) of the first embodiment may be applied.

<Image Encoding Apparatus>

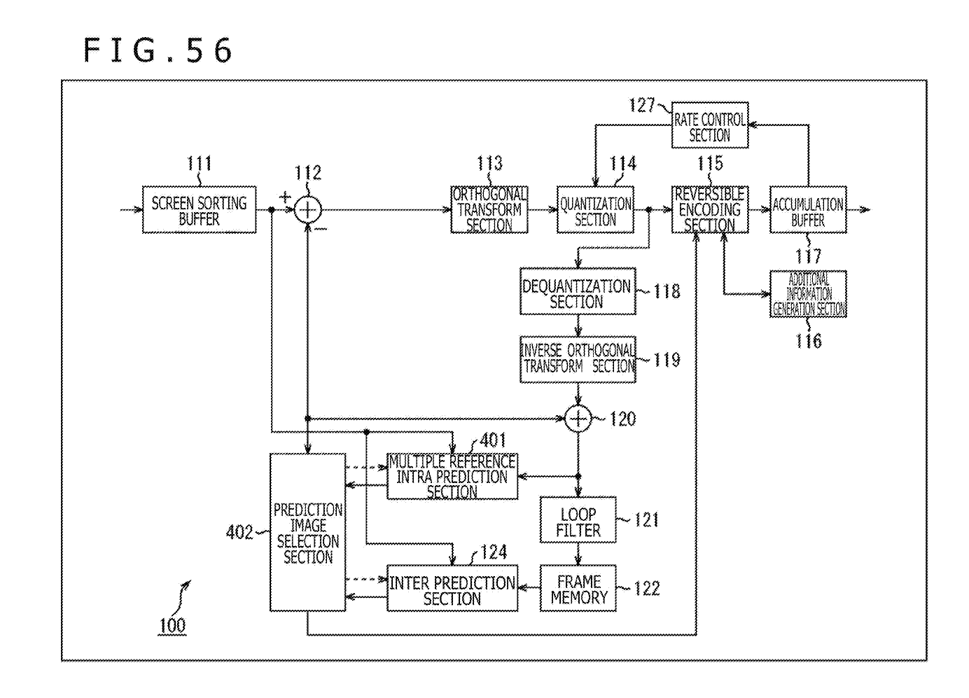

An example of a main configuration of the image encoding apparatus 100 in this case is depicted in FIG. 56. It is to be noted that, in FIG. 56, main processing sections, flows of data and so forth are depicted, and elements depicted in FIG. 56 are not all elements. In other words, a processing section that is not indicated as a block in FIG. 56 may exist in the image encoding apparatus 100, or a process or a flow of data not depicted as an arrow mark or the like in FIG. 56 may exist.

As depicted in FIG. 56, the image encoding apparatus 100 has a configuration basically similar to that of the case of FIG. 14. However, the image encoding apparatus 100 includes a multiple reference intra prediction section 401 in place of the intra prediction section 123 and the inter-destination intra prediction section 125 and includes a prediction image selection section 402 in place of the prediction image selection section 126.

The multiple reference intra prediction section 401 performs intra prediction for a CU of a processing target similarly as in the case of the intra prediction section 123. However, the multiple reference intra prediction section 401 generates each pixel of a prediction image using a plurality of reference pixels corresponding to a single intra prediction mode. Thereupon, the multiple reference intra prediction section 401 may generate each pixel of a prediction image using one of the plurality of reference pixels selected in response to the position of the pixel or may be generated by predetermined arithmetic operation using a plurality of reference pixels (for example, by performing weighted arithmetic operation according to the position of the pixel). In the following description, intra prediction of such a method as just described is referred to also as multiple reference intra prediction.

Although the prediction image selection section 402 performs processing basically similar to that of the prediction image selection section 126, it controls the multiple reference intra prediction section 401 and the inter prediction section 124.

<Plural Reference Intra Prediction Section>

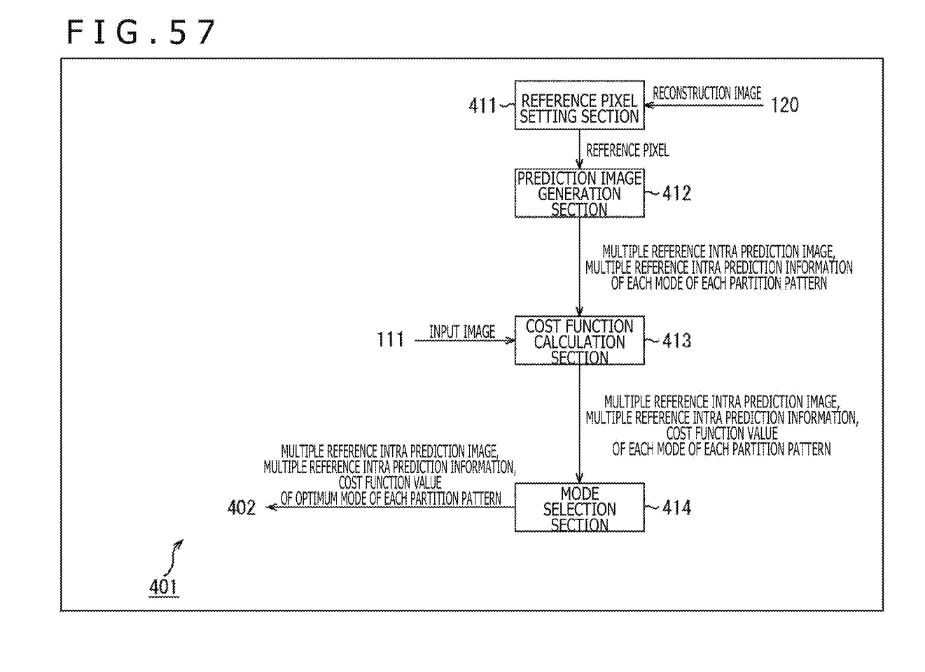

FIG. 57 is a block diagram depicting an example of a main configuration of the multiple reference intra prediction section 401. As depicted in FIG. 57, the multiple reference intra prediction section 401 includes a reference pixel setting section 411, a prediction image generation section 412, a cost function calculation section 413 and a mode selection section 414.

The reference pixel setting section 411 performs a process relating to setting of a reference pixel. For example, the reference pixel setting section 411 acquires a reconstruction image from the arithmetic operation section 120 and sets a reference pixel in such a manner as described above, for example, in (A) (including (A-1), (A-1-1) to (A-1-6), (A-2), (A-2-1) and (A-2-2)) of the first embodiment using the reconstruction image. It is to be noted that the reference pixel setting section 411 sets a reference pixel such that a plurality of reference pixels can be referred to in each prediction mode from each pixel of a processing target block. The reference pixel setting section 411 supplies the set reference pixel to the prediction image generation section 412.

The prediction image generation section 412 refers to the reference pixel set by the reference pixel setting section 411 to generate a prediction image. Thereupon, as described above, the prediction image generation section 412 refers to a plurality of reference pixels for each pixel to generate a prediction image (referred to also as multiple reference intra prediction image). Further, the prediction image generation section 412 generates multiple reference intra prediction information that is information relating to multiple reference intra prediction. Such multiple reference intra prediction image and multiple reference intra prediction information are generated for each mode for each partition pattern by the prediction image generation section 412. The prediction image generation section 412 supplies the multiple reference intra prediction images and the generated multiple reference intra prediction information for each mode for each partition pattern to the cost function calculation section 413.

The cost function calculation section 413 determines a cost function value (for example, an RD cost) for each mode for each partition pattern using the multiple reference intra prediction images and the input image supplied from the screen sorting buffer 111. The cost function calculation section 413 supplies the multiple reference intra prediction image, multiple reference intra prediction information and cost function value for each mode for each partition pattern to the mode selection section 414.

The mode selection section 414 compares the cost function values supplied thereto to select an optimum mode. The mode selection section 414 supplies the multiple reference intra prediction image, multiple reference intra prediction information and cost function value of the optimum mode for each partition pattern to the prediction image selection section 402.

<Prediction Image Selection Section>

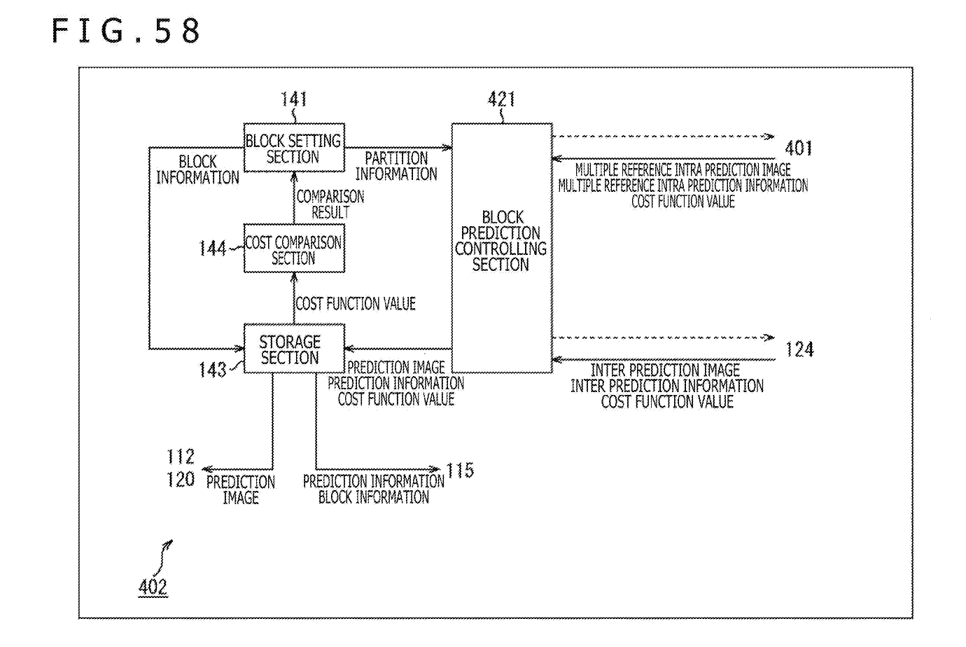

FIG. 58 is a block diagram depicting an example of a main configuration of the prediction image selection section 402. As depicted in FIG. 58, the prediction image selection section 402 has a configuration similar to that of the prediction image selection section 126. However, the prediction image selection section 402 includes a block prediction controlling section 421 in place of the block prediction controlling section 142.

Although the block prediction controlling section 421 performs a process basically similar to that of the block prediction controlling section 142, it controls the multiple reference intra prediction section 401 and the inter prediction section 124. In particular, the block prediction controlling section 421 controls the multiple reference intra prediction section 401 and the inter prediction section 124 on the basis of partition information acquired from the block setting section 141 to execute a prediction process for each block set by the block setting section 141.

The block prediction controlling section 421 acquires the multiple reference intra prediction image, multiple reference intra prediction information and cost function value of the optimum mode for each partition pattern from the multiple reference intra prediction section 401. Further, the block prediction controlling section 421 acquires the inter prediction image, inter prediction information and cost function value of the optimum mode for each partition pattern from the inter prediction section 124.

The block prediction controlling section 421 compares the cost function values with each other to select whether the optimum prediction method is multiple reference intra prediction or inter prediction and further selects an optimum partition pattern. After an optimum prediction method and an optimum partition pattern are selected, the block prediction controlling section 421 sets a prediction image, prediction information and a cost function value of the optimum prediction method and the optimum mode of the partition pattern. In particular, the selected prediction method and partition pattern information are set as information of an optimum prediction method and an optimum mode of the partition pattern. The block prediction controlling section 421 supplies the prediction image, prediction information and cost function value of the set optimum prediction method and set optimum mode of the partition pattern to the storage section 143 to store them.

As described above, also in the present embodiment, since the image encoding apparatus 100 can set a reference pixel to a position to which a reference pixel is not set in an intra prediction process of conventional AVC or HEVC, reduction of the prediction accuracy of intra prediction can be suppressed. Further, since respective pixels of a prediction image are set utilizing a plurality of reference pixels, reduction of the prediction accuracy of intra prediction can be suppressed. Consequently, reduction of the encoding efficiency can be suppressed. In other words, it is possible to suppress increase of the control amount or suppress reduction of the picture quality.

It is to be noted that, also in this case, by transmitting such various kinds of information as additional information as described hereinabove in connection with the first embodiment or the second embodiment to the decoding side, the decoding side can correctly decode encoded data generated by the image encoding apparatus 100.

<Flow of Prediction Process>

Also in this case, the encoding process is executed in such a flow as described hereinabove with reference to the flow chart of FIG. 21 similarly as in the case of the second embodiment.

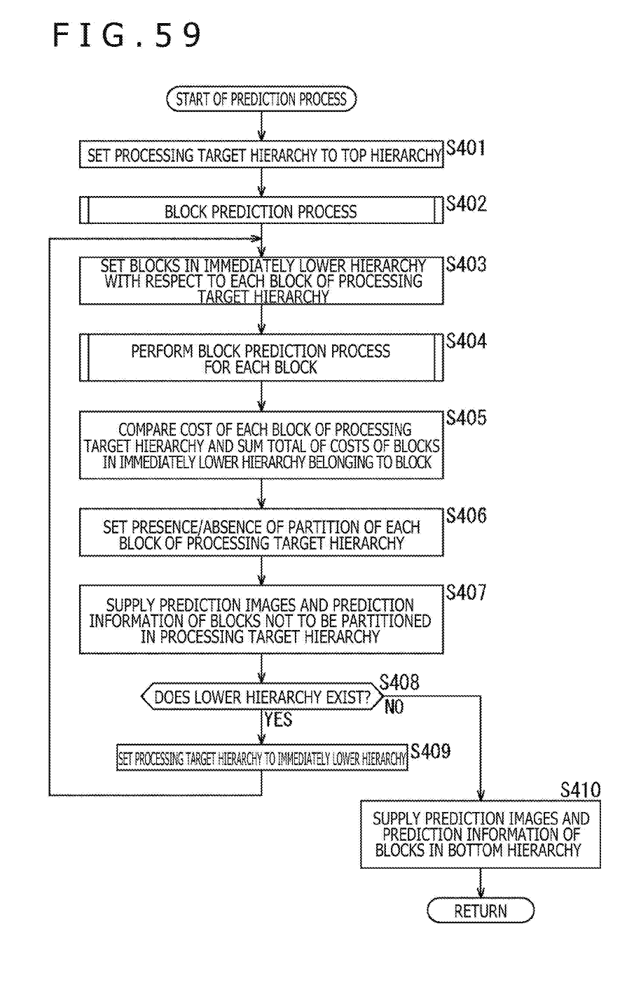

An example of a flow of the prediction process executed at step S102 of FIG. 21 in this case is described with reference to a flow chart of FIG. 59.

After the prediction process is started, the block setting section 141 of the prediction image selection section 126 sets the processing target hierarchy to the uppermost hierarchy (namely, an LCU) at step S401.

At step S402, the block prediction controlling section 421 controls the multiple reference intra prediction section 401 and the inter prediction section 124 to perform a block prediction process for a block of the processing target hierarchy (namely, for an LCU).

At step S403, the block setting section 141 sets a block in the immediately lower hierarchy with respect to each block of the processing target hierarchy.

At step S404, the block prediction controlling section 421 controls the multiple reference intra prediction section 401 and the inter prediction section 124 to perform a block prediction process for the respective blocks set at step S403.

At step S405, the cost comparison section 144 compares the cost of the block of the processing target hierarchy and the sum total of costs of blocks, which belong to the block, in the immediately lower hierarchy with each other. The cost comparison section 144 performs such comparison for each block of the processing target hierarchy.

Processes at steps S406 to S410 are executed similarly to the processes at steps S136 to S140 of FIG. 22, respectively.

<Flow of Block Prediction Process>

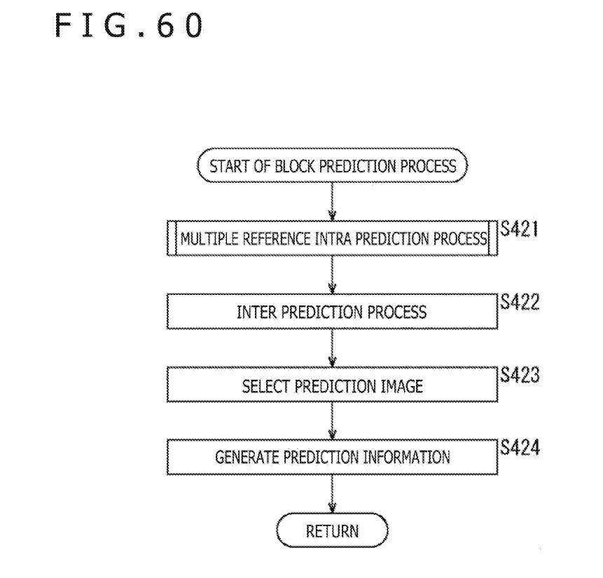

Now, an example of a flow of the block prediction process executed at steps S402 and S404 of FIG. 59 is described with reference to a flow chart of FIG. 60. It is to be noted that, where the block prediction process is executed at step S404, this block prediction process is executed for each block in the immediately lower hierarchy with respect to the processing target hierarchy. In particular, where a plurality of blocks exist in the immediately lower hierarchy with respect to the processing target hierarchy, the block prediction process is executed by the plural number of times.

After the block prediction process is started, at step S421, the multiple reference intra prediction section 401 performs a multiple reference intra prediction process for a processing target block.

At step S422, the inter prediction section 124 performs an inter prediction process for the processing target block.

At step S423, the block prediction controlling section 421 compares the cost function values obtained by the respective processes at steps S421 and S422 and selects a prediction image in response to a result of the comparison. Then, at step S424, the block prediction controlling section 421 generates prediction information corresponding to the prediction image selected at step S423. In particular, the block prediction controlling section 421 sets, through the processes described, information (prediction image, prediction information, cost function value and so forth) of the optimum prediction mode of the optimum partition pattern of the optimum prediction method.

After the process at step S424 ends, the block prediction process ends, and the processing returns to FIG. 59.

<Flow of Multiple Reference Intra Prediction Process>

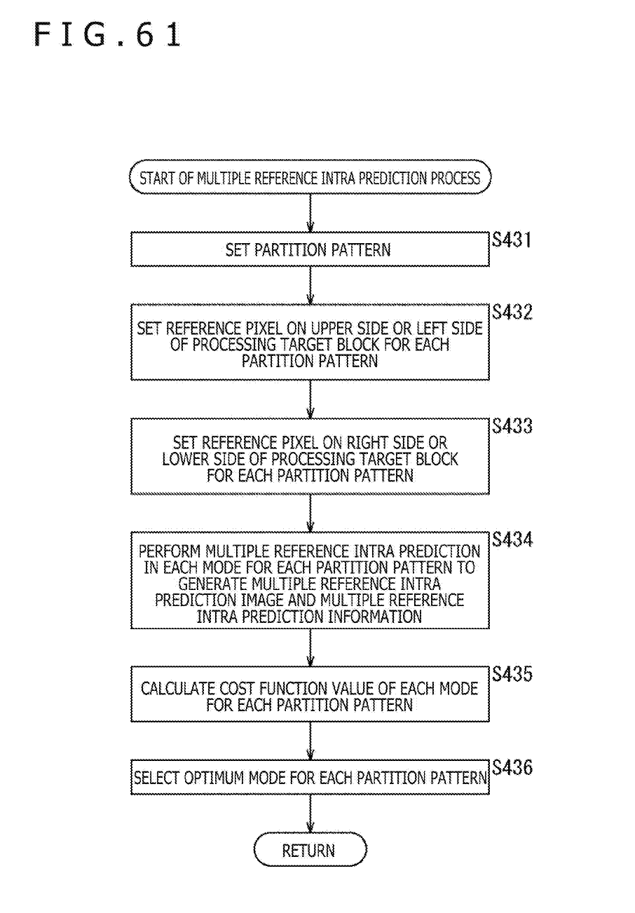

Now, an example of a flow of the multiple reference intra prediction process executed at step S421 of FIG. 60 is described with reference to a flow chart of FIG. 61.

After the multiple reference intra prediction process is started, the block prediction controlling section 421 sets a partition pattern for a processing target CU at step S431.

At step S432, the reference pixel setting section 411 sets a reference pixel on the upper side or the left side of the process target block for each partition pattern. Such reference pixels are set, for example, using pixel values of a reconstruction image of a block processed already.

At step S433, the reference pixel setting section 411 sets a reference pixel on the right side or the lower side of the processing target block. Such reference pixels may be, for example, set using pixel values of a reconstruction image of an already processed block of a different picture (past frame, different layer, different view, different component or the like) or may be set using an interpolation process (duplication, weighted arithmetic operation or the like).

At step S434, the prediction image generation section 412 performs multiple reference intra prediction in each mode for each partition pattern using reference pixels set in the processes at steps S432 and S433 to generate a multiple reference intra prediction image and multiple reference intra prediction information in each mode for each partition pattern.

At step S435, the cost function calculation section 413 determines a cost function value for each mode for each partition pattern using the multiple reference intra prediction images generated at step S434.

At step S436, the mode selection section 414 selects an optimum mode for each partition pattern on the basis of the cost function values calculated at step S435.

When the process at step S436 ends, the processing returns to FIG. 60.

By executing the respective processes in such a manner as described above, the image encoding apparatus 100 can implement suppression of reduction of the encoding efficiency.

### 7. Seventh Embodiment

<Image Decoding Apparatus>

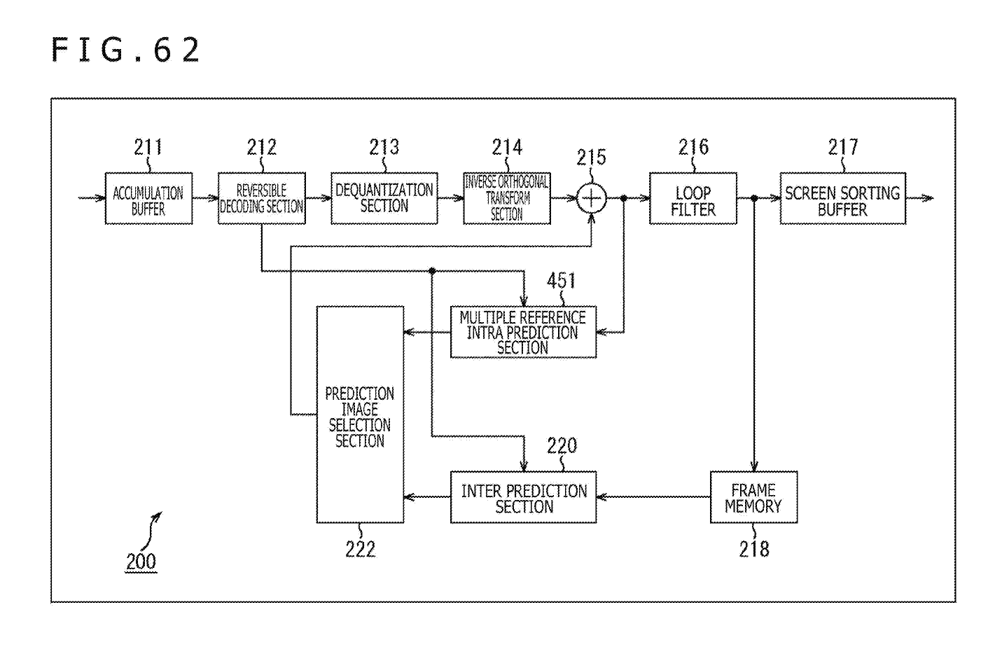

FIG. 62 is a block diagram depicting an example of a main configuration of the image decoding apparatus 200 in this case. The image decoding apparatus 200 depicted in FIG. 62 is an image decoding apparatus corresponding to the image encoding apparatus 100 of FIG. 56 and decodes encoded data generated by the image encoding apparatus 100 by a decoding method corresponding to the encoding method. It is to be noted that, in FIG. 62, main processing sections, flows of data and so forth are depicted, and elements depicted in FIG. 62 are not all elements. In other words, a processing section that is not indicated as a block in FIG. 62 may exist in the image decoding apparatus 200, or a process or a flow of data not depicted as an arrow mark or the like in FIG. 62 may exist.

As depicted in FIG. 62, the image decoding apparatus 200 also in this case has a configuration basically similar to that of the case of FIG. 42. However, the image decoding apparatus 200 includes a multiple reference intra prediction section 451 in place of the intra prediction section 219 and the inter-destination intra prediction section 221.

The multiple reference intra prediction section 451 performs multiple reference intra prediction for a CU of a processing target similarly to the multiple reference intra prediction section 401 on the encoding side. In particular, the multiple reference intra prediction section 451 generates each pixel of a prediction image using a plurality of reference pixels corresponding to a single intra prediction mode. Thereupon, the multiple reference intra prediction section 451 may generate each pixel of a prediction image using one of the plurality of reference pixels selected in response to the position of the pixel or may generate each pixel of a prediction image by performing weighted arithmetic operation in response to the position of the pixel for a plurality of reference pixels.

It is to be noted that the multiple reference intra prediction section 451 performs multiple reference intra prediction for a block (CU), for which multiple reference intra prediction has been performed on the encoding side, on the basis of a configuration of the encoded data, additional information and so forth.

<Multiple Reference Intra Prediction Section>

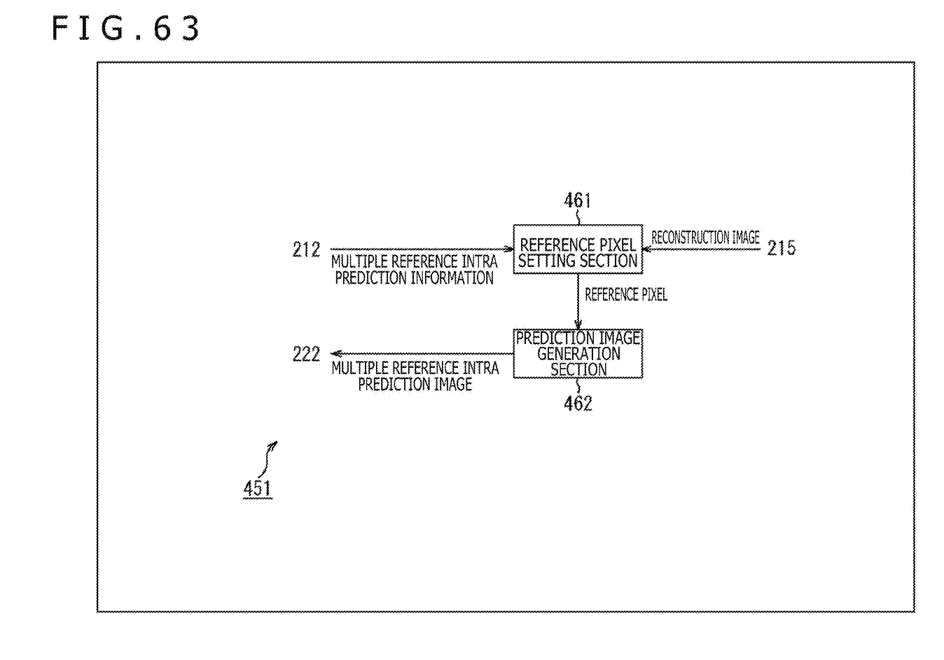

FIG. 63 is a block diagram depicting an example of a main configuration of the multiple reference intra prediction section 451. As depicted in FIG. 63, the multiple reference intra prediction section 451 includes a reference pixel setting section 461 and a prediction image generation section 462.

The reference pixel setting section 461 performs a process relating to setting of a reference pixel. For example, the reference pixel setting section 461 sets a reference pixel of a prediction mode designated by multiple reference intra prediction information supplied from the reversible decoding section 212 using the reconstruction image acquired from the arithmetic operation section 215. Thereupon, the reference pixel setting section 461 sets each reference pixel to such a position that a plurality of reference pixels can be referred to from each pixel of the processing target block. The reference pixel setting section 461 supplies the set reference pixel to the prediction image generation section 462.

The prediction image generation section 462 refers to the reference pixel set by the reference pixel setting section 461 to generate a multiple reference intra prediction image. Thereupon, as described above, the prediction image generation section 462 refers to a plurality of reference pixels for each pixel to generate a multiple reference intra prediction image. The prediction image generation section 462 supplies the generated multiple reference intra prediction image to the prediction image selection section 222.

As described above, alto in this case, since the image decoding apparatus 200 performs a prediction process by a method similar to the method adopted in the image encoding apparatus 100, it can correctly decode a bit stream encoded by the image encoding apparatus 100. Accordingly, the image decoding apparatus 200 can implement suppression of reduction of the encoding efficiency.

<Flow of Prediction Process>

Also in this case, the decoding process is executed in such a flow as described above with reference to the flow chart of FIG. 44 similarly as in the case of the third embodiment.

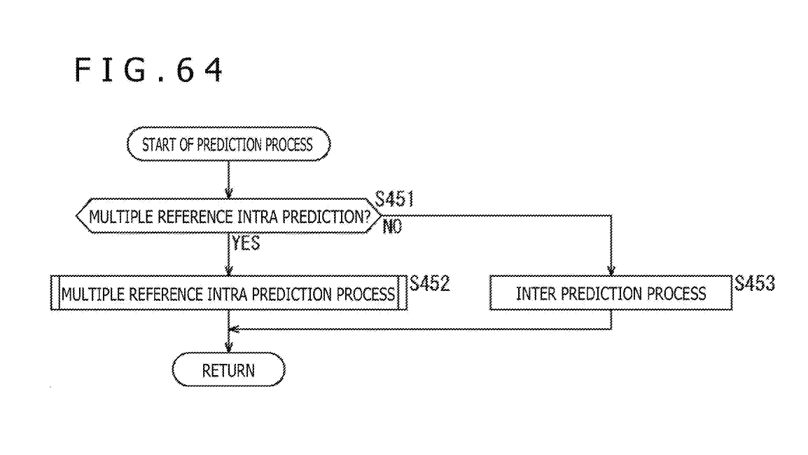

Now, an example of a flow of the prediction process performed at step S206 of FIG. 44 is described with reference to a flow chart of FIG. 64.

After the prediction process is started, the reversible decoding section 212 decides, at step S451, whether or not the prediction method adopted by the image encoding apparatus 100 for a block (CU) of the processing target is multiple reference intra prediction on the basis of additional information acquired from encoded data. If the multiple reference intra prediction is adopted by the image encoding apparatus 100, then the processing advances to step S452.

At step S452, the multiple reference intra prediction section 451 performs a multiple reference intra prediction process to generate a prediction image of the block of the processing target. After the prediction image is generated, the prediction process ends, and the processing returns to FIG. 44.

On the other hand, if it is decided at step S451 that multiple reference intra prediction is not adopted, then the processing advances to step S453. At step S453, the inter prediction section 220 performs inter prediction to generate a prediction image of the block of the processing target. After the prediction image is generated, the prediction process ends, and the processing returns to FIG. 44.

<Flow of Multiple Reference Intra Prediction Process>

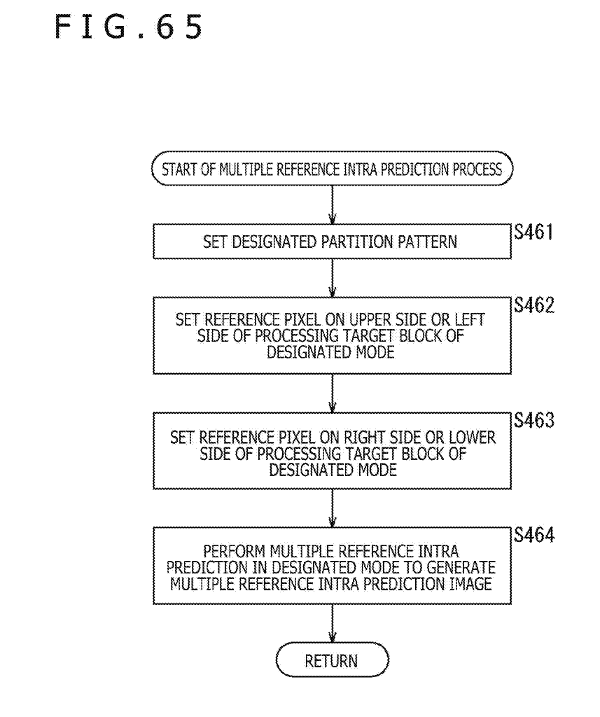

Now, an example of a flow of the multiple reference intra prediction process executed at step S452 of FIG. 64 is described with reference to a flow chart of FIG. 65.

After the multiple reference intra prediction process is started, the reference pixel setting section 461 sets, at step S461, a partition pattern designated by multiple reference intra prediction information transmitted from the encoding side.

At step S462, the reference pixel setting section 461 sets a reference pixel on the upper side or the left side of the processing target block (CU) of the prediction mode designated by the multiple reference intra prediction information. Such reference pixels are, for example, set using prediction values of a reconstruction image of a block that is processed already.

At step S463, the reference pixel setting section 461 sets a reference pixel on the right side or the lower side of the processing target block (CU) of the prediction mode designated by the multiple reference intra prediction information. Such reference pixels are set by a method similar to that on the encoding side. For example, such reference pixels are set using pixel values of a reconstruction image of an already processed block of a different picture (past frame, different layer, different view, different component or the like) or is set using an interpolation process (duplication, weighted arithmetic operation or the like).

At step S464, the prediction image generation section 462 uses reference pixels set by the processes at steps S462 and S463 to perform multiple reference intra prediction in the prediction mode designated by the multiple reference intra prediction information to generate a multiple reference intra prediction image of the prediction mode.

When the process at step S464 ends, the multiple reference intra prediction process ends, and the processing returns to FIG. 64.

By executing the respective processes in such a manner as described above, the image decoding apparatus 200 can implement suppression of reduction of the encoding efficiency.

While the foregoing description is directed to an example in which the present technology is applied when image data are encoded by the HEVC method or when encoded data of the image data are transmitted and decoded or in a like case, the present technology can be applied to any encoding method if the encoding method is an image encoding method that involves a prediction process.

Further, the present technology can be applied to an image processing apparatus that is used to compress image information by orthogonal transform such as discrete cosine transform and motion compensation like MPEG or H.26x and transmit a bit stream of the image information through a network medium such as a satellite broadcast, a cable television, the Internet or a portable telephone set. Further, the present technology can be applied to an image processing apparatus that is used to process image information on a storage medium such as an optical or magnetic disk and a flash memory.

### 8. Eighth Embodiment

<Application to Multi-View Image Encoding and Decoding System>

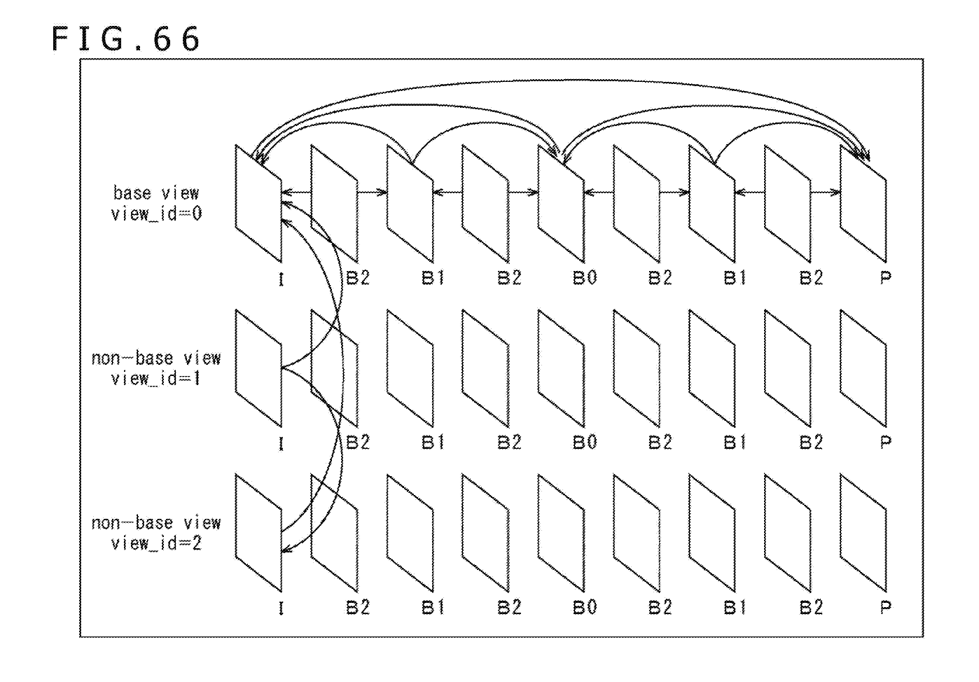

The series of processes described above can be applied to a multi-view image encoding and decoding system. FIG. 66 depicts an example of a multi-view image encoding method.

As depicted in FIG. 66, a multi-view image includes images of a plurality of points of view (views (view)). The plurality of views of the multi-view image include a base view with which encoding and decoding are performed using only an image of the own view without utilizing information of any other view and a non-base view with which encoding and decoding are performed utilizing information of a different view. The encoding and decoding of a non-base view may be performed utilizing information of a base view or utilizing information of some other non-base view.

When a multi-view image as in the example of FIG. 66 is to be encoded and decoded, the multi-view image is encoded for each point of view. Then, when encoded data obtained in this manner is to be decoded, the encoded data of the points of view are decoded individually (namely for each point of view). To such encoding and decoding of each point of view, any of the methods described in the foregoing description of the embodiments may be applied. This makes it possible to suppress reduction of the encoding efficiency. In short, reduction of the encoding efficiency can be suppressed similarly also in the case of a multi-view image.

<Multi-View Image Encoding and Decoding System>

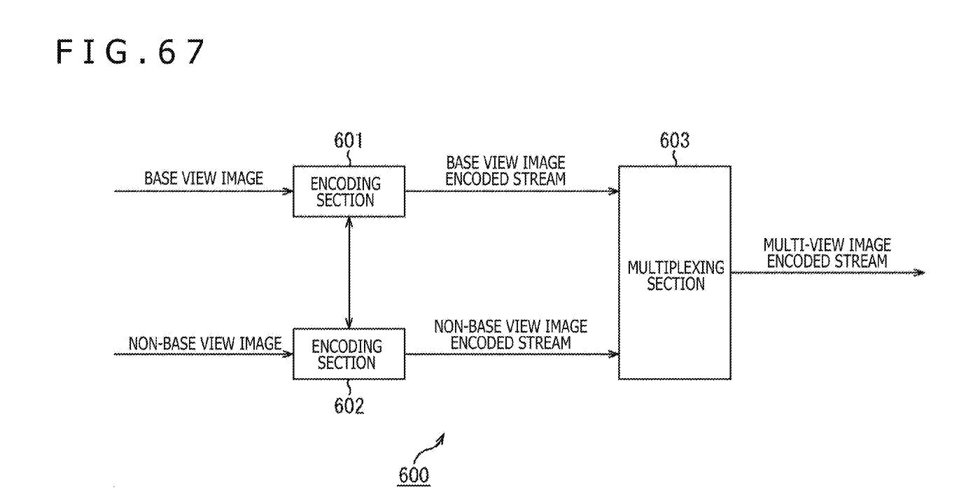

FIG. 67 is a view depicting a multi-view image encoding apparatus of a multi-view image encoding and decoding system that performs the above-described multi-view image encoding and decoding. As depicted in FIG. 67, the multi-view image encoding apparatus 600 includes an encoding section 601, another encoding section 602 and a multiplexing section 603.

The encoding section 601 encodes a base view image to generate a base view image encoded stream. The encoding section 602 encodes a non-base view image to generate a non-base view image encoded stream. The multiplexing section 603 multiplexes the base view image encoded stream generated by the encoding section 601 and the non-base view image encoded stream generated by the encoding section 602 to generate a multi-view image encoded stream.

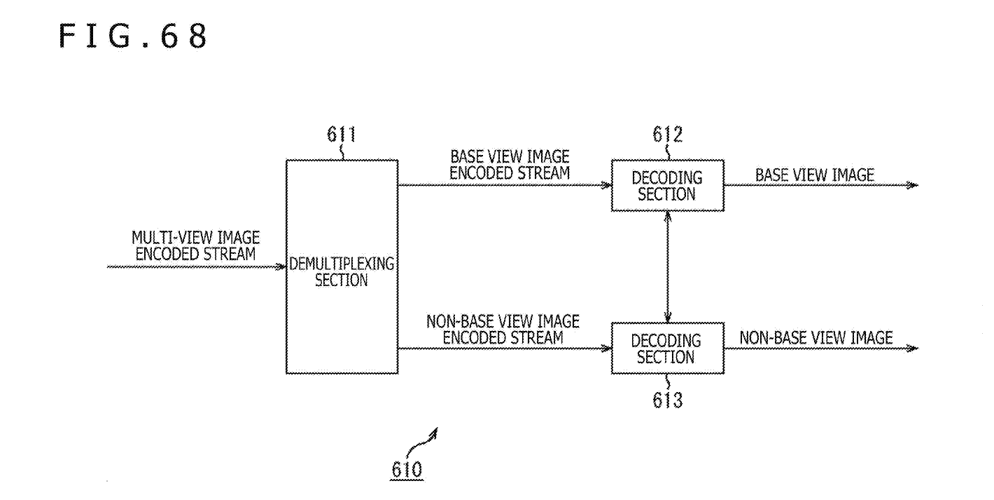

FIG. 68 is a view depicting a multi-view image decoding apparatus that performs multi-view image decoding described above. As depicted in FIG. 68, the multi-view image decoding apparatus 610 includes a demultiplexing section 611, a decoding section 612 and another decoding section 613.

The demultiplexing section 611 demultiplexes a multi-view image encoded stream, in which a base view image encoded stream and a non-base view image encoded stream are multiplexed, to extract the base view image encoded stream and the non-base view image encoded stream. The decoding section 612 decodes the base view image encoded stream extracted by the demultiplexing section 611 to obtain a base view image. The decoding section 613 decodes the non-base view image encoded stream extracted by the demultiplexing section 611 to obtain a no-base view image.

For example, in such a multi-view image encoding and decoding system as described above, the image encoding apparatus 100 described hereinabove in connection with the foregoing embodiments may be adopted as the encoding section 601 and the encoding section 602 of the multi-view image encoding apparatus 600. This makes it possible to apply the methods described hereinabove in connection with the foregoing embodiments also to encoding of a multi-view image. In other words, reduction of the encoding efficiency can be suppressed. Further, for example, the image decoding apparatus 200 described hereinabove in connection with the foregoing embodiments may be applied as the decoding section 612 and the decoding section 613 of the multi-view image decoding apparatus 610. This makes it possible to apply the methods described hereinabove in connection with the foregoing embodiment also to decoding of encoded data of a multi-view image. In other words, reduction of the encoding efficiency can be suppressed.

<Application to Hierarchical Image Encoding and Decoding System>

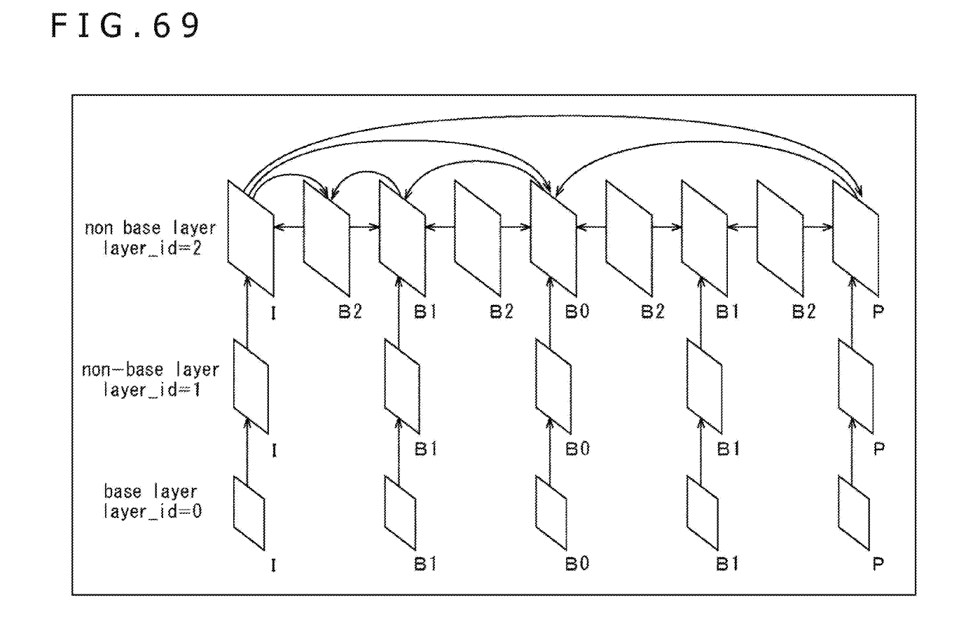

Further, the series of processes described above can be applied to a hierarchical image encoding (scalable encoding) and decoding system. FIG. 69 depicts an example of a hierarchical image encoding method.

Hierarchical image encoding (scalable encoding) converts (hierarchizes) an image into a plurality of layers such that the image data have a scalability (scalability) function in regard to a predetermined parameter to encode the image for each layer. Hierarchical image decoding is, the hierarchical image decoding (scalable decoding) is, decoding corresponding to the hierarchical image encoding.

As depicted in FIG. 69, in hierarchization of an image, one image is partitioned into a plurality of images (layers) with reference to a predetermined parameter having a scalability function. In particular, a hierarchized image (hierarchical image) includes images of a plurality of hierarchies (layers) that are different from each other in value of the predetermined parameter. The plurality of layers of the hierarchical image is configured from a base layer whose encoding and decoding are performed using only an image of the own layer without utilizing an image of a different layer and a non-base layer (referred to also as enhancement layer) whose encoding and decoding are performed utilizing an image of a different layer. The non-base layer may be configured so as to utilize an image of a base layer or so as to utilize an image of a different non-base layer.

Generally, a non-base layer is configured from an own image and data of a difference image from an image of a different layer (difference data) such that the redundancy is reduced. For example, where one image is converted into two hierarchies of a base layer and a non-base layer (referred to also as enhancement layer), an image of lower quality than that of an original image is obtained only from data of the base layer, but the original image (namely, an image of high quality) can be obtained by synthesizing data of the base layer and data of the non-base layer.

By hierarchizing an image in this manner, images of various qualities can be obtained readily in response to the situation. For example, for a terminal having a low processing capacity such as a portable telephone set, image compression information only of the base layer (base layer) is transmitted such that a moving image having a low spatial temporal resolution or having a poor picture quality is reproduced. However, for a terminal having a high processing capacity such as a television set or a personal computer, image compression information of the enhancement layer (enhancement layer) is transmitted in addition to the base layer (base layer) such that a moving image having a high spatial temporal resolution or a high picture quality is reproduced. In this manner, image compression information according to the capacity of a terminal or a network can be transmitted from a server without performing a transcode process.

Where such a hierarchical image as in the example of FIG. 69 is encoded and decoded, the hierarchical image is encoded for each layer. Then, where the encoded data obtained in this manner are to be decoded, the encoded data of the individual layers are decoded individually (namely, for the individual layers). To such encoding and decoding of each layer, the methods described in connection with the embodiments described above may be applied. This makes it possible to suppress reduction of the encoding efficiency. In short, also in the case of a hierarchical image, reduction of the encoding efficiency can be suppressed similarly.

<Scalable Parameter>

In such hierarchical image encoding and hierarchical image decoding (scalable encoding and scalable decoding) as described above, the parameter having a scalability (scalability) function is arbitrary. For example, the parameter may be a special resolution (spatial scalability). In the case of this spatial scalability (spatial scalability), the resolution of an image is different for each layer.

Further, as the parameter that has such scalability as described above, for example, a temporal resolution may be applied (temporal scalability). In the case of this temporal scalability (temporal scalability), the frame rate is different for each layer.

Further, as the parameter that has such a scalability property as described above, for example, a signal to noise ratio (SNB (Signal to Noise ratio)) may be applied (SNR scalability). In the case of this SNR scalability (SNR scalability), the SN ratio is different for each layer.

The parameter that has a scalability property may naturally be a parameter other than the examples described above. For example, a bit depth scalability (bit-depth scalability) is available in which the base layer (base layer) is configured from an 8-bit (bit) image and, by adding the enhancement layer (enhancement layer) to the base layer, a 10-bit (bit) image is obtained.

Further, a chroma scalability (chroma scalability) is available in which the base layer (base layer) is configured from a component image of a 4:2:0 format and, by adding the enhancement layer (enhancement layer) to the base layer, a component image of a 4:2:2 format is obtained.

<Hierarchical Image Encoding and Decoding System>

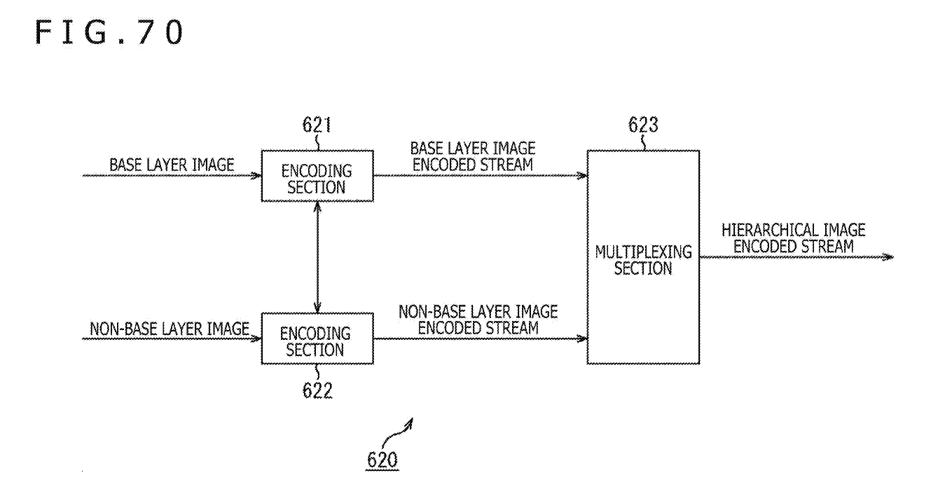

FIG. 70 is a view depicting a hierarchical image encoding apparatus of a hierarchical image encoding and decoding system that performs the hierarchical image encoding and decoding described above. As depicted in FIG. 70, the hierarchical image encoding apparatus 620 includes an encoding section 621, another encoding section 622 and a multiplexing section 623.

The encoding section 621 encodes a base layer image to generate a base layer image encoded stream. The encoding section 622 encodes a non-base layer image to generate a non-base layer image encoded stream. The multiplexing section 623 multiplexes the base layer image encoded stream generated by the encoding section 621 and the non-base layer image encoded stream generated by the encoding section 622 to generate a hierarchical image encoded stream.

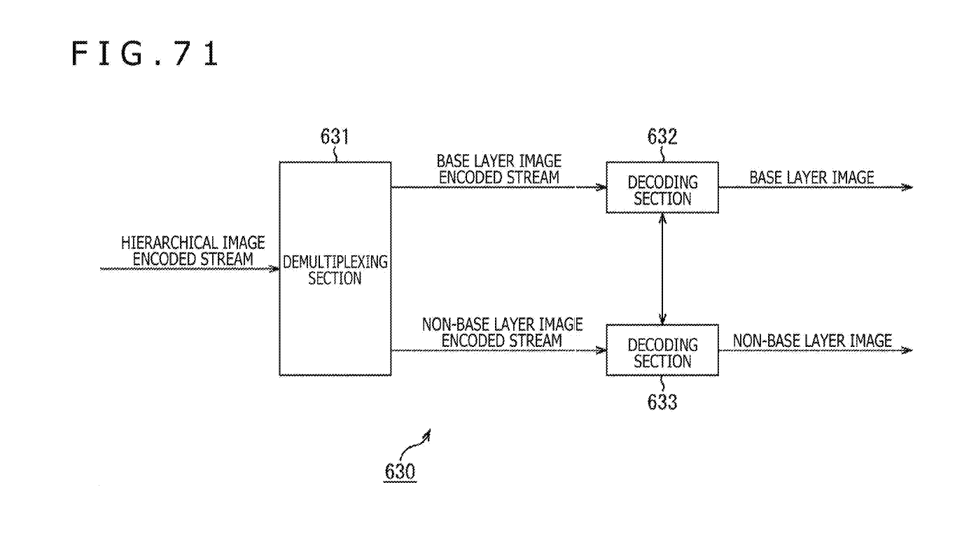

FIG. 71 is a view depicting a hierarchical image decoding apparatus that performs the hierarchical image decoding described above. As depicted in FIG. 71, the hierarchical image decoding apparatus 630 includes a demultiplexing section 631, a decoding section 632 and another decoding section 633.

The demultiplexing section 631 demultiplexes a hierarchical image encoded stream in which a base layer image encoded stream and a non-base layer image encoded stream are multiplexed to extract the base layer image encoded stream and the non-base layer image encoded stream. The decoding section 632 decodes the base layer image encoded stream extracted by the demultiplexing section 631 to obtain a base layer image. The decoding section 633 decodes the non-base layer image encoded stream extracted by the demultiplexing section 631 to obtain a non-base layer image.

For example, in such a hierarchical image encoding and decoding system as described above, the image encoding apparatus 100 described in the foregoing description of the embodiments may be applied as the encoding section 621 and the encoding section 622 of the hierarchical image encoding apparatus 620. This makes it possible to apply the methods described in the foregoing description of the embodiments also to encoding of a hierarchical image. In other words, reduction of the encoding efficiency can be suppressed. Further, for example, the image decoding apparatus 200 described in the foregoing description of the embodiments may be applied as the decoding section 632 and the decoding section 633 of the hierarchical image decoding apparatus 630. This makes it possible to apply the methods described in the foregoing description of the embodiments also to decoding of encoded data of a hierarchical image. In other words, reduction of the encoding efficiency can be suppressed.

<Computer>

While the series of processes described hereinabove may be executed by hardware, it may otherwise be executed by software. Where the series of processes is executed by software, a program that constructs the software is installed into a computer for exclusive use or the like. Here, the computer includes a computer incorporated in hardware for exclusive use and, for example, a personal computer for universal use that can execute various functions by installing various programs.

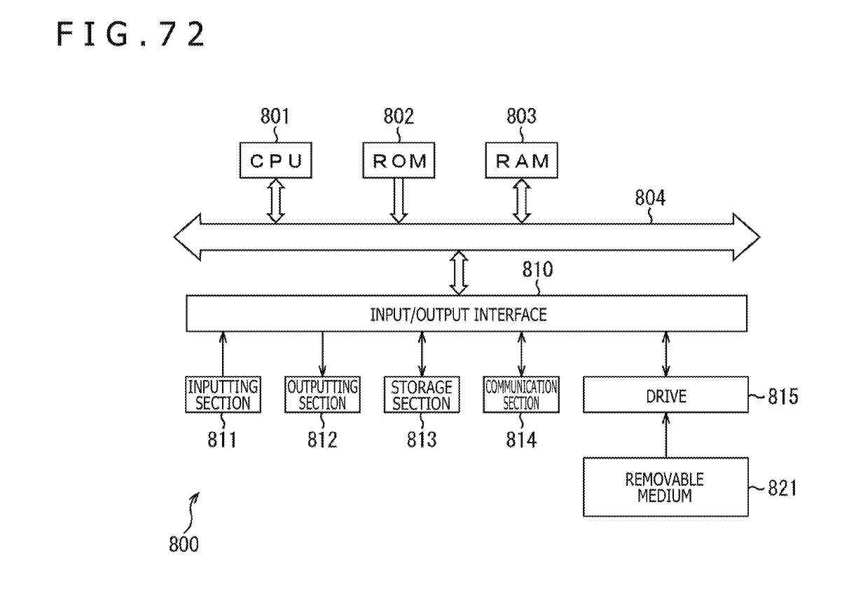

FIG. 72 is a block diagram depicting an example of a configuration of hardware of a computer that executes the series of processes described above in accordance with a program.

In the computer 800 depicted in FIG. 72, a CPU (Central Processing Unit) 801, a ROM (Read Only Memory) 802 and a RAM (Random Access Memory) 803 are connected to each other by a bus 804.

To the bus 804, also an input/output interface 810 is connected. To the input/output interface 810, an inputting section 811, an outputting section 812, a storage section 813, a communication section 814 and a drive 815 are connected.

The inputting section 811 is configured, for example, from a keyboard, a mouse, a microphone, a touch pane, an input terminal and so forth. The outputting section 812 is configured, for example, from a display section, a speaker, an output terminal and so forth. The storage section 813 is configured from a hard disk, a RAM disk, a nonvolatile memory and so forth. The communication section 814 is configured, for example, from a network interface. The drive 815 drives a removable medium 821 such as a magnetic disk, an optical disk, a magneto-optical disk or a semiconductor memory.

In the computer configured in such a manner as described above, the CPU 801 loads a program stored, for example, in the storage section 813 into the RAM 803 through the inputting/output interface 810 and the bus 804 and executes the program to perform the series of processes described hereinabove. Also data necessary for the CPU 801 to execute various processes and so forth are stored suitably into the RAM 803.

The program to be executed by the computer (CPU 801) can be recorded into and applied to the removable medium 821, for example, as a package medium. In this case, the program can be installed into the storage section 813 through the input/output interface 810 by loading the removable medium 821 into the drive 815.

Further, the program can be provided through a wired or wireless transmission medium such as a local area network, the Internet or a digital satellite broadcast. In this case, the program can be received by the communication section 814 and installed into the storage section 813.

Also it is possible to install the program into the ROM 802 or the storage section 813 in advance.

It is to be noted that the program to be executed by the computer may be a program in which processes are performed in a time series in the order as described in the present specification or may be a program in which processes are executed in parallel or at necessary timings such as timings at which the program is called or the like.

Further, in the present specification, the steps that describe the program to be recorded in a recording medium include not only processes executed in a time series in accordance with the descried order but also processes that are executed in parallel or individually without being necessarily processed in a time series.

Further, the term system in the present specification signifies an aggregation of a plurality of components (apparatus, modules (parts) and so forth) and is not limited to a system in which all components are provided in the same housing. Accordingly, both of a plurality of apparatus that are accommodated in different housings and connected to each other through a network and a single apparatus that includes a plurality of modules accommodated in one housing are systems.

Further, a component described as one apparatus (or processing section) in the foregoing may be partitioned and configured as a plurality of apparatus (or processing sections). Conversely, components described as a plurality of apparatus (or processing sections) in the foregoing description may be configured connectively as a single apparatus (or processing section). Further, a component other than the components described hereinabove may be added to the configuration of the various apparatus (or various processing sections). Furthermore, if a configuration or operation of the entire system is substantially same, then part of the component of a certain apparatus (or processing section) may be included in the configuration of a different apparatus (or a different processing section).

While the suitable embodiments of the present disclosure have been described in detail with reference to the accompanying drawings, the technical scope of the present disclosure is not limited to such examples. It is apparent that those having ordinary knowledge in the technical field of the present disclosure can conceive various alterations and modifications without departing from the spirit of the technical scope described in the claims, and it is recognized that also such alterations and modifications naturally belong to the technical scope of the present disclosure.

For example, the present technology can assume a configuration of cloud computing by which one function is shared by and processed through cooperation of a plurality of apparatus through a network.

Further, the respective steps described in connection with the flow charts described hereinabove not only can be executed by a single apparatus but also can be shared and executed by a plurality of apparatus.

Further, where a plurality of processes are included in one step, the plurality of processes included in the one step not only can be executed by a single apparatus but also can be shared and executed by a plurality of apparatus.

The image encoding apparatus 100 and the image decoding apparatus 200 according to the embodiments described hereinabove can be applied to various electronic apparatus such as, for example, transmitters and receivers in satellite broadcasting, wired broadcasting such as a cable TV, distribution on the Internet, distribution to terminals by cellular communication and so forth, recording apparatus for recording an image into a medium such as an optical disk, a magnetic disk and a flash memory, and reproduction apparatus for reproducing an image from such recording media. In the following, four applications are described.

### First Application Example: Television Receiver

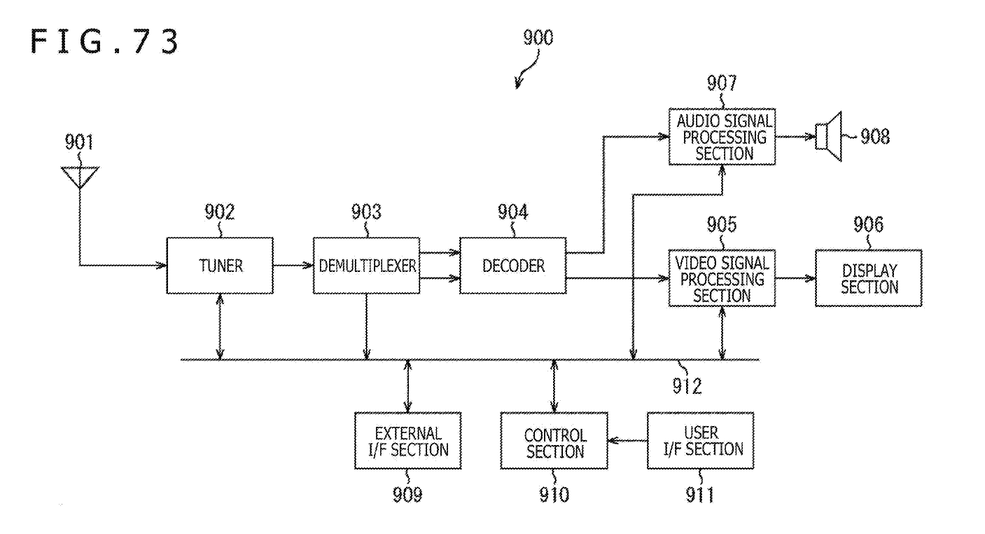

FIG. 73 depicts an example of a simple configuration of a television apparatus to which the embodiments described hereinabove are applied. The television apparatus 900 includes an antenna 901, a tuner 902, a demultiplexer 903, a decoder 904, a video signal processing section 905, a display section 906, an audio signal processing section 907, a speaker 908, an external interface (I/F) section 909, a control section 910, a user interface (I/F) section 911 and a bus 912.

The tuner 902 extracts a signal of a desired channel from broadcasting signals received through the antenna 901 and demodulates the extracted signal. Then, the tuner 902 outputs an encoded bit stream obtained by the demodulation to the demultiplexer 903. In particular, the tuner 902 has a role as a transmission section in the television apparatus 900 for receiving an encode bit stream in which an image is encoded.

The demultiplexer 903 demultiplexes a video stream and an audio stream of a program of a viewing target from the encoded bit stream and outputs the respective demultiplexed streams to the decoder 904. Further, the demultiplexer 903 extracts auxiliary data such as an EPG (Electronic Program Guide) from the encoded bit stream and supplies the extracted data to the control section 910. It is to be noted that the demultiplexer 903 may perform descrambling where the encoded bit stream is in a scrambled state.

The decoder 904 decodes a video stream and an audio stream inputted from the demultiplexer 903. Then, the decoder 904 outputs video data generated by the decoding process to the video signal processing section 905. Meanwhile, the decoder 904 outputs the audio data generated by the decoding process to the audio signal processing section 907.

The video signal processing section 905 reproduces the video data inputted from the decoder 904 and causes the display section 906 to display a video. Alternatively, the video signal processing section 905 may cause the display section 906 to display an application screen image supplied through a network. Further, the video signal processing section 905 may perform an additional process such as, for example, noise removal for the video data in response to a setting. Furthermore, the video signal processing section 905 may generate an image, for example, of a GUI (Graphical User Interface) of a menu, a button or a cursor and superimpose the generated image on an output image.

The display section 906 is driven by a driving signal supplied from the video signal processing section 905 and displays a video or an image on an image plane of a display device (for example, a liquid crystal display section, a plasma display section or an OELD (Organic ElectroLuminescence Display) (organic EL display) section or the like).

The audio signal processing section 907 performs a reproduction process such as D/A conversion and amplification for audio data inputted from the decoder 904 and causes the speaker 908 to output the audio. Further, the audio signal processing section 907 may perform an additional process such as noise removal for the audio data.

The external interface section 909 is an interface for connecting the television apparatus 900 and an external apparatus or a network to each other. For example, a video stream or an audio stream received through the external interface section 909 may be decoded by the decoder 904. In particular, also the external interface section 909 has a role as a transmission section in the television apparatus 900 for receiving an encoded stream in which an image is encoded.

The control section 910 includes a processor such as a CPU and a memory such as a RAM or a ROM. The memory stores a program to be executed by the CPU, program data, EPG data, data acquired through a network and so forth. The program stored in the memory is read into the CPU, for example, upon activation of the television apparatus 900 and executed by the CPU. The CPU controls, by executing the program, operation of the television apparatus 900, for example, in response to an operation signal inputted from the user interface section 911.

The user interface section 911 is connected to the control section 910. The user interface section 911 has, for example, a button and a switch for operating the television apparatus 900, a reception section of a remote control signal and so forth. The user interface section 911 detects an operation by a user through the components to generate an operation signal and outputs the generated operation signal to the control section 910.

The bus 912 connects the tuner 902, demultiplexer 903, decoder 904, video signal processing section 905, audio signal processing section 907, external interface section 909 and control section 910 to each other.

In the television apparatus 900 configured in such a manner as described above, the decoder 904 may have the functions of the image decoding apparatus 200 described hereinabove. In other words, the decoder 904 may decode encoded data by any of the methods described in the foregoing description of the embodiments. This makes it possible for the television apparatus 900 to suppress reduction of the encoding efficiency of an encoded bit stream received by the same.

Further, in the television apparatus 900 configured in such a manner as described above, the video signal processing section 905 may be configured such that it encodes image data supplied, for example, from the decoder 904 and outputs the obtained encoded data to the outside of the television apparatus 900 through the external interface section 909. Further, the video signal processing section 905 may have the functions of the image encoding apparatus 100 described hereinabove. In other words, the video signal processing section 905 may encode image data supplied thereto from the decoder 904 by any method described in the description of the embodiments. This makes it possible for the television apparatus 900 to suppress reduction of the encoding efficiency of encoded data to be outputted.

### Second Application Example: Portable Telephone Set

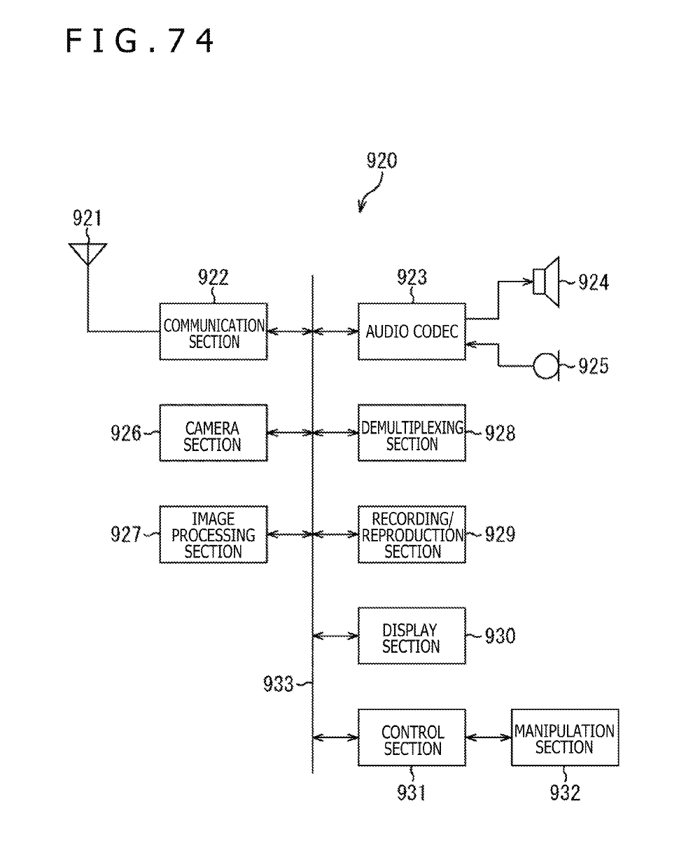

FIG. 74 depicts an example of a general configuration of a portable telephone set to which the embodiments described hereinabove are applied. The portable telephone set 920 includes an antenna 921, a communication section 922, an audio codec 923, a speaker 924, a microphone 925, a camera section 926, an image processing section 927, a demultiplexing section 928, a recording and reproduction section 929, a display section 930, a control section 931, an operation section 932 and a bus 933.

The antenna 921 is connected to the communication section 922. The speaker 924 and the microphone 925 are connected to the audio codec 923. The operation section 932 is connected to the control section 931. The bus 933 connects the communication section 922, audio codec 923, camera section 926, image processing section 927, demultiplexing section 928, recording and reproduction section 929, display section 930 and control section 931 to each other.

The portable telephone set 920 performs such operations as transmission and reception of a voice signal, transmission and reception of an electronic mail or image data, pickup of an image and recording of data in various operation modes including a voice communication mode, a data communication mode, an image pickup mode and a videophone mode.

In the voice communication mode, an analog voice signal generated by the microphone 925 is supplied to the audio codec 923. The audio codec 923 converts the analog voice signal into voice data and A/D converts and compresses the converted voice data. Then, the audio codec 923 outputs the voice data after compression to the communication section 922. The communication section 922 encodes and modulates the voice data to generate a transmission signal. Then, the communication section 922 transmits the generated transmission signal to a base station (not depicted) through the antenna 921. Further, the communication section 922 amplifies and frequency converts a radio signal received through the antenna 921 to acquire a reception signal. Then, the communication section 922 demodulates and decodes the reception signal to generate voice data and outputs the generated voice data to the audio codec 923. The audio codec 923 decompresses and D/A converts the voice data to generate an analog voice signal. Then, the audio codec 923 supplies the generated voice signal to the speaker 924 so as to output sound.

On the other hand, in the data communication mode, for example, the control section 931 generates character data to configure an electronic mail in response to an operation by the user through the operation section 932. Further, the control section 931 controls the display section 930 to display the characters. Further, the control section 931 generates electronic mail data in response to a transmission instruction from the user through the operation section 932 and outputs the generated electronic mail data to the communication section 922. The communication section 922 encodes and modulates the electronic mail data and generates a transmission signal. Then, the communication section 922 transmits the generated transmission signal to a base station (not depicted) through the antenna 921. Further, the communication section 922 amplifies and frequency converts a radio signal received through the antenna 921 to acquire a reception signal. Then, the communication section 922 demodulates and decodes the reception signal to restore the electronic mail data and outputs the restored electronic mail data to the control section 931. The control section 931 controls the display section 930 to display the substance of the electronic mail and supplies the electronic mail data to the recording and reproduction section 929 so as to be recorded into a recording medium of the recording and reproduction section 929.

The recording and reproduction section 929 has an arbitrary readable and writable storage medium. For example, the storage medium may be a built-in type storage medium such as a RAM or a flash memory or may be an externally mountable storage medium such as a hard disk, a magnetic disk, a magneto-optical disk, an optical disk, a USB (Universal Serial Bus) memory or a memory card.

Meanwhile, in the image pickup mode, for example, the camera section 926 picks up an image of an image pickup object to generate image data and outputs the generated image data to the image processing section 927. The image processing section 927 encodes the image data inputted from the camera section 926 and supplies an encoded stream to the recording and reproduction section 929 so as to be written into a storage medium of the recording and reproduction section 929.

Furthermore, in the image display mode, the recording and reproduction section 929 reads out an encoded stream recorded in a recording medium and outputs the encoded stream to the image processing section 927. The image processing section 927 decodes the encoded stream inputted from the recording and reproduction section 929 and supplies image data to the display section 930 such that an image of the image data is displayed on the display section 930.

On the other hand, in the videophone mode, for example, the demultiplexing section 928 multiplexes a video stream encoded by the image processing section 927 and an audio stream inputted from the audio codec 923 and outputs the multiplexed stream to the communication section 922. The communication section 922 encodes and modulates the stream to generate a transmission signal. Then, the communication section 922 transmits the generated transmission signal to a base station (not depicted) through the antenna 921. Further, the communication section 922 amplifies and frequency converts a radio signal received through the antenna 921 to acquire a reception signal. The transmission signal and the reception signal can include an encoded bit stream. Then, the communication section 922 demodulates and decodes the reception signal to restore the stream and outputs the restored stream to the demultiplexing section 928. The demultiplexing section 928 demultiplexes the video stream and the audio stream from the inputted stream, and supplies the video stream to the image processing section 927 and supplies the audio stream to the audio codec 923. The image processing section 927 decodes the video stream to generate video data. The video data are supplied to the display section 930, by which a series of images are displayed. The audio codec 923 decompresses and D/A converts the audio stream to generate an analog sound signal. Then, the audio codec 923 supplies the generated sound signal to the speaker 924 such that sound is outputted from the speaker 924.

In the portable telephone set 920 configured in such a manner as described above, for example, the image processing section 927 may have the functions of the image encoding apparatus 100 described hereinabove. In other words, the image processing section 927 may be configured so as to encode image data by any method described in the description of the embodiments. This makes it possible for the portable telephone set 920 to suppress reduction of the encoding efficiency.

Further, in the portable telephone set 920 configured in this manner, for example, the image processing section 927 may have the functions of the image decoding apparatus 200 described hereinabove. In other words, the image processing section 927 may be configured so as to decode encoded data by any method described in the description of the embodiments. This makes it possible for the portable telephone set 920 to suppress reduction of the encoding efficiency of encoded data.

### Third Application Example: Recording and Reproduction Apparatus

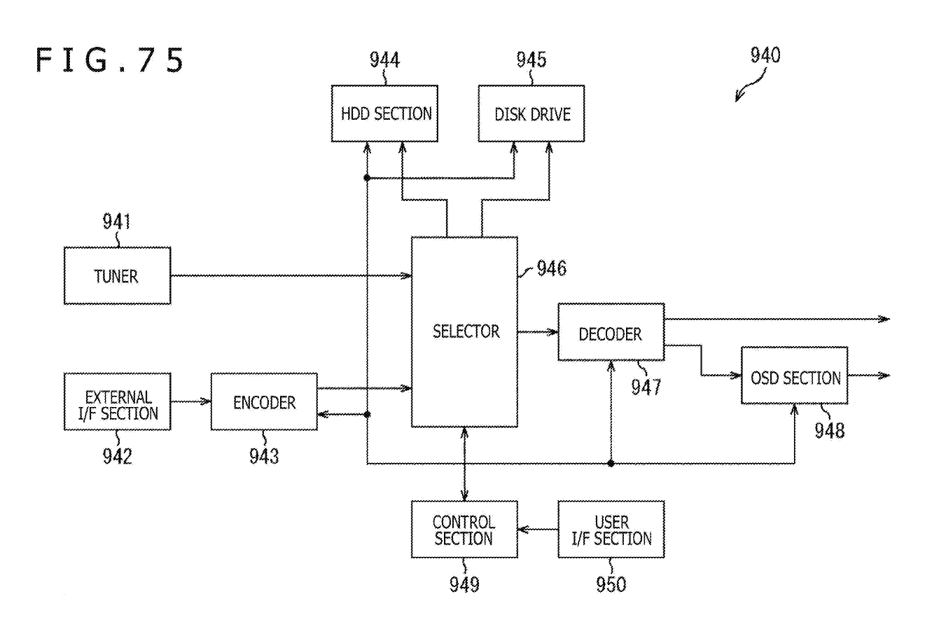

FIG. 75 depicts an example of a general configuration of a recording and reproduction apparatus to which the embodiments described hereinabove are applied. The recording and reproduction apparatus 940 encodes, for example, audio data and video data of a received broadcasting program and records the data into a recording medium. Further, the recording and reproduction apparatus 940 may encode audio data and video data acquired, for example, from a different apparatus and records the data into the recording medium. Further, the recording and reproduction apparatus 940 reproduces data recorded in the recording medium on a monitor and a speaker in response to an instruction of the user, for example. At this time, the recording and reproduction apparatus 940 decodes the audio data and the video data.

The recording and reproduction apparatus 940 includes a tuner 941, an external interface (I/F) section 942, an encoder 943, an HDD (Hard Disk Drive) 944, a disk drive 945, a selector 946, a decoder 947, an OSD (On-Screen Display) 948, a control section 949 and a user interface (I/F) section 950.

The tuner 941 extracts a signal of a desired channel from broadcasting signals received through an antenna (not depicted) and demodulates the extracted signal. Then, the tuner 941 outputs an encoded bit stream obtained by the demodulation to the selector 946. In other words, the tuner 941 has a role as a transmission section in the recording and reproduction apparatus 940.

The external interface section 942 is an interface for connecting the recording and reproduction apparatus 940 and an external apparatus or a network. The external interface section 942 may be, for example, an IEEE (Institute of Electrical and Electronic Engineers) 1394 interface, a network interface, a USB interface, a flash memory interface or the like. For example, video data and audio data received through the external interface section 942 are inputted to the encoder 943. In other words, the external interface section 942 has a role as a transmission section in the recording and reproduction apparatus 940.

The encoder 943 encodes, where video data and audio data inputted from the external interface section 942 are not in an encoded state, the video data and the audio data. Then, the encoder 943 outputs an encoded bit stream to the selector 946.

The HDD 944 records an encoded bit stream in which content data of videos and audios are compressed, various programs and other data into an internal hard disk. Further, the HDD 944 reads out, upon reproduction of a video and an audio, such data as described above from the hard disk.

The disk drive 945 performs recording and reading out of data into and from a recording medium mounted thereon. The recording medium to be mounted on the disk drive 945 may be, for example, a DVD (Digital Versatile Disc) disk (such as DVD-Video, DVD-RAM (DVD-Random Access Memory), DVD-R (DVD-Recordable), DVD-RW (DVD-Rewritable), DVD+R (DVD+Recordable), DVD+RW (DVD+Rewritable) and so forth), a Blu-ray (registered trademark) disk or the like.

The selector 946 selects, upon recording of a video and an audio, an encoded bit stream inputted from the tuner 941 or the encoder 943 and outputs the selected encoded bit stream to the HDD 944 or the disk drive 945. On the other hand, upon reproduction of a video and an audio, the selector 946 outputs an encoded bit stream inputted from the HDD 944 or the disk drive 945 to the decoder 947.

The decoder 947 decodes an encoded bit stream to generate video data and audio data. Then, the decoder 947 outputs the generated video data to the OSD 948. Meanwhile, the decoder 947 outputs the generated audio data to an external speaker.

The OSD 948 reproduces video data inputted from the decoder 947 to display a video. Further, the OSD 948 may superimpose an image of a GUI such as, for example, a menu, a button or a cursor on the displayed video.

The control section 949 includes a processor such as a CPU and a memory such as a RAM and a ROM. The memory stores a program to be executed by the CPU, program data and so forth. The program stored in the memory is read in and executed by the CPU, for example, upon activation of the recording and reproduction apparatus 940. The CPU controls, by execution of the program, operation of the recording and reproduction apparatus 940, for example, in response to an operation signal inputted from the user interface section 950.

The user interface section 950 is connected to the control section 949. The user interface section 950 includes, for example, a button and a switch for allowing the user to operate the recording and reproduction apparatus 940, a reception section of a remote control signal and so forth. The user interface section 950 detects an operation by the user through the components to generate an operation signal and outputs the generated operation signal to the control section 949.

In the recording and reproduction apparatus 940 configured in this manner, for example, the encoder 943 may have the functions of the image encoding apparatus 100 described hereinabove. In other words, the encoder 943 may be configured so as to encode image data by any method described in the embodiments. This makes it possible for the recording and reproduction apparatus 940 to suppress reduction of the encoding efficiency.

Further, in the recording and reproduction apparatus 940 configured in such a manner as described above, for example, the decoder 947 may have the functions of the image decoding apparatus 200 described hereinabove. In other words, the decoder 947 may be configured so as to decode encoded data by any method described in the description of the embodiments. This makes it possible for the recording and reproduction apparatus 940 to suppress reduction of the encoding efficiency of encoded data.

### Fourth Application Example: Image Pickup Apparatus

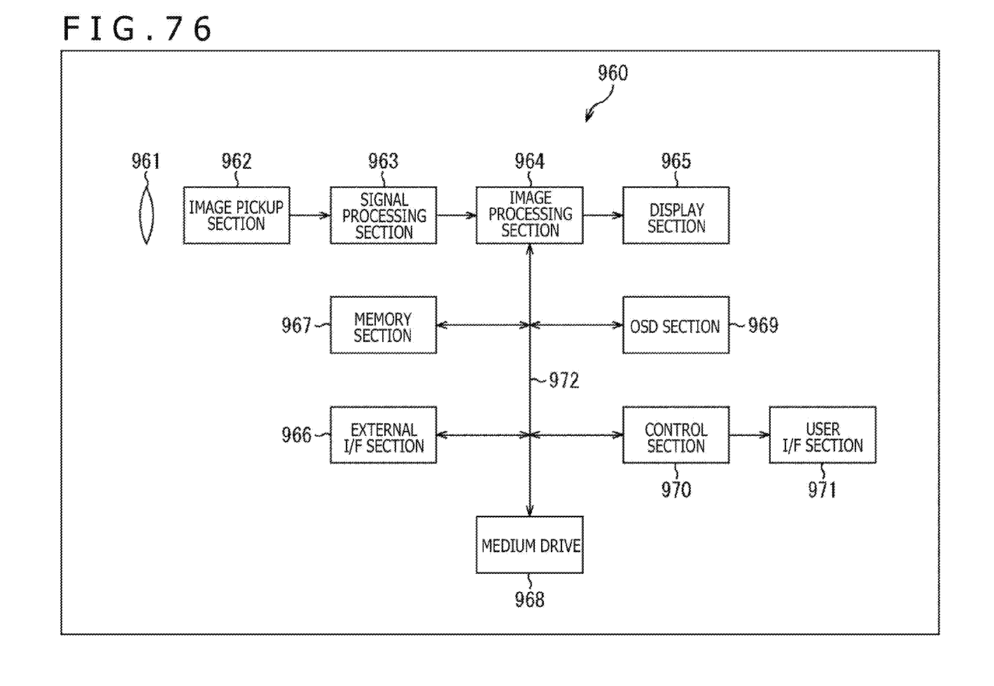

FIG. 76 depicts an example of a schematic configuration of an image pickup apparatus to which the embodiments described hereinabove are applied. The image pickup apparatus 960 images an image pickup object to generate an image and encodes and records the image data into a recording medium.

The image pickup apparatus 960 includes an optical block 961, an image pickup section 962, a signal processing section 963, an image processing section 964, a display section 965, an external interface (I/F) section 966, a memory section 967, a medium drive 968, an OSD 969, a control section 970, a user interface (I/F) section 971 and a bus 972.

The optical block 961 is connected to the image pickup section 962. The image pickup section 962 is connected to the signal processing section 963. The display section 965 is connected to the image processing section 964. The user interface section 971 is connected to the control section 970. The bus 972 connects the image processing section 964, external interface section 966, memory section 967, medium drive 968, OSD 969 and control section 970 to each other.

The optical block 961 includes a focus lens, a diaphragm mechanism and so forth. The optical block 961 forms an optical image of an image pickup object on an image pickup plane of the image pickup section 962. The image pickup section 962 includes an image sensor such as a CCD (Charge Coupled Device) image sensor or a CMOS (Complementary Metal Oxide Semiconductor) image sensor and converts an optical image formed on the image pickup plane into an image signal as an electric signal by photoelectric conversion. Then, the image pickup section 962 outputs the image signal to the signal processing section 963.

The signal processing section 963 performs various camera signal processes such as KNEE correction, gamma correction or color correction for the image signal inputted from the image pickup section 962. The signal processing section 963 outputs the image data after the camera signal processes to the image processing section 964.

The image processing section 964 encodes the image data inputted from the signal processing section 963 to generate encoded data. Then, the image processing section 964 outputs the generated encoded data to the external interface section 966 or the medium drive 968. Further, the image processing section 964 decodes encoded data inputted from the external interface section 966 or the medium drive 968 to generate image data. Then, the image processing section 964 outputs the generated image data to the display section 965. Further, the image processing section 964 may output the image data inputted from the signal processing section 963 to the display section 965 such that an image is displayed on the display section 965. Further, the image processing section 964 may superimpose displaying data acquired from the OSD 969 on an image to be outputted to the display section 965.

The OSD 969 generates an image of a GUI such as, for example, a menu, a button or a cursor and outputs the generated image to the image processing section 964.

The external interface section 966 is configured, for example, as a USB input/output terminal. The external interface section 966 connects, for example, upon printing of an image, the image pickup apparatus 960 and a printer to each other. Further, a drive is connected to the external interface section 966 as occasion demands. A removable medium such as, for example, a magnetic disk or an optical disk is loaded into the drive such that a program read out from the removable medium can be installed into the image pickup apparatus 960. Further, the external interface section 966 may be configured as a network interface connected to a network such as a LAN or the Internet. In other words, the external interface section 966 has a role as a transmission section of the image pickup apparatus 960.

The recording medium loaded into the medium drive 968 may be an arbitrary readable and writable removable medium such as, for example, a magnetic disk, a magneto-optical disk, an optical disk or a semiconductor memory. Further, a recording medium may be mounted fixedly in the medium drive 968 such that it configures a non-portable storage section, for example, like a built-in hard disk drive or an SSD (Solid State Drive).

The control section 970 includes a processor such as a CPU and a memory such as a RAM and a ROM. The memory stores a program to be executed by the CPU, program data and so forth. The program stored in the memory is read in by the CPU, for example, upon activation of the image pickup apparatus 960 and is executed by the CPU. The CPU controls, by executing the program, operation of the image pickup apparatus 960, for example, in response to an operation signal inputted from the user interface section 971.

The user interface section 971 is connected to the control section 970. The user interface section 971 includes, for example, a button and a switch for allowing the user to operate the image pickup apparatus 960. The user interface section 971 detects an operation by the user through the components to generate an operation signal and outputs the generated operation signal to the control section 970.

In the image pickup apparatus 960 configured in this manner, for example, the image processing section 964 may have the functions of the image encoding apparatus 100 described hereinabove. In other words, the image processing section 964 may encode image data by any method described hereinabove in connection with the embodiments. This makes it possible for the image pickup apparatus 960 to suppress reduction of the encoding efficiency.

Further, in the image pickup apparatus 960 configured in such a manner as described above, for example, the image processing section 964 may have the functions of the image decoding apparatus 200 described hereinabove. In other words, the image processing section 964 may decode encoded data by any method described hereinabove in connection with the embodiments. This makes it possible for the image pickup apparatus 960 to suppress reduction of the encoding efficiency of encoded data.

It is to be noted that the present technology can be applied also to HTTP streaming of, for example, MPEG DASH or the like in which appropriate encoded data is selected and used in units of a segment from among a plurality of encoded data prepared in advance and different in resolution or the like from each other. In other words, information relating to encoding or decoding can be shared between such a plurality of encoded data as just described.

### Other Embodiments

While examples of an apparatus, a system and so forth to which the present technology are applied are described above, the present technology is not limited to them but can be carried out as any configuration that is incorporated in an apparatus that configures such an apparatus or a system as described, for example, a processor as a system LSI (Large Scale Integration) or the like, a module that uses a plurality of processors or the like, a unit that uses a plurality of modules, a set to which some other function is added to the unit and so forth (namely, as a configuration of part of an apparatus).

<Video Set>

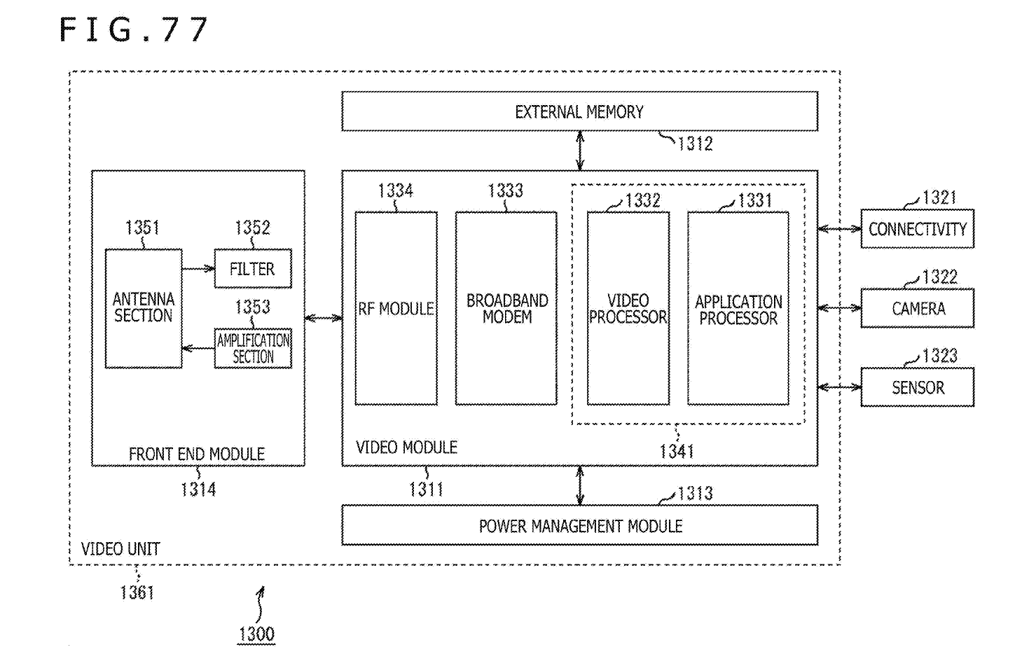

An example of a case in which the present technology is carried out as a set is described with reference to FIG. 77. FIG. 77 depicts an example of a general configuration of a video set to which the present technology is applied.

In recent years, multifunctionalization of electronic apparatus has been and is progressing, and when some configuration is carried out as sales, provision or the like in development or manufacture of an electronic apparatus, not only a case in which it is carried out as a configuration having one function but also a case in which a plurality of configurations having functions related to each other are combined and are carried out as one set having a plurality of functions seem increasing.

The video set 1300 depicted in FIG. 77 is such a multifunctionalized configuration as just described and is a combination of a device having a function relating to encoding or decoding (one or both of encoding and decoding) of an image and a device having a different function related to the function.

As depicted in FIG. 77, the video set 1300 includes a module group including a video module 1311, an external memory 1312, a power management module 1313, a front end module 1314 and so forth, and devices having related functions such as a connectivity 1321, a camera 1322, a sensor 1323 and so forth.

A module is a part having coherent functions formed by combining functions of several parts related to each other. Although the particular physical configuration is arbitrary, for example, a module may be an article in which a plurality of processors individually having functions, electronic circuit elements such as resistors and capacitors, other devices and so forth are arranged and integrated on a wiring board or the like. Alternatively, alto it is possible to combine a module with a different module, a processor or the like to produce a new module.

In the case of the example of FIG. 77, the video module 1311 is a combination of configurations having functions relating to image processing and includes an application processor, a video processor, a broadband modem 1333 and an RF module 1334.

A processor includes configurations having predetermined functions and integrated in a semiconductor chip by SoC (System On a Chip) and is called, for example, system LSI (Large Scale Integration). The configuration having a predetermined function may be a logic circuit (hardware configuration) or may be a CPU, a ROM, a RAM and so forth and a program (software configuration) executed using them or may be a combination of them. For example, a processor may include a logic circuit and a CPU, a ROM, a RAM and so forth such that part of functions are implemented by logic circuits (hardware configuration) while the other functions are implemented by a program (software configuration) executed by the CPU.

The application processor 1331 of FIG. 77 is a processor that executes an application relating to image processing. The application executed by the application processor 1331 not only performs an arithmetic process but also can control configurations inside or outside of the video module 1311 such as, for example, the video processor 1332 in order to implement predetermined functions.

The video processor 1332 is a processor having functions relating to encoding or decoding (one or both of encoding and decoding) of an image.

The broadband modem 1333 converts data (digital signal), which is to be transmitted by wired or wireless (or both wired and wireless) broadband communication that is performed through a broadband line such as the Internet or a public telephone network, into an analog signal by digital modulation or the like or demodulates and converts an analog signal received by such broadband communication into data (digital signal). The broadband modem 1333 processes arbitrary information such as, for example, image data processed by the video processor 1332, an encoded stream of image data, an application program, setting data and so forth.

The RF module 1334 is a module that performs frequency conversion, modulation or demodulation, amplification, filter processing and so forth for an RF (Radio Frequency) signal to be transmitted and received through an antenna. For example, the RF module 1334 performs frequency conversion and so forth for a baseband signal generated by the broadband modem 1333 to generate RF signals. Further, for example, the RF module 1334 performs frequency conversion and so forth for an RF signal received through the front end module 1314 to generate a baseband signal.

It is to be noted that, as depicted by a broken line 1341 in FIG. 77, the application processor 1331 and the video processor 1332 may be integrated so as to configure a single processor.

The external memory 1312 is a module that is provided outside the video module 1311 and includes a storage device that is utilized by the video module 1311. Although the storage device of the external memory 1312 may be implemented by any physical configuration, since generally the storage device is frequently utilized for storage of a large capacity of data like image data in units of a frame, it preferably is implemented by a semiconductor memory that is comparatively less expensive but has a large capacity like, for example, a DRAM (Dynamic Random Access Memory).

The power management module 1313 manages and controls power supply to the video module 1311 (to the respective components in the video module 1311).

The front end module 1314 is a module that provide a front end function (circuit at a transmission or reception end of the antenna side) to the RF module 1334. As depicted in FIG. 77, the front end module 1314 includes, for example, an antenna section 1351, a filter 1352 and an amplification section 1353.

The antenna section 1351 includes an antenna for transmitting and receiving a wireless signal and components around the antenna. The antenna section 1351 transmits a signal supplied from the amplification section 1353 as a wireless signal and supplies the received wireless signal as an electric signal (RF signal) to the filter 1352. The filter 1352 performs a filter process and so forth for the RF signal received through the antenna section 1351 and supplies the RF signal after the processing to the RF module 1334. The amplification section 1353 amplifies the RF signal supplied from the RF module 1334 and supplies the amplified RF signal to the antenna section 1351.

The connectivity 1321 is a module having a function relating to connection to the outside. The physical configuration of the connectivity 1321 is arbitrary. For example, the connectivity 1321 has a configuration having a communication function other than the communication standard with which the broadband modem 1333 is compatible, external input and output terminals and so forth.

For example, the connectivity 1321 may include a module having a communication function that complies with a wireless communication standard such as Bluetooth (registered trademark), IEEE 802.11 (for example, Wi-Fi (Wireless Fidelity, registered trademark)), NFC (Near Field Communication), IrDA (InfraRed Data Association), an antenna for transmitting and receiving a signal that complies with the standard, and so forth. Further, for example, the connectivity 1321 may include a module having a communication function that complies with a wired communication standard such as USB (Universal Serial Bus), or HDMI (registered trademark) (High-Definition Multimedia Interface), and a terminal that complies with the standard. Furthermore, for example, the connectivity 1321 may have some other data (signal) transmission function for analog input/output terminals and so forth and a like function.

It is to be noted that the connectivity 1321 may include a device of a transmission destination of data (signal). For example, the connectivity 1321 may include a drive for performing reading out or writing of data from or into a recording medium such as a magnetic disk, an optical disk, a magneto-optical disk or a semiconductor memory (including not only a drive for a removable medium but also a hard disk, an SSD (Solid State Drive), an NAS (Network Attached Storage) and so forth). Alternatively, the connectivity 1321 may include an outputting device of an image or sound (monitor, speaker or the like).

The camera 1322 is a module having a function that can pick up an image of an image pickup object to obtain image data of the image pickup object. The image data obtained by image pickup of the camera 1322 are supplied to and encoded by, for example, the video processor 1332.

The sensor 1323 is a module having an arbitrary sensor function such as, for example, a sound sensor, an ultrasonic sensor, a light sensor, an illuminance sensor, an infrared sensor, an image sensor, a rotation sensor, an angle sensor, an angular velocity sensor, a velocity sensor, an acceleration sensor, an inclination sensor, a magnetic identification sensor, a chock sensor, a temperature sensor and so forth. Data detected by the sensor 1323 is supplied, for example, to the application processor 1331 and is utilized by an application.

A configuration described as a module in the foregoing description may be implemented as a processor, or conversely a configuration described as a processor may be implemented as a module.

In the video set 1300 having such a configuration as described above, the present technology can be applied to the video processor 1332 as hereinafter described. Accordingly, the video set 1300 can be carried out as a set to which the present technology is applied.

<Example of Configuration of Video Processor>

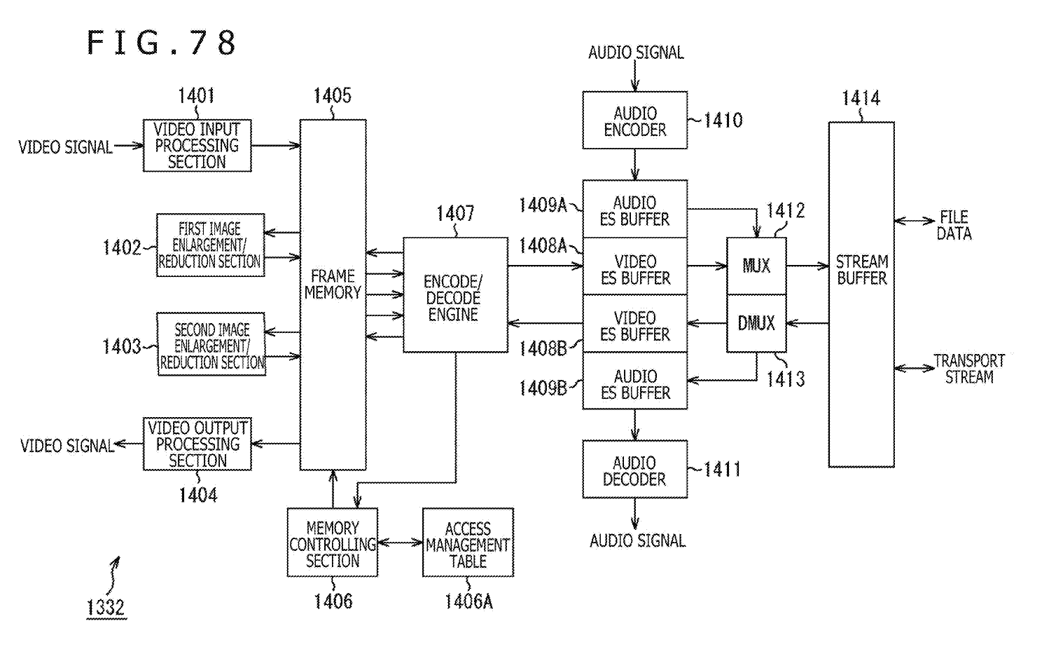

FIG. 78 depicts an example of a general configuration of the video processor 1332 (FIG. 77) to which the present technology is applied.

In the case of the example of FIG. 78, the video processor 1332 has a function for receiving inputs of a video signal and an audio signal and encoding them in accordance with a predetermined method and another function for decoding encoded video data and audio data and reproducing and outputting a video signal and an audio signal.

As depicted in FIG. 78, the video processor 1332 includes a video input processing section 1401, a first image enlargement/reduction section 1402, a second image enlargement/reduction section 1403, a video output processing section 1404, a frame memory 1405, and a memory controlling section 1406. The video processor 1332 further includes an encode/decode engine 1407, video ES (Elementary Stream) buffers 1408A and 1408B and audio ES buffers 1409A and 1409B. Further, the video processor 1332 includes an audio encoder 1410, an audio decoder 1411, a multiplexing section (MUX (Multiplexer)) 1412, a demultiplexing section (DMUX (Demultiplexer)) 1413 and a stream buffer 1414.

The video input processing section 1401 acquires a video signal inputted, for example, from the connectivity 1321 (FIG. 77) or the like and converts the video signal into digital image data. The first image enlargement/reduction section 1402 performs format conversion for image data, an enlargement or reduction process of an image and so forth. The second image enlargement/reduction section 1403 performs an enlargement or reduction process of an image for image data in response to a format at a destination of outputting through the video output processing section 1404, format conversion or an enlargement or reduction process of an image and so forth similar to those of the first image enlargement/reduction section 1402 and so forth. The video output processing section 1404 performs format information, conversion into an analog signal and so forth for image data and outputs resulting image data as a reproduced video signal, for example, to the connectivity 1321 and so forth.

The frame memory 1405 is a memory for image data shared by the video input processing section 1401, first image enlargement/reduction section 1402, second image enlargement/reduction section 1403, video output processing section 1404 and encode/decode engine 1407. The frame memory 1405 is implemented as a semiconductor memory such as, for example, a DRAM.

The memory controlling section 1406 receives a synchronizing signal from the encode/decode engine 1407 and controls accessing for writing and reading out to the frame memory 1405 in accordance with an access schedule to the frame memory 1405 written in the access management table 1406A. The access management table 1406A is updated by the memory controlling section 1406 in response to a process executed by the encode/decode engine 1407, first image enlargement/reduction section 1402, second image enlargement/reduction section 1403 or the like.

The encode/decode engine 1407 performs an encoding process of image data and a decoding process of a video stream that is encoded data of image data. For example, the encode/decode engine 1407 encodes image data read out from the frame memory 1405 and successively writes the image data as a video stream into the video ES buffer 1408A. Further, for example, the encode/decode engine 1407 successively reads out a video stream from the video ES buffer 1408B and decodes the video stream, and successively writes the video stream as image data into the frame memory 1405. The encode/decode engine 1407 uses the frame memory 1405 as a working area in encoding and decoding of them. Further, the encode/decode engine 1407 outputs a synchronizing signal to the memory controlling section 1406 at a timing at which, for example, processing for each macro block is started.

The video ES buffer 1408A buffers a video stream generated by the encode/decode engine 1407 and supplies the buffered video stream to the multiplexing section (MUX) 1412. The video ES buffer 1408B buffers a video stream supplied from the demultiplexing section (DMUX) 1413 and supplies the buffered video stream to the encode/decode engine 1407.

The audio ES buffer 1409A buffers an audio stream generated by the audio encoder 1410 and supplies the buffered audio stream to the multiplexing section (MUX) 1412. The audio ES buffer 1409B buffers an audio stream supplied from the demultiplexing section (DMUX) 1413 and supplies the buffered audio stream to the audio decoder 1411.

The audio encoder 1410, for example, digitally converts an audio signal inputted, for example, from the connectivity 1321 and encodes the digital audio signal in accordance with a predetermined method such as, for example, an MPEG audio method or an AC3 (AudioCode number 3) method. The audio encoder 1410 successively writes an audio stream, which is data encoded from an audio signal, into the audio ES buffer 1409A. The audio decoder 1411 decodes an audio stream supplied from the audio ES buffer 1409B, performs, for example, conversion into an analog signal and so forth and supplies the resulting analog signal as a reproduced audio signal, for example, to the connectivity 1321.

The multiplexing section (MUX) 1412 multiplexes a video stream and an audio stream. The method for the multiplexing (namely, the format of a bit stream generated by the multiplexing) is arbitrary. Further, upon such multiplexing, the multiplexing section (MUX) 1412 can also add predetermined header information or the like to the bit stream. In other words, the multiplexing section (MUX) 1412 can convert the format of a stream by multiplexing. For example, the multiplexing section (MUX) 1412 multiplexes a video stream and an audio stream to convert them into a transport stream that is a bit stream of a format for transfer. Further, for example, the multiplexing section (MUX) 1412 multiplexes a video stream and an audio stream to convert them into data (file data) of a file format for recording.

The demultiplexing section (DMUX) 1413 demultiplexes a bit stream, in which a video stream and an audio stream are multiplexed, by a method corresponding to the method for multiplexing by the multiplexing section (MUX) 1412. In particular, the demultiplexing section (DMUX) 1413 extracts a video stream and an audio stream from the bit stream read out from the stream buffer 1414 (demultiplexes into the video stream and the audio stream). In particular, the demultiplexing section (DMUX) 1413 can convert the format of the stream by demultiplexing (reverse conversion to the conversion by the multiplexing section (MUX) 1412). For example, the demultiplexing section (DMUX) 1413 can convert a transport stream supplied, for example, from the connectivity 1321, broadband modem 1333 or the like into a video stream and an audio stream by acquiring the transport stream through the stream buffer 1414 and demultiplexing the transport stream. Further, for example, the demultiplexing section (DMUX) 1413 can convert, for example, file data read out from various recording media by the connectivity 1321 into a video stream and an audio stream by acquiring the file data through the stream buffer 1414 and demultiplexing the file data.

The stream buffer 1414 buffers a bit stream. For example, the stream buffer 1414 buffers a transport stream supplied from the multiplexing section (MUX) 1412 and supplies the transport stream, for example, to the connectivity 1321 or the broadband modem 1333 at a predetermined timing or on the basis of a request from the outside or the like.

Further, for example, the stream buffer 1414 buffers file data supplied from the multiplexing section (MUX) 1412 and supplies the file data, for example, to the connectivity 1321 or the like at a predetermined timing or on the basis of a request from the outside or the like so as to be recorded into various recording media.

Furthermore, the stream buffer 1414 buffers a transport stream acquired, for example, through the connectivity 1321, broadband modem 1333 or the like and supplies the buffered transport stream to the demultiplexing section (DMUX) 1413 at a predetermined timing or on the basis of a request from the outside or the like.

Further, the stream buffer 1414 buffers file data read out from various recording media, for example, by the connectivity 1321 or the like, and supplies the buffered file data to the demultiplexing section (DMUX) 1413 at a predetermined timing or on the basis of a request from the outside or the like.

Now, an example of operation of the video processor 1332 of such a configuration as described above is described. For example, a video signal inputted from the connectivity 1321 or the like to the video processor 1332 is converted into digital image data of a predetermined method such as a 4:2:2Y/Cb/Cr method or the like by the video input processing section 1401 and successively written into the frame memory 1405. The digital image data are read out to the first image enlargement/reduction section 1402 or the second image enlargement/reduction section 1403 and subjected to format conversion into a format of a predetermined method such as the 4:2:0Y/Cb/Cr method and an enlargement or reduction process and are then written into the frame memory 1405 again. The image data are encoded by the encode/decode engine 1407 and written as a video stream into the video ES buffer 1408A.

Further, an audio signal inputted from the connectivity 1321 or the like to the video processor 1332 is encoded by the audio encoder 1410 and is written as an audio stream into the audio ES buffer 1409A.

A video stream of the video ES buffer 1408A and an audio stream of the audio ES buffer 1409A are read out to and multiplexed by the multiplexing section (MUX) 1412 and converted into a transport stream or file data or the like. The transport stream generated by the multiplexing section (MUX) 1412 is buffered by the stream buffer 1414 and then outputted to an external network, for example, through the connectivity 1321, the broadband modem 1333 or the like. Meanwhile, the file data generated by the multiplexing section (MUX) 1412 is buffered into the stream buffer 1414 and then outputted, for example, to the connectivity 1321 or the like and then recorded into various recording media.

On the other hand, a transport stream inputted from the external network to the video processor 1332, for example, through the connectivity 1321, the broadband modem 1333 or the like is buffered by the stream buffer 1414 and then demultiplexed, for example, by the demultiplexing section (DMUX) 1413 or the like. Meanwhile, file data read out from various kinds of recording media by the connectivity 1321 or the like and inputted to the video processor 1332 is buffered by the stream buffer 1414 and then demultiplexed by the demultiplexing section (DMUX) 1413. In other words, the transport stream or the file data inputted to the video processor 1332 is demultiplexed into a video stream and an audio stream by the demultiplexing section (DMUX) 1413.

The audio stream is supplied to the audio decoder 1411 through the audio ES buffer 1409B and is decoded by the audio decoder 1411 to reproduce an audio signal. Meanwhile, the video stream is written into the video ES buffer 1408B, and then is successively read out by the encode/decode engine 1407 and written into the frame memory 1405. The decoded image data is subjected to an enlargement/reduction process by the second image enlargement/reduction section 1403 and written into the frame memory 1405. Then, the decoded image data is read out to the video output processing section 1404 and is subjected to format conversion into a format of a predetermined method such as the 4:2:2Y/Cb/Cr method, whereafter it is converted into an analog signal to reproduce and output a video signal.

Where the present technology is applied to the video processor 1332 configured in such a manner as described above, the present technology according to each embodiment described hereinabove may be applied to the encode/decode engine 1407. In other words, for example, the encode/decode engine 1407 may have one or both of the functions of the image encoding apparatus 100 and the functions of the image decoding apparatus 200 described hereinabove. This makes it possible for the video processor 1332 to achieve advantageous effects similar to those by the embodiments described hereinabove with reference to FIGS. 1 to 65.

It is to be noted that, in the encode/decode engine 1407, the present technology (namely, one or both of the functions of the image encoding apparatus 100 and the functions of the image decoding apparatus 200) may be implemented by hardware such as logic circuits or may be implemented by software such as an incorporated program or the like or else may be implemented by both of them.

<Other Configuration Example of Video Processor>

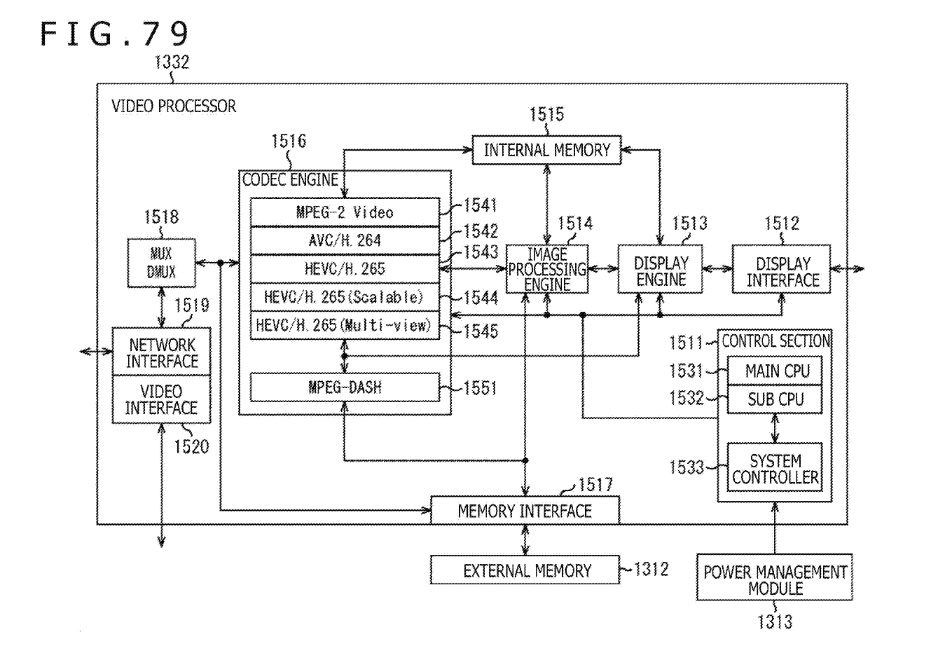

FIG. 79 depicts another example a schematic configuration of the video processor 1332 to which the present technology is applied. In the case of the example of FIG. 79, the video processor 1332 has functions for encoding and decoding video data by a predetermined method.

More particularly, as depicted in FIG. 79, the video processor 1332 includes a control section 1511, a display interface 1512, a display engine 1513, an image processing engine 1514 and an internal memory 1515. The video processor 1332 further includes a codec engine 1516, a memory interface 1517, a multiplexing/demultiplexing section (MUX DMUX) 1518, a network interface 1519 and a video interface 1520.

The control section 1511 controls operation of the respective processing sections in the video processor 1332 such as the display interface 1512, display engine 1513, image processing engine 1514, codec engine 1516 and so forth.

As depicted in FIG. 79, the control section 1511 includes, for example, a main CPU 1531, a sub CPU 1532 and a system controller 1533. The main CPU 1531 executes a program for controlling operation of the respective processing sections in the video processor 1332 and a like program. The main CPU 1531 generates a control signal in accordance with the program or the like and supplies the control signal to the respective processing sections (in other words, controls operation of the respective processing sections). The sub CPU 1532 plays an auxiliary role of the main CPU 1531. For example, the sub CPU 1532 executes a child process, a subroutine or the like of the program executed by the main CPU 1531 or the like. The system controller 1533 controls operation of the main CPU 1531 and the sub CPU 1532 such as to designate a program to be executed by the main CPU 1531 and the sub CPU 1532.

The display interface 1512 outputs image data, for example, to the connectivity 1321 under the control of the control section 1511. For example, the display interface 1512 converts image data of digital data into an analog signal and outputs the analog signal as a reproduced video signal or while keeping the form of the image data of digital data to the monitor apparatus of the connectivity 1321 or the like.

The display engine 1513 performs, under the control of the control section 1511, various conversion processes such as format conversion, size conversion or color region conversion for the image data so as to comply with the hardware specification of the monitor apparatus or the like on which the image of the image data is to be displayed.

The image processing engine 1514 performs predetermined image processes such as, for example, a filter process for picture quality improvement for the image data under the control of the control section 1511.

The internal memory 1515 is a memory that is provided in the inside of the video processor 1332 and is shared by the display engine 1513, image processing engine 1514 and codec engine 1516. The internal memory 1515 is utilized for transfer of data performed, for example, among the display engine 1513, image processing engine 1514 and codec engine 1516. For example, the internal memory 1515 stores data supplied from the display engine 1513, image processing engine 1514 or codec engine 1516 and supplies the data to the display engine 1513, image processing engine 1514 or codec engine 1516 as occasion demands (for example, in accordance with a request). Although the internal memory 1515 may be implemented by any storage device, since generally the internal memory 1515 is frequently utilized for storage of a small capacity of data such as image data in units of a block or parameters, it is desirable to implement the internal memory 1515 using a semiconductor memory that has a high response speed although it has a comparatively (for example, in comparison with the external memory 1312) small capacity like, for example, an SRAM (Static Random Access Memory).

The codec engine 1516 performs processes relating to encoding and decoding of image data. The method of encoding and decoding with which the codec engine 1516 is compatible is arbitrary, and the number of such methods may be one or a plural number. For example, the codec engine 1516 may be configured such that it includes a codec function of a plurality of encoding and decoding methods and performs encoding of image data or decoding of encoded data using a method selected from among the encoding and decoding methods.

In the example depicted in FIG. 79, the codec engine 1516 includes, as functional blocks of processes relating to the codec, for example, MPEG-2 Video 1541, AVC/H.264 1542, HEVC/H.265 1543, HEVC/H.265 (Scalable) 1544, HEVC/H.265 (Multi-view) 1545 and MPEG-DASH 1551.

The MPEG-2 Video 1541 is a functional block that encodes or decodes image data in accordance with the MPEG-2 method. The AVC/H.264 1542 is a functional block that encodes or decodes image data by the AVC method. The HEVC/H.265 1543 is a functional block that encodes or decodes image data by the HEVC method. The HEVC/H.265 (Scalable) 1544 is a functional block that scalably encodes or scalably decodes image data by the HEVC method. The HEVC/H.265 (Multi-view) 1545 is a functional block that multi-view encodes or multi-view decodes image data by the HEVC method.

The MPEG-DASH 1551 is a functional block that transmits and receives image data by the MPEG-DASH (MPEG-Dynamic Adaptive Streaming over HTTP) method. MPEG-DASH is a technology that performs streaming of a video using the HTTP (HyperText Transfer Protocol) and has characteristics one of which is to select and transmit appropriate encode data from among a plurality of encoded data prepared in advance and having resolutions and so forth different from each other in a unit of a segment. The MPEG-DASH 1551 performs generation of a stream in compliance with a standard and transmission control and so forth of the stream and utilizes, for encoding and decoding of image data, the MPEG-2 Video 1541 and the HEVC/H.265 (Multi-view) 1545 described above.

The memory interface 1517 is an interface for the external memory 1312. Data supplied from the image processing engine 1514 or the codec engine 1516 is supplied to the external memory 1312 through the memory interface 1517. On the other hand, data read out from the external memory 1312 is supplied to the video processor 1332 (image processing engine 1514 or codec engine 1516) through the memory interface 1517.

The multiplexing/demultiplexing section (MUX DMUX) 1518 performs multiplexing or demultiplexing of various data relating to an image such as a bit stream of encoded data, image data, a video signal and so forth. The method for multiplexing and demultiplexing is arbitrary. For example, upon multiplexing, the multiplexing/demultiplexing section (MUX DMUX) 1518 not only can summarize a plurality of data into one data but also can add predetermined header information or the like to the data. Further, upon demultiplexing, the multiplexing/demultiplexing section (MUX DMUX) 1518 not only can partition one data into a plurality of data but also can add predetermined header information or the like to each partitioned data. In other words, the multiplexing/demultiplexing section (MUX DMUX) 1518 can convert the format of data by demultiplexing. For example, the multiplexing/demultiplexing section (MUX DMUX) 1518 can convert, by multiplexing bit streams, the bit streams into a transport stream that is a bit stream of the format for transfer or data of a file format for recording (file data). Naturally, reverse conversion is possible by demultiplexing.

The network interface 1519 is an interface, for example, for the broadband modem 1333, the connectivity 1321 and so forth. The video interface 1520 is an interface, for example, for the connectivity 1321, the camera 1322 and so forth.

Now, an example of operation of such a video processor 1332 as described above is described. For example, if a transport stream is received from an external network through the connectivity 1321, the broadband modem 1333 or the like, then the transport stream is supplied through the network interface 1519 to and demultiplexed by the multiplexing/demultiplexing section (MUX DMUX) 1518 and is decoded by the codec engine 1516. Image data obtained by the decoding of the codec engine 1516 is subjected to a predetermined image process, for example, by the image processing engine 1514 and is subjected to predetermined conversion by the display engine 1513, and then is supplied, for example, to the connectivity 1321 through the display interface 1512. Consequently, an image of the image data is displayed on the monitor. Further, for example, image data obtained by decoding of the codec engine 1516 is re-encoded by the codec engine 1516 and multiplexed by the multiplexing/demultiplexing section (MUX DMUX) 1518 such that it is converted into file data. The file data is outputted, for example, to the connectivity 1321 through the video interface 1520 and recorded into various recording media.

Furthermore, for example, file data of encoded data encoded from image data and read out from a recording medium not depicted by the connectivity 1321 or the like is supplied through the video interface 1520 to and demultiplexed by the multiplexing/demultiplexing section (MUX DMUX) 1518, whereafter it is decoded by the codec engine 1516. The image data obtained by the decoding of the codec engine 1516 is subjected to a predetermined image process by the image processing engine 1514 and then to a predetermined conversion by the display engine 1513, and then is supplied, for example, to the connectivity 1321 or the like through the display interface 1512 such that an image thereof is displayed on the monitor. Further, for example, image data obtained by the decoding of the codec engine 1516 is re-encoded by the codec engine 1516 and multiplexed and converted into a transport stream by the multiplexing/demultiplexing section (MUX DMUX) 1518, and the transport stream is supplied, for example, to the connectivity 1321 or the broadband modem 1333 through the network interface 1519 and is transmitted to a different apparatus not depicted.

It is to be noted that transfer of image data or other data between the respective processing sections in the video processor 1332 is performed utilizing, for example, the internal memory 1515 or the external memory 1312. Further, the power management module 1313 controls, for example, power supply to the control section 1511.

Where the present technology is applied to the video processor 1332 configured in such a manner as described above, the present technology according to the embodiments descried above may be applied to the codec engine 1516. For example, the codec engine 1516 may be configured such that it has one or both of the functions of the image encoding apparatus 100 and the functions of the image decoding apparatus 200 described hereinabove. This makes it possible for the video processor 1332 to achieve advantageous effects similar to that of the embodiments described hereinabove with reference to FIGS. 1 to 65.

It is to be noted that, in the codec engine 1516, the present technology (namely, the functions of the image encoding apparatus 100) may be implemented by hardware such as logic circuits or may be implemented by software such as an incorporated program or else may be implemented by both of them.

Although two configurations of the video processor 1332 are exemplified above, the configuration of the video processor 1332 is arbitrary and may be different from the two examples described above. Further, while the video processor 1332 may be configured as a single semiconductor chip, it may otherwise be configured as a plurality of semiconductor chips. For example, the video processor 1332 may be a three-dimensional multilayer LSI having a plurality of semiconductor layers. Alternatively, the video processor 1332 may be implemented by a plurality of LSIs.

### Application Example to Apparatus

The video set 1300 can be incorporated into various apparatus that process image data. For example, the video set 1300 can be incorporated into the television apparatus 900 (FIG. 73), portable telephone set 920 (FIG. 74), recording and reproduction apparatus 940 (FIG. 75), image pickup apparatus 960 (FIG. 76) and so forth. By incorporating the video set 1300, the apparatus can achieve advantageous effects similar to those of the embodiments described hereinabove with reference to FIGS. 1 to 65.

It is to be noted that, if even part of the configurations of the video set 1300 described hereinabove includes the video processor 1332, it can be carried out as a configuration to which the present technology is applied. For example, only the video processor 1332 by itself can be carried out as a video processor to which the present technology is applied. Further, for example, a processor, the video module 1311 or the like indicated by the broken line 1341 can be carried out as a processor, a module or the like to which the present technology is applied as described hereinabove. Furthermore, it is possible to combine, for example, the video module 1311, external memory 1312, power management module 1313 and front end module 1314 so as to carry out them as a video unit 1361 to which the present technology is applied. In the case of any configuration, advantageous effects similar to those of the embodiments described hereinabove with reference to FIGS. 1 to 65 can be achieved.

In particular, if the video processor 1332 is included, then any configuration can be incorporated into various apparatus for processing image data similarly as in the case of the video set 1300. For example, it is possible to incorporate the video processor 1332, processor indicated by the broken line 1341, video module 1311, or video unit 1361 into the television apparatus 900 (FIG. 73), portable telephone set 920 (FIG. 74), recording and reproduction apparatus 940 (FIG. 75), image pickup apparatus 960 (FIG. 76) and so forth. Then, by incorporating one of the configurations to which the present technology is applied, the apparatus can achieve advantageous effects similar to those of the embodiments described hereinabove with reference to FIGS. 1 to 65 similarly as in the case of the video set 1300.

Further, in the present specification, an example in which various kinds of information are multiplexed into an encoded stream and transmitted from the encoding side to the decoding side is described. However, the technique for transmitting such information is not limited to this example. For example, such information may be transmitted or recorded as separate data associated with an encoded bit stream without being multiplexed into the encoded bit stream. Here, the term “associated” signifies to cause an image included in a bit stream (or part of an image such as a slice, a tile or a block) to be linked to information corresponding to the image upon decoding. In other words, information may be transmitted on a transmission line different from that on which an image (or a bit stream) is transmitted. Further, the information may be recorded in a recording medium different from that of an image (or a bit stream) (or in a different recording area of the same recording medium). Furthermore, information and an image (or a bit stream) may be associated with each other in an arbitrary unit such as, for example, a plurality of frames, one frame or a portion in a frame.

It is to be noted that the present technology can take also the following configuration.

(1) An image processing apparatus, including:

a prediction section configured to perform inter prediction for part of a plurality of regions of a lower hierarchy into which a processing target region of an image is partitioned, set a reference pixel using a reconstruction image corresponding to a prediction image generated by the inter prediction and perform intra prediction using the reference pixel for the other region from among the regions of the lower hierarchy; and

an encoding section configured to encode the image using a prediction image generated by the prediction section.

(2) The image processing apparatus according to (1), in which

the prediction section performs the inter prediction for one or both of a region positioned on the right side with respect to the region for which the intra prediction is to be performed and a region positioned on the lower side with respect to the region for which the intra prediction is to be performed, sets one or both of a reference pixel on the right side with respect to the region for which the intra prediction is to be performed and a reference pixel on the lower side with respect to the region for which the intra prediction is to be performed using a reconstruction image corresponding to a prediction image generated by the inter prediction and performs the intra prediction using the set reference pixel or pixels.

(3) The image processing apparatus according to (2), in which

the prediction section further sets a reference pixel using a reconstruction image of a region for which the prediction process has been performed and performs the intra prediction using the set reference pixel.

(4) The image processing apparatus according to (3), in which

the prediction section generates respective pixels of a prediction image using a single reference pixel corresponding to a single intra prediction mode by the intra prediction.

(5) The image processing apparatus according to (3), in which

the prediction section generates respective pixels of a prediction image using a plurality of reference pixels corresponding to a single intra prediction mode by the intra prediction.

(6) The image processing apparatus according to (5), in which

the prediction section generates each pixel of the prediction image using one of the plurality of reference pixels selected in response to the position of the pixel.

(7) The image processing apparatus according to (5) or (6), in which

the prediction section generates each pixel of the prediction image by performing, using the plurality of reference pixels, weighted arithmetic operation in response to the position of the pixels.

(8) The image processing apparatus according to (5), in which

the plurality of reference pixels are two pixels positioned in the opposite directions to each other of the single intra prediction mode as viewed from a pixel in the region for which the intra prediction is to be performed.

(9) The image processing apparatus according to any one of (1) to (8), in which

the processing target region is an encoded block that becomes a unit of encoding, and

the plurality of regions of the lower hierarchy are prediction blocks each of which becomes a unit of a prediction process in the encoded block.

(10) The image processing apparatus according to any one of (1) to (8), in which

the plurality of regions of the lower hierarchy are encoded blocks each of which becomes a unit of encoding, and

the processing target region is a set of a plurality of encoded blocks.

(11) The image processing apparatus according to (1) to (10), further including:

a generation section configured to generate information relating to prediction by the prediction section.

(12) The image processing apparatus according to any one of (1) to (11), further including:

an intra prediction section configured to perform intra prediction for the processing target region;

an inter prediction section configured to perform inter prediction for the processing target region; and

a prediction image selection section configured to select one of a prediction image generated by the intra prediction section, a prediction image generated by the inter prediction section, and a prediction image generated by the prediction section; in which

the encoding section encodes the image using the prediction image selected by the prediction image selection section.

(13) The image processing apparatus according to any one of (1) to (12), in which

the encoding section encodes a residual image representative of a difference between the image and the prediction image generated by the prediction section.

(14) An image processing method, including:

performing inter prediction for part of a plurality of regions of a lower hierarchy into which a processing target region of an image is partitioned;

setting a reference pixel using a reconstruction image corresponding to a prediction image generated by the inter prediction;

performing intra prediction using the reference pixel for the other region from among the regions of the lower hierarchy; and

encoding the image using a prediction image generated by the inter prediction and the intra prediction.

(15) An image processing apparatus, including:

a decoding section configured to decode encoded data of an image to generate a residual image;

a prediction section configured to perform inter prediction for part of a plurality of regions of a lower hierarchy into which a processing target region of the image is partitioned, set a reference pixel using a reconstruction image corresponding to a prediction image generated by the inter prediction and perform intra prediction using the reference pixel for the other region from among the regions of the lower hierarchy; and

a generation section configured to generate a decoded image of the image using the residual image generated by the decoding section and a prediction image generated by the prediction section.

(16) An image processing method, including:

decoding encoded data of an image to generate a residual image;

performing inter prediction for part of a plurality of regions of a lower hierarchy into which a processing target region of the image is partitioned;

setting a reference pixel using a reconstruction image corresponding to a prediction image generated by the inter prediction;

performing intra prediction using the reference pixel for the other region from among the regions of the lower hierarchy; and

generating a decoded image of the image using the generated residual image and the generated prediction image.

(17) An image processing apparatus, including:

a prediction image generation section configured to generate each of pixels of a prediction image of a processing target region of an image using a plurality of reference pixels corresponding to a single intra prediction mode.

(18) The image processing apparatus according to (17), in which

the prediction image generation section generates each pixel of the prediction image using one of the plurality of reference pixels selected in response to the position of the pixel.

(19) The image processing apparatus according to (17) or (18), in which

the prediction image generation section generates each pixel of the prediction image using the plurality of reference pixels by performing weighted arithmetic operation in response to the position of the pixel.

(20) An image processing method, including:

generating each of pixels of a prediction image of a processing target region of an image using a plurality of reference pixels corresponding to a single intra prediction mode.

### REFERENCE SIGNS LIST

31 Processing target region, 32 Region, 33 Pixel, 41 Region, 100 Image encoding apparatus, 115 Reversible encoding section, 116 Additional information generation section, 123 Intra prediction section, 124 Inter prediction section, 125 Inter-destination intra prediction section, 126 Prediction image selection section, 131 Inter prediction section, 134 Intra prediction section, 141 Block setting section, 142 Block prediction controlling section, 143 Storage section, 144 Cost comparison section, 200 Image decoding apparatus, 212 Reversible decoding section, 219 Intra prediction section, 220 Inter prediction section, 221 Inter-destination intra prediction section, 222 Prediction image selection section, 231 Inter prediction section, 232 Intra prediction section, 301 Intra prediction section, 302 Prediction image selection section, 311 Block prediction controlling section, 351 Intra prediction section, 401 Multiple reference intra prediction section, 402 Prediction image selection section, 411 Reference pixel setting section, 412 Prediction image generation section, 413 Cost function calculation section, 414 Mode selection section, 421 Block prediction controlling section, 451 Multiple reference intra prediction section, 461 Reference pixel setting section, 462 Prediction image generation section

1. An image processing apparatus, comprising:
a prediction section configured to perform inter prediction for part of a plurality of regions of a lower hierarchy into which a processing target region of an image is partitioned, set a reference pixel using a reconstruction image corresponding to a prediction image generated by the inter prediction and perform intra prediction using the reference pixel for the other region from among the regions of the lower hierarchy; and
an encoding section configured to encode the image using a prediction image generated by the prediction section.

2. The image processing apparatus according to claim 1, wherein
the prediction section performs the inter prediction for one or both of a region positioned on the right side with respect to the region for which the intra prediction is to be performed and a region positioned on the lower side with respect to the region for which the intra prediction is to be performed, sets one or both of a reference pixel on the right side with respect to the region for which the intra prediction is to be performed and a reference pixel on the lower side with respect to the region for which the intra prediction is to be performed using a reconstruction image corresponding to a prediction image generated by the inter prediction and performs the intra prediction using the set reference pixel or pixels.

3. The image processing apparatus according to claim 2, wherein
the prediction section further sets a reference pixel using a reconstruction image of a region for which the prediction process has been performed and performs the intra prediction using the set reference pixel.

4. The image processing apparatus according to claim 3, wherein
the prediction section generates respective pixels of a prediction image using a single reference pixel corresponding to a single intra prediction mode by the intra prediction.

5. The image processing apparatus according to claim 3, wherein
the prediction section generates respective pixels of a prediction image using a plurality of reference pixels corresponding to a single intra prediction mode by the intra prediction.

6. The image processing apparatus according to claim 5, wherein
the prediction section generates each pixel of the prediction image using one of the plurality of reference pixels selected in response to the position of the pixel.

7. The image processing apparatus according to claim 5, wherein
the prediction section generates each pixel of the prediction image by performing, using the plurality of reference pixels, weighted arithmetic operation in response to the position of the pixels.

8. The image processing apparatus according to claim 5, wherein
the plurality of reference pixels are two pixels positioned in the opposite directions to each other of the single intra prediction mode as viewed from a pixel in the region for which the intra prediction is to be performed.

9. The image processing apparatus according to claim 1, wherein
the processing target region is an encoded block that becomes a unit of encoding, and
the plurality of regions of the lower hierarchy are prediction blocks each of which becomes a unit of a prediction process in the encoded block.

10. The image processing apparatus according to claim 1, wherein
the plurality of regions of the lower hierarchy are encoded blocks each of which becomes a unit of encoding, and
the processing target region is a set of a plurality of encoded blocks.

11. The image processing apparatus according to claim 1, further comprising:
a generation section configured to generate information relating to prediction by the prediction section.

12. The image processing apparatus according to claim 1, further comprising:
an intra prediction section configured to perform intra prediction for the processing target region;
an inter prediction section configured to perform inter prediction for the processing target region; and
a prediction image selection section configured to select one of a prediction image generated by the intra prediction section, a prediction image generated by the inter prediction section, and a prediction image generated by the prediction section; wherein
the encoding section encodes the image using the prediction image selected by the prediction image selection section.

13. The image processing apparatus according to claim 1, wherein
the encoding section encodes a residual image representative of a difference between the image and the prediction image generated by the prediction section.

14. An image processing method, comprising:
performing inter prediction for part of a plurality of regions of a lower hierarchy into which a processing target region of an image is partitioned;
setting a reference pixel using a reconstruction image corresponding to a prediction image generated by the inter prediction;
performing intra prediction using the reference pixel for the other region from among the regions of the lower hierarchy; and
encoding the image using a prediction image generated by the inter prediction and the intra prediction.

15. An image processing apparatus, comprising:
a decoding section configured to decode encoded data of an image to generate a residual image;
a prediction section configured to perform inter prediction for part of a plurality of regions of a lower hierarchy into which a processing target region of the image is partitioned, set a reference pixel using a reconstruction image corresponding to a prediction image generated by the inter prediction and perform intra prediction using the reference pixel for the other region from among the regions of the lower hierarchy; and
a generation section configured to generate a decoded image of the image using the residual image generated by the decoding section and a prediction image generated by the prediction section.

16. An image processing method, comprising:
decoding encoded data of an image to generate a residual image;
performing inter prediction for part of a plurality of regions of a lower hierarchy into which a processing target region of the image is partitioned;
setting a reference pixel using a reconstruction image corresponding to a prediction image generated by the inter prediction;
performing intra prediction using the reference pixel for the other region from among the regions of the lower hierarchy; and
generating a decoded image of the image using the generated residual image and the generated prediction image.

17. An image processing apparatus, comprising:
a prediction image generation section configured to generate each of pixels of a prediction image of a processing target region of an image using a plurality of reference pixels corresponding to a single intra prediction mode.

18. The image processing apparatus according to claim 17, wherein
the prediction image generation section generates each pixel of the prediction image using one of the plurality of reference pixels selected in response to the position of the pixel.

19. The image processing apparatus according to claim 17, wherein
the prediction image generation section generates each pixel of the prediction image using the plurality of reference pixels by performing weighted arithmetic operation in response to the position of the pixel.

20. An image processing method, comprising:
generating each of pixels of a prediction image of a processing target region of an image using a plurality of reference pixels corresponding to a single intra prediction mode.
